(19) United States
(12) Patent Application Publication
(10) Pub. No.: US 2026/0261982 A1
(43) Pub. Date: Sep. 3, 2026

(54) COMMUNICATION SYSTEM, MANAGEMENT CONTROL APPARATUS AND CONTROL METHOD

(71) Applicant: NTT, Inc., Tokyo (JP)

(72) Inventors: Karin UMEDA, Musashino-shi (JP); Yoshihito SAKAI, Musashino-shi (JP); Hiroko NOMURA, Musashino-shi (JP); Tatsuya SHIMADA, Musashino-shi (JP); Hirotaka UJIKAWA, Musashino-shi (JP)

(73) Assignee: NTT, Inc., Tokyo (JP)

(21) Appl. No.: 18/865,729

(22) PCT Filed: May 16, 2023
(86) PCT No.: PCT/JP2023/018276

§ 371 Date: Nov. 14, 2024

(30) Foreign Application Priority Data
May 17, 2022 (WO) PCT/JP2022/020495

(51) Int. Cl. H04W 52/02; H04W 36/22

(52) U.S. Cl. CPC H04W 52/0274; H04W 36/22

(57) ABSTRACT

A communication system including: one or more terminal accommodation stations that perform communication with one or more terminals; a plurality of communication stations that is connected to the one or more terminal accommodation stations directly or via another device; a cooperation information collection unit that acquires cooperation information indicating a state of communication between the communication station and the one or more terminals, from the communication station; an optical path switching control unit that controls switching of an optical path between the one or more terminal accommodation stations and the plurality of communication stations in a case where it is determined that switching of the optical path between the one or more terminal accommodation stations and the plurality of communication stations is necessary on the basis of the cooperation information; and a sleep control unit that causes a communication station capable of sleep to transition to a sleep state before the switching of the optical path is performed or after the switching is performed.

The present application claims priority on the basis of PCT/JP2022/20495 filed in Japan on May 17, 2022, and the contents of which are incorporated herein by reference.

### TECHNICAL FIELD

The present invention relates to a communication system, a management control device, a communication station, and a control method.

### BACKGROUND ART

In a conventional communication system in which wireless communication is performed between a terminal and each base station, each base station calculates a throughput and autonomously sleeps when the throughput exceeds a threshold to achieve power saving. In such a communication system, a handover to a base station having the maximum throughput is instructed to a terminal connected to a base station that has been sleeping. As a result, the terminal can continuously perform communication.

### CITATION LIST

### Non Patent Literature

Non Patent Literature 1: Yong Sheng Soh, Tony Q. S. Quek, and Marios Kountouris, “Dynamic Sleep Mode Strategies in Energy Efficient Cellular Networks”, IEEE, Communications Theory, pp. 3131 3136, June 2013.

### SUMMARY OF INVENTION

### Technical Problem

However, in the conventional communication system, there is a possibility that a terminal connected to a sleeping base station performs a handover to a base station to which a large number of terminals are already connected, resulting in deterioration of communication quality. Further, in the conventional communication system, since each base station autonomously determines the necessity of sleep, overall optimization cannot be performed, and the effect of power saving may be limited. Note that such a problem is not limited to a communication system in which wireless communication is performed between a terminal and each base station, but may also occur in a communication system in which wired communication is performed between a terminal accommodation station connected to the terminal by wire and the terminal.

In view of the above circumstances, an object of the present invention is to provide a technique capable of increasing the effect of power saving without deterioration in communication quality.

### Solution to Problem

An aspect of the present invention is a communication system including: one or more terminal accommodation stations that perform communication with one or more terminals; a plurality of communication stations that is connected to the one or more terminal accommodation stations directly or via another device; a cooperation information collection unit that acquires cooperation information indicating a state of communication between the communication station and the one or more terminals, from the communication station; an optical path switching control unit that controls switching of an optical path between the one or more terminal accommodation stations and the plurality of communication stations in a case where it is determined that switching of the optical path between the one or more terminal accommodation stations and the plurality of communication stations is necessary on the basis of the cooperation information; and a sleep control unit that causes a communication station capable of sleep to transition to a sleep state before the switching of the optical path is performed or after the switching is performed.

An aspect of the present invention is a management control device including: a cooperation information collection unit that acquires cooperation information indicating a state of communication between a communication station connected, directly or via another device, to one or more terminal accommodation stations that perform communication with one or more terminals and the one or more terminals, from the communication station; an analysis unit that determines necessity of switching of an optical path between the one or more terminal accommodation stations and a plurality of communication stations and sleep control on the basis of the cooperation information; an optical path switching control unit that controls switching of the optical path between the one or more terminal accommodation stations and the plurality of communication stations in a case where it is determined that switching of the optical path between the one or more terminal accommodation stations and the plurality of communication stations is necessary; and a sleep control unit that causes a communication station capable of sleep to transition to a sleep state before the switching of the optical path is performed or after the switching is performed.

An aspect of the present invention is a communication station connected to a terminal accommodation station that communicates with a terminal, the communication station including: a transmission unit that transmits cooperation information indicating a state of communication with the terminal to a management control device; a reception unit that receives an optical path switching instruction indicating that the management control device determines that it is necessary to switch an optical path between the terminal accommodation station and the communication station on the basis of the cooperation information; and a sleep processing unit that transitions to a sleep state before the switching of the optical path is performed or after the switching is performed on the basis of the optical path switching instruction.

An aspect of the present invention is a control method including: acquiring cooperation information indicating a state of communication between a communication station connected, directly or via another device, to one or more terminal accommodation stations that perform communication with one or more terminals and the one or more terminals, from the communication station; controlling switching of an optical path between the one or more terminal accommodation stations and a plurality of communication stations in a case where it is determined that switching of the optical path between the one or more terminal accommodation stations and the plurality of communication stations is necessary on the basis of the cooperation information; and causing a communication station capable of sleep to transition to a sleep state before the switching of the optical path is performed or after the switching is performed.

### Advantageous Effects of Invention

According to the present invention, it is possible to increase the effect of power saving without deterioration in communication quality.

### BRIEF DESCRIPTION OF DRAWINGS

FIG. 1 A diagram for describing an overview of an overall configuration and processing of a mobile NW system according to an embodiment.

FIG. 2 A diagram illustrating a configuration example of a mobile NW system according to a first embodiment.

FIG. 3 A flowchart illustrating an example of a flow of sleep processing executed by a management control device according to the first embodiment.

FIG. 4 A flowchart illustrating an example of a flow of sleep processing executed by the management control device according to the first embodiment.

FIG. 5 A sequence diagram illustrating an example of a detailed flow of sleep processing executed by the mobile NW system according to the first embodiment.

FIG. 6 A flowchart illustrating an example of a flow of sleep cancellation processing executed by the management control device according to the first embodiment.

FIG. 7 A sequence diagram illustrating an example of a detailed flow of sleep cancellation processing executed by the mobile NW system according to the first embodiment.

FIG. 8 A diagram illustrating a configuration example of a mobile NW system according to a modification of the first embodiment.

FIG. 9 A diagram illustrating a configuration example of a mobile NW system according to a modification of the first embodiment.

FIG. 10 A sequence diagram illustrating an example of a detailed flow of sleep processing executed by a mobile NW system according to a modification of the first embodiment.

FIG. 11 A sequence diagram illustrating an example of a detailed flow of sleep cancellation processing executed by a mobile NW system according to a modification of the first embodiment.

FIG. 12 A diagram illustrating a configuration example of a mobile NW system according to a second embodiment.

FIG. 13 A flowchart illustrating an example of a flow of sleep processing executed by a management control device according to the second embodiment.

FIG. 14 A flowchart illustrating an example of a flow of sleep processing executed by the management control device according to the second embodiment.

FIG. 15 A sequence diagram illustrating an example of a detailed flow of sleep processing executed by the mobile NW system according to the second embodiment.

FIG. 16 A flowchart illustrating an example of a flow of sleep cancellation processing executed by the management control device according to the second embodiment.

FIG. 17 A sequence diagram illustrating an example of a detailed flow of sleep cancellation processing executed by the mobile NW system according to the second embodiment.

FIG. 18 A sequence diagram illustrating an example of a detailed flow of sleep processing executed by a mobile NW system according to a modification of the second embodiment.

FIG. 19 A sequence diagram illustrating an example of a detailed flow of sleep cancellation processing executed by a mobile NW system according to a modification of the second embodiment.

FIG. 20 A flowchart illustrating an example of a flow of sleep processing executed by a management control device according to a third embodiment.

FIG. 21 A flowchart illustrating an example of a flow of sleep processing executed by the management control device according to the third embodiment.

FIG. 22 A sequence diagram illustrating an example of a detailed flow of sleep processing executed by a mobile NW system according to the third embodiment.

FIG. 23 A flowchart illustrating an example of a flow of sleep cancellation processing executed by the management control device according to the third embodiment.

FIG. 24 A sequence diagram illustrating an example of a detailed flow of sleep cancellation processing executed by a mobile NW system according to the third embodiment.

FIG. 25 A is a sequence diagram illustrating an example of a detailed flow of sleep processing executed by a mobile NW system according to a modification of the third embodiment.

FIG. 26 A sequence diagram illustrating an example of a detailed flow of sleep cancellation processing executed by a mobile NW system according to a modification of the third embodiment.

FIG. 27 A diagram illustrating a configuration example of a mobile NW system according to a fourth embodiment.

FIG. 28 A flowchart illustrating an example of a flow of sleep processing executed by a management control device according to the fourth embodiment.

FIG. 29 A flowchart illustrating an example of a flow of sleep processing executed by the management control device according to the fourth embodiment.

FIG. 30 A sequence diagram illustrating an example of a detailed flow of sleep processing executed by the mobile NW system according to the fourth embodiment.

FIG. 31 A flowchart illustrating an example of a flow of sleep cancellation processing executed by the management control device according to the fourth embodiment.

FIG. 32 A sequence diagram illustrating an example of a detailed flow of sleep cancellation processing executed by the mobile NW system according to the fourth embodiment.

FIG. 33 A sequence diagram illustrating an example of a detailed flow of sleep processing executed by a mobile NW system according to a modification of the fourth embodiment.

FIG. 34 A sequence diagram illustrating an example of a detailed flow of sleep cancellation processing executed by a mobile NW system according to a modification of the fourth embodiment.

FIG. 35 A diagram for describing an overview of an overall configuration and processing of a wired NW system according to an embodiment.

FIG. 36 A diagram illustrating a configuration example of a wired NW system according to a fifth embodiment.

FIG. 37 A flowchart illustrating an example of a flow of sleep processing executed by a management control device according to the fifth embodiment.

FIG. 38 A flowchart illustrating an example of a flow of sleep processing executed by the management control device according to the fifth embodiment.

FIG. 39 A sequence diagram illustrating an example of a detailed flow of sleep processing executed by the wired NW system according to the fifth embodiment.

FIG. 40 A flowchart illustrating an example of a flow of sleep cancellation processing executed by the management control device according to the fifth embodiment.

FIG. 41 A sequence diagram illustrating an example of a detailed flow of sleep cancellation processing executed by the wired NW system according to the fifth embodiment.

FIG. 42 A diagram illustrating a configuration example of a wired NW system according to a modification of the fifth embodiment.

FIG. 43 A diagram illustrating a configuration example of a wired NW system according to a modification of the fifth embodiment.

FIG. 44 A sequence diagram illustrating an example of a detailed flow of sleep processing executed by the wired NW system according to a modification of the fifth embodiment.

FIG. 45 A sequence diagram illustrating an example of a detailed flow of sleep cancellation processing executed by the wired NW system according to a modification of the fifth embodiment.

FIG. 46 A diagram illustrating a configuration example of a wired NW system according to a sixth embodiment.

FIG. 47 A flowchart illustrating an example of a flow of sleep processing executed by a management control device according to the sixth embodiment.

FIG. 48 A flowchart illustrating an example of a flow of sleep processing executed by the management control device according to the sixth embodiment.

FIG. 49 A sequence diagram illustrating an example of a detailed flow of sleep processing executed by the wired NW system according to the sixth embodiment.

FIG. 50 A flowchart illustrating an example of a flow of sleep cancellation processing executed by the management control device according to the sixth embodiment.

FIG. 51 A sequence diagram illustrating an example of a detailed flow of sleep cancellation processing executed by the wired NW system according to the sixth embodiment.

FIG. 52 A sequence diagram illustrating an example of a detailed flow of sleep processing executed by a wired NW system according to a modification of the sixth embodiment.

FIG. 53 A sequence diagram illustrating an example of a detailed flow of sleep cancellation processing executed by a wired NW system according to a modification of the sixth embodiment.

FIG. 54 A flowchart illustrating an example of a flow of sleep processing executed by a management control device according to a seventh embodiment.

FIG. 55 A flowchart illustrating an example of a flow of sleep processing executed by the management control device according to the seventh embodiment.

FIG. 56 A sequence diagram illustrating an example of a detailed flow of sleep processing executed by a wired NW system according to the seventh embodiment.

FIG. 57 A flowchart illustrating an example of a flow of sleep cancellation processing executed by a management control device according to the seventh embodiment.

FIG. 58 A sequence diagram illustrating an example of a detailed flow of sleep cancellation processing executed by the wired NW system according to the seventh embodiment.

FIG. 59 A sequence diagram illustrating an example of a detailed flow of sleep processing executed by a wired NW system according to a modification of the seventh embodiment.

FIG. 60 A sequence diagram illustrating an example of a detailed flow of sleep cancellation processing executed by a wired NW system according to a modification of the seventh embodiment.

FIG. 61 A diagram illustrating a configuration example of a wired NW system according to an eighth embodiment.

FIG. 62 A flowchart illustrating an example of a flow of sleep processing executed by a management control device according to the eighth embodiment.

FIG. 63 A flowchart illustrating an example of a flow of sleep processing executed by the management control device according to the eighth embodiment.

FIG. 64 A sequence diagram illustrating an example of a detailed flow of sleep processing executed by the wired NW system according to the eighth embodiment.

FIG. 65 A flowchart illustrating an example of a flow of sleep cancellation processing executed by the management control device according to the eighth embodiment.

FIG. 66 A sequence diagram illustrating an example of a detailed flow of sleep cancellation processing executed by the wired NW system according to the eighth embodiment.

FIG. 67 A sequence diagram illustrating an example of a detailed flow of sleep processing executed by a wired NW system according to a modification of the eighth embodiment.

FIG. 68 A sequence diagram illustrating an example of a detailed flow of sleep cancellation processing executed by a wired NW system according to a modification of the eighth embodiment.

### DESCRIPTION OF EMBODIMENTS

Hereinafter, an embodiment of the present invention will be described with reference to drawings.

### (Overview of Overall Configuration and Processing of Mobile NW System)

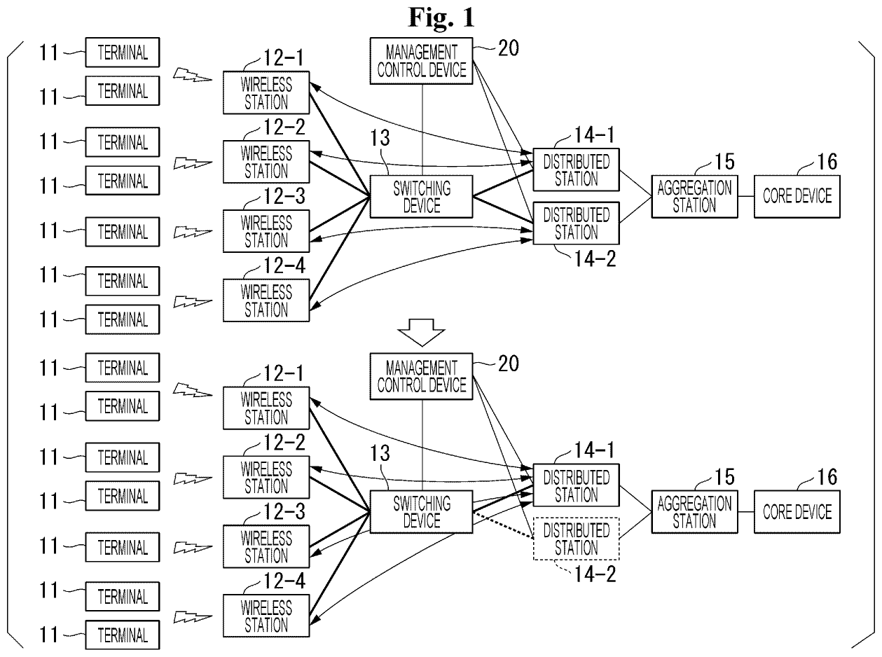

FIG. 1 is a diagram for describing an overview of an overall configuration and processing of a mobile NW system according to an embodiment. First, an overall configuration of a mobile NW system will be described. The mobile NW system is an example of a communication system. The mobile NW system is, for example, a fifth generation mobile communication system (hereinafter referred to as “5G”). The mobile NW system includes one or more radio stations 12, a switching device 13, a plurality of distributed stations 14, an aggregation station 15, a core device 16, and a management control device 20.

The radio station 12 and the switching device 13, the switching device 13 and the distributed station 14, the distributed station 14 and the aggregation station 15, and the aggregation station 15 and the core device 16 are connected by an optical fiber that transmits an optical signal. The switching device 13 and the management control device 20, and the distributed station 14 and the management control device 20 are connected by an electric line that transmits an electric signal or an optical fiber. The example illustrated in FIG. 1 illustrates a case where there are four radio stations 12 and two distributed stations 14. Note that a plurality of switching devices 13 may be provided, but the case where the number of switching devices 13 is one will be described as an example in the following description.

Each radio station 12 includes one or more antennas and performs wireless communication with a terminal 11. For example, each radio station 12 receives a signal transmitted from the terminal 11 and transmits the received signal to the distributed station 14 connected via the switching device 13. Each radio station 12 transmits the received signal to the terminal 11 via the switching device 13. The radio station 12 is, for example, a radio unit (RU) in the 5G communication standard. The radio station 12 is an aspect of a terminal accommodation station.

The switching device 13 is provided between the radio station 12 and the distributed station 14. The switching device 13 switches an optical path in accordance with an instruction from the management control device 20. The optical path is a path of an optical signal. The switching device 13 switches the connection between the radio station 12 and the distributed station 14 by switching the optical path.

The distributed station 14 receives an uplink signal transmitted by the radio station 12 via the switching device 13. The distributed station 14 transmits a downlink signal to the radio station 12 via the switching device 13. Note that the uplink signal is a signal transmitted by the terminal 11, and the downlink signal is a signal addressed to the terminal 11. Each distributed station 14 transitions to a sleep state in accordance with an instruction from the management control device 20. The sleep state is a state in which power saving can be achieved by stopping some functions. The distributed station 14 is, for example, a distributed unit (DU) in the 5G communication standard. Information acquired by the management control device 20 from the distributed station 14 is referred to as cooperation information. The cooperation information is information indicating a state of communication between each distributed station 14 and the terminal 11. The distributed station 14 is an aspect of a communication station.

The cooperation information includes, for example, information regarding the number of terminals 11 accommodated in each distributed station 14 (hereinafter, “the number of accommodated terminals”). The cooperation information includes, for example, the maximum number of accommodated terminals in the distributed station 14. The maximum number of accommodated terminals in the distributed station 14 is the maximum number that can be accommodated in the distributed station 14. The cooperation information includes, for example, information (hereinafter referred to as “connected radio station information”) of the radio station 12 to which the distributed station 14 on the optical path is connected. The cooperation information includes, for example, information regarding the processing load of the distributed station 14 (hereinafter, referred to as “processing load information”). The processing load information may be, for example, information of a usage rate of a memory or information of a usage rate of a central processing unit (CPU) of the distributed station 14. The cooperation information includes, for example, information (hereinafter referred to as “processing delay information”) regarding the processing delay for each distributed station 14. The cooperation information includes, for example, information (hereinafter referred to as “delay information”) regarding the transmission delay between the terminal 11 and each distributed station 14.

The aggregation station 15 aggregates uplink signals transmitted by the distributed stations 14. The aggregation station 15 distributes downlink signals. The aggregation station 15 is, for example, a centralized unit (CU) in the 5G communication standard.

The core device 16 executes signal processing on the uplink signals aggregated by the aggregation station 15. The core device 16 transmits a signal obtained as a result of executing the signal processing on the uplink signals to an external network. The core device 16 receives a signal from the external network.

The core device 16 performs prescribed predetermined signal processing on the signal received from the external network. The core device 16 transmits a signal obtained as a result of executing the signal processing on the signal received from the external network to the aggregation station 15 as a downlink signal. The signal processing is, for example, transfer of user data in a user plane function (UPF) of a 5G core network.

The management control device 20 acquires the cooperation information from the distributed station 14. The management control device 20 determines the necessity of the optical path switching and the sleep control on the basis of the acquired cooperation information. The management control device 20 performs optical path switching control processing and sleep control processing when it is determined that optical path switching and sleep control are necessary. The optical path switching control processing is processing of switching the optical path between the radio station 12 and the distributed station 14. For example, the management control device 20 instructs the switching device 13 to control switching of the optical path between the radio station 12 and the distributed station 14. The sleep control processing is processing of causing the distributed station 14 to execute sleep or to cancel sleep.

Next, an overview of processing of the mobile NW system will be described.

The upper diagram of FIG. 1 indicates the connection state of the mobile NW system before optical path switching, and the lower diagram of FIG. 1 indicates the connection state of the mobile NW system after optical path switching. The upper diagram of FIG. 1 indicates an example in which radio stations 12-1 and 12-2 are connected to a distributed station 14-1, and radio stations 12-3 and 12-4 are connected to a distributed station 14-2.

The management control device 20 determines whether or not to perform the optical path switching control processing on the basis of the cooperation information collected from each distributed station 14. The management control device 20 determines to perform the optical path switching control processing when there is a distributed station 14 capable of transition to the sleep state. The distributed station 14 capable of transition to the sleep state is, for example, a distributed station 14 that does not accommodate the terminals 11.

On the other hand, the management control device 20 determines not to perform the optical path switching control processing when there is no distributed station 14 capable of transition to the sleep state. When determining to perform the optical path switching control processing, the management control device 20 instructs the switching device 13 to switch the optical path. The switching device 13 switches the optical path between the radio station 12 and the distributed station 14 in accordance with the instruction from the management control device 20. The switching device 13 notifies the management control device 20 of the completion of the optical path switching after the optical path switching is completed.

Upon receiving the notification of optical path switching completion from the switching device 13, the management control device 20 transmits a sleep permission notification to the distributed station 14 capable of transition to the sleep state. The sleep permission notification is a signal including an instruction for causing the distributed station 14 to transition to the sleep state. As a result, the distributed station 14 capable of transition to the sleep state transitions to the sleep state.

The lower diagram of FIG. 1 illustrates an example in which the radio stations 12-1 to 12-4 are connected to the distributed station 14-1 and the distributed station 14-2 transitions to the sleep state. As described above, in a mobile NW system 100, the terminal 11 connected to the distributed station 14 capable of transition to the sleep state is connected to another distributed station 14 on the basis of the cooperation information collected from each distributed station 14, whereby the distributed station 14 capable of transition to the sleep state transitions to the sleep state. Hereinafter, the distributed station 14 capable of transition to the sleep state is referred to as a switching source distributed station, and the distributed station 14 to be a new connection destination of the terminal 11 connected to the switching source distributed station is referred to as a switching destination distributed station.

### First Embodiment

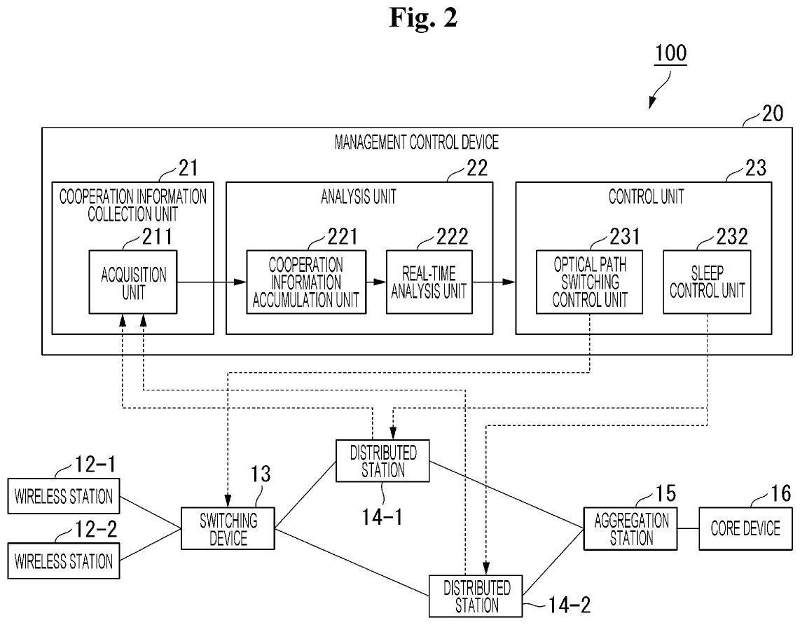

FIG. 2 is a diagram illustrating a configuration example of the mobile NW system 100 according to the first embodiment. The mobile NW system 100 according to the first embodiment includes one or more radio stations 12, a switching device 13, a plurality of distributed stations 14, an aggregation station 15, a core device 16, and a management control device 20. Since the radio station 12, the switching device 13, the distributed station 14, the aggregation station 15, and the core device 16 have been described with reference to FIG. 1, the description thereof will be omitted. The management control device 20 includes a cooperation information collection unit 21, an analysis unit 22, and a control unit 23.

The cooperation information collection unit 21 includes an acquisition unit 211. The acquisition unit 211 collects the cooperation information from the distributed station 14 at a predetermined cycle.

The analysis unit 22 includes a cooperation information accumulation unit 221 and a real-time analysis unit 222. The cooperation information accumulation unit 221 records the collected cooperation information in a predetermined storage device. The real-time analysis unit 222 analyzes a state of communication between each distributed station 14 and the terminal 11 such as a change amount of the number of connections of the distributed station 14 per unit time on the basis of the cooperation information. Specifically, the real-time analysis unit 222 determines the necessity of optical path switching and sleep control on the basis of the cooperation information.

For example, in a case where all the terminals 11 accommodated in the switching source distributed station can be accommodated in another distributed station 14, the real-time analysis unit 222 determines that optical path switching and sleep control are necessary. In this case, the real-time analysis unit 222 notifies the control unit 23 of information indicating the distributed station 14 to be an optical path switching destination and information indicating the distributed station 14 to be a sleep target.

For example, in a case where the number of terminals 11 accommodated in the distributed station 14 exceeds the maximum number of accommodated terminals, the real-time analysis unit 222 determines that optical path switching and sleep control are necessary. In this case, the real-time analysis unit 222 notifies the control unit 23 of information indicating the distributed station 14 to be an optical path switching destination and information indicating the distributed station 14 to be a sleep cancellation target.

The control unit 23 includes an optical path switching control unit 231 and a sleep control unit 232. The optical path switching control unit 231 determines the distributed station 14 to be the optical path switching destination on the basis of the analysis result of the real-time analysis unit 222, and instructs the switching device 13 to switch the optical path. For example, the optical path switching control unit 231 determines the distributed station 14 to be the optical path switching destination on the basis of the information indicating the distributed station 14 to be the optical path switching destination notification of which has been given from the real-time analysis unit 222.

The sleep control unit 232 causes the distributed station 14 to execute sleep or cancel sleep on the basis of the analysis result of the real-time analysis unit 222.

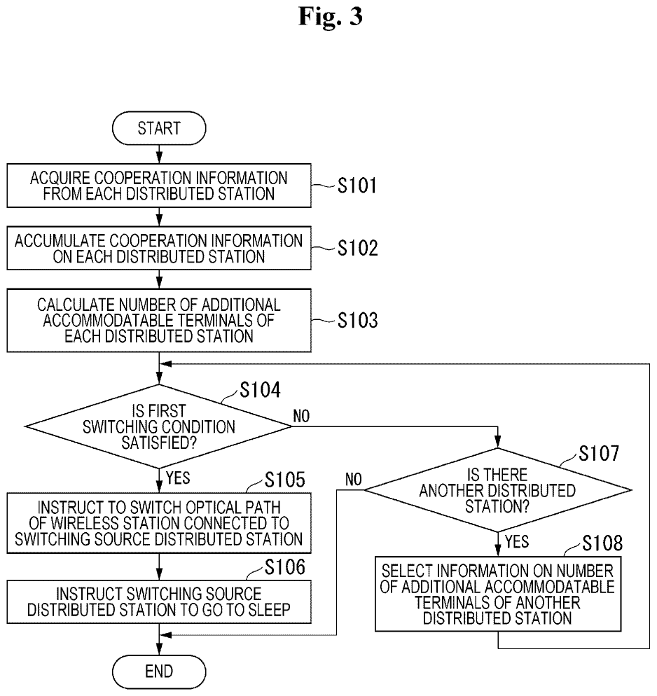

FIG. 3 is a flowchart illustrating an example of a flow of sleep processing executed by the management control device 20 according to the first embodiment. In FIG. 3, a case where the cooperation information includes at least information of the number of accommodated terminals of each distributed station 14 and information of the maximum number of accommodated terminals will be described as an example. The flow of the processing in FIG. 3 is repeatedly executed at a predetermined cycle.

The acquisition unit 211 acquires the cooperation information from each distributed station 14 (step S101). The acquisition unit 211 accumulates the acquired cooperation information of each distributed station 14 in the cooperation information accumulation unit 221 (step S102). The real-time analysis unit 222 calculates the number of additionally accommodatable terminals of each distributed station 14 on the basis of the cooperation information for each distributed station 14 accumulated in the cooperation information accumulation unit 221 (step S103). Here, the number of additionally accommodatable terminals indicates the number of terminals 11 that can be additionally accommodated in addition to the number of terminals currently accommodated in the distributed station 14. For example, the number of additionally accommodatable terminals is obtained by subtracting the number of accommodated terminals from the maximum number of accommodated terminals.

The real-time analysis unit 222 determines whether or not a first switching condition is satisfied (step S104). The first switching condition is a condition indicating that switching of the optical path between the radio station 12 and the distributed station 14 is necessary, and is, for example, that the number of additionally accommodatable terminals in a certain distributed station 14 is larger than the number of accommodated terminals of the distributed station 14 as a sleep determination target.

When determining that the first switching condition is satisfied (step S104—YES), the real-time analysis unit 222 notifies the control unit 23 of an optical path switching instruction and a sleep control instruction. The optical path switching control unit 231 instructs the switching device 13 to switch the optical path of the radio station 12 connected to the switching source distributed station on the basis of the optical path switching instruction notification of which has been given from the real-time analysis unit 222 (step S105). Specifically, the optical path switching control unit 231 instructs the optical path of the radio station 12 connected to the switching source distributed station to head for the switching destination distributed station.

The sleep control unit 232 transmits a sleep permission notification to the switching source distributed station (step S106). For example, the sleep control unit 232 may transmit a sleep instruction to the switching source distributed station when an optical path switching completion notification is obtained from the radio station 12 connected to the switching source distributed station and the switching destination distributed station. The optical path switching completion notification is a signal including contents indicating that the optical path switching is completed. As a result, the switching source distributed station can transition to the sleep state.

In a case where it is determined that the first switching condition is not satisfied in the processing of step S104 (step S104—NO), the real-time analysis unit 222 determines whether or not there is another distributed station 14 (step S107). The another distributed station 14 is, for example, a distributed station 14 that is not compared with the distributed station 14 that is a sleep determination target. When it is determined that there is no other distributed station 14 (step S107-NO), the real-time analysis unit 222 ends the processing.

On the other hand, in a case where it is determined that there is another distributed station 14 (step S107—YES), the real-time analysis unit 222 selects information of the number of addable accommodated terminals of the another distributed station 14 (step S108). The real-time analysis unit 222 executes the processing of step S104 again by using the information of the number of addable accommodated terminals of the selected another distributed station 14.

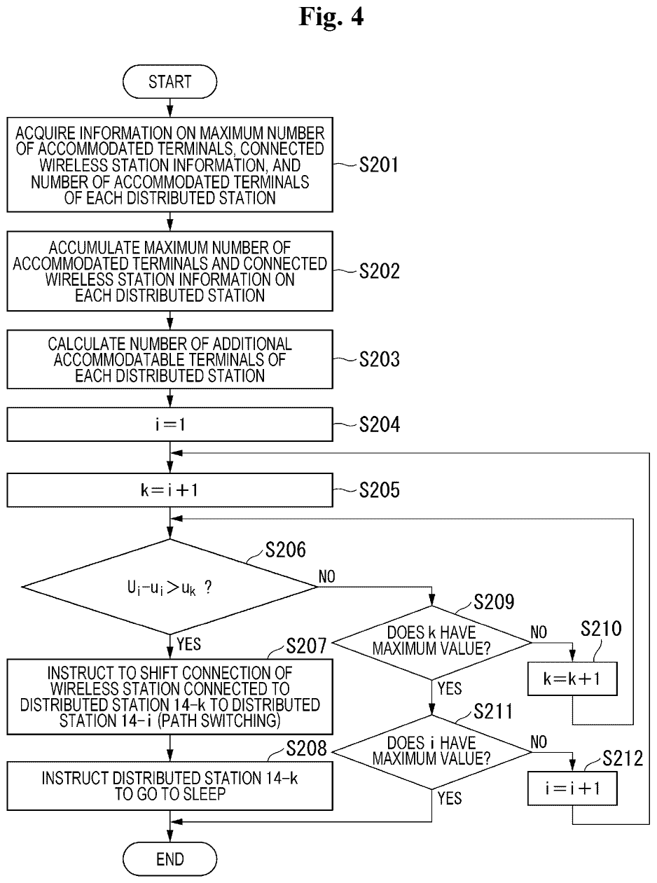

FIG. 4 is a flowchart illustrating an example of a flow of sleep processing executed by the management control device 20 according to the first embodiment. Note that, in the processing illustrated in FIG. 4, contents more specifically indicating the processing illustrated in FIG. 3 will be described.

The acquisition unit 211 acquires, from each distributed station 14, the information of the maximum number of accommodated terminals, the connected radio station information, and the number of accommodated terminals of each distributed station as the cooperation information (step S201).

The acquisition unit 211 accumulates the acquired cooperation information of each distributed station 14 in the cooperation information accumulation unit 221 (step S202). The real-time analysis unit 222 calculates the number of additionally accommodatable terminals of each distributed station 14 on the basis of the cooperation information for each distributed station 14 accumulated in the cooperation information accumulation unit 221 (step S203). Next, the real-time analysis unit 222 substitutes a value of 1 for constant i (step S204). i indicates, for example, a distributed station 14-i to be the switching destination. When i=1, the distributed station 14-1 is the switching destination distributed station. i is a value of 1≤i≤I. I is the total number of distributed stations 14.

Next, the real-time analysis unit 222 substitutes a value of (i+1) for k (step S205). k indicates, for example, a distributed station 14-k to be the switching source. When k=2 (i=1), the distributed station 14-2 is the switching source distributed station. k is a value of 2≤k≤K. K is the total number of distributed stations 14-1, i.e., K=(I−1).

Thereafter, the real-time analysis unit 222 determines whether Uᵢ−uᵢ>uₖ is satisfied (step S206). Uᵢ indicates the maximum number of accommodated terminals of the distributed station 14-i, uᵢ indicates the number of accommodated terminals of the distributed station 14-i, and uₖ indicates the number of accommodated terminals of the distributed station 14-k. The condition indicated by Uᵢ−uᵢ>uₖ is a specific example of the first switching condition. Here, as an example, it is assumed that the maximum number of accommodated terminals of the distributed station 14-1 is 1000, the number of accommodated terminals of the distributed station 14-1 is 100, the maximum number of accommodated terminals of the distributed station 14-2 is 800, and the number of accommodated terminals of the distributed station 14-2 is 200.

When i=1 and k=2, those described below are indicated.

$${U}_{1} - {u}_{1} \text{=>} 1000 - 100 = 900$$

Based on the above results, U₁−u₁>u₂ becomes 900>200, and the first switching condition is satisfied. When determining that the first switching condition (for example, Uᵢ−uᵢ>Uₖ) is satisfied (step S206—YES), the real-time analysis unit 222 notifies the control unit 23 of an optical path switching instruction and a sleep control instruction.

The optical path switching control unit 231 instructs the switching device 13 to switch the optical path of the radio station 12 connected to the distributed station 14-k on the basis of the optical path switching instruction notification of which has been given from the real-time analysis unit 222 (step S207). Specifically, the optical path switching control unit 231 gives an instruction so that the optical path of the radio station 12 connected to the distributed station 14-k (for example, the distributed station 14-2) to head for the distributed station 14-i (for example, the distributed station 14-1) which is the switching destination distributed station. The sleep control unit 232 transmits a sleep permission notification to the distributed station 14-k (for example, distributed station 14-2) (step S208).

On the other hand, as an example, a case is considered in which the maximum number of accommodated terminals of the distributed station 14-1 is 1000, the number of accommodated terminals of the distributed station 14-1 is 500, the maximum number of accommodated terminals of the distributed station 14-2 is 800, and the number of accommodated terminals of the distributed station 14-2 is 700. When i=1 and k=2, those described below are indicated.

$${U}_{1} - {u}_{1} \text{=>} 1000 - 500 = 500$$

Based on the above results, U₁−u₁>u₂ becomes 500<700, and the first switching condition is not satisfied. In a case where it is determined that the first switching condition (for example, Uᵢ−uᵢ>uₖ) is not satisfied (step S206—NO), the real-time analysis unit 222 determines whether or not k is the maximum value (step S209).

When determining that k is not the maximum value (step S209—NO), the real-time analysis unit 222 adds a value of 1 to the value of k (step S210). Thereafter, the real-time analysis unit 222 executes the processing of step S206 again. For example, as in the above-described example, in a case where i=1 and k=2 and k is not the maximum value, the real-time analysis unit 222 adds a value of 1 to the value of k to obtain k=3. Then, the real-time analysis unit 222 determines whether U₁−u₁>u₃ is satisfied.

On the other hand, when determining that k is the maximum value (step S209—YES), the real-time analysis unit 222 determines whether i is the maximum value (step S211). When it is determined that i is the maximum value (step S211—YES), the real-time analysis unit 222 ends the processing.

On the other hand, when determining that i is not the maximum value (step S211—NO), the real-time analysis unit 222 adds a value of 1 to the value of i (step S212). Thereafter, the real-time analysis unit 222 executes the processing of step S205 again. For example, in a case where i=1, k=3, k is the maximum value, and i is not the maximum value, the real-time analysis unit 222 adds a value of 1 to the value of i to obtain i=2.

Then, the real-time analysis unit 222 substitutes a value of (i+1) for k in the processing of step S205 (step S205). In this case, i=2 and k=3. Thereafter, the real-time analysis unit 222 determines whether U₂−u₂>u₃ is satisfied in the processing of step S206.

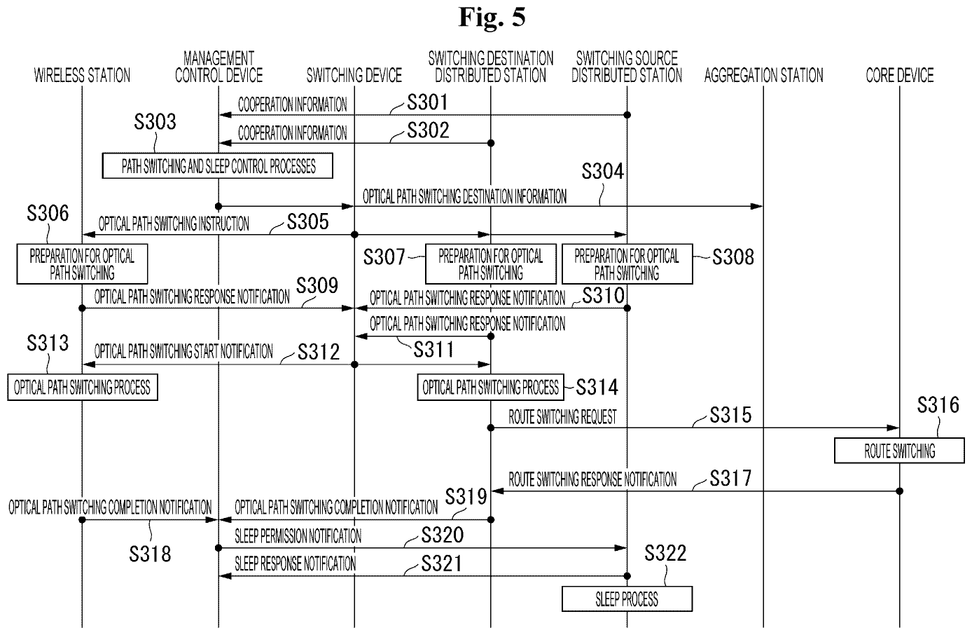

FIG. 5 is a sequence diagram illustrating an example of a detailed flow of sleep processing executed by the mobile NW system 100 according to the first embodiment. Note that, in the description of FIG. 5, it is assumed that the distributed station 14-1 is a switching destination distributed station and the distributed station 14-2 is a switching source distributed station. Here, the switching destination distributed station 14-1 and the switching source distributed station 14-2 will be described.

The acquisition unit 211 of the management control device 20 acquires the cooperation information from the switching destination distributed station 14-1 and the switching source distributed station 14-2 at a predetermined cycle (step S301 and step S302). The acquisition unit 211 accumulates the acquired cooperation information in the cooperation information accumulation unit 221. When the cooperation information is accumulated in the cooperation information accumulation unit 221, the real-time analysis unit 222 performs optical path switching and sleep control determination (step S303).

The optical path switching and the sleep control determination in step S303 is a determination as to whether or not the first switching condition is satisfied in step S104. Here, it is assumed that the first switching condition in step S104 is satisfied. When the first switching condition is satisfied, the real-time analysis unit 222 instructs the optical path switching control unit 231 to perform optical path switching control, and instructs the sleep control unit 232 to perform sleep control.

The optical path switching control unit 231 notifies the switching device 13 and the aggregation station 15 of optical path switching destination information (step S304). The optical path switching destination information is information regarding an optical path switching destination. In the example illustrated in FIG. 5, the optical path switching destination information includes information indicating the switching destination distributed station 14-1 as the optical path switching destination. When notified of the optical path switching destination information from the management control device 20, the switching device 13 instructs the radio station 12 connected to the switching source distributed station 14-2, the switching destination distributed station 14-1, and the switching source distributed station 14-2 to switch the optical path (step S305). For example, the switching device 13 instructs the radio station 12 connected to the switching source distributed station 14-2 to switch the optical path to the switching destination distributed station 14-1, instructs the switching destination distributed station 14-1 to switch so that the optical path is connected to the radio station 12 connected to the switching source distributed station 14-2, and instructs the switching source distributed station 14-2 not to set the optical path.

The radio station 12 connected to the switching source distributed station 14-2, the switching destination distributed station 14-1, and the switching source distributed station 14-2 prepare optical path switching (step S306, step S307, and step S308). The radio station 12 connected to the switching source distributed station 14-2, the switching destination distributed station 14-1, and the switching source distributed station 14-2 transmit an optical path switching response notification to the switching device 13 (step S309, step S310, and step S311). The optical path switching response notification is a signal including contents indicating that the optical path switching destination information has been received.

When the optical path switching response notification is obtained from the radio station 12 connected to the switching source distributed station 14-2, the switching destination distributed station 14-1, and the switching source distributed station 14-2, the switching device 13 transmits an optical path switching start notification to the radio station 12 connected to the switching source distributed station 14-2 and the switching destination distributed station 14-1 (step S312). The optical path switching start notification is a signal including a command to start the optical path switching.

The radio station 12 connected to the switching source distributed station 14-2 and the switching destination distributed station 14-1 switch the optical path in response to the reception of the optical path switching start notification (step S313 and step S314). With this processing, the optical path of the radio station 12 connected to the switching source distributed station 14-2 is switched to head for the switching destination distributed station 14-1. That is, the radio station 12 and the switching destination distributed station 14-1 become a communicable state.

The switching destination distributed station 14-1 transmits a path switching request to the core device 16 (step S315). The path switching request is a signal including contents for requesting switching of a communication path in the core device 16. The core device 16 switches the path in response to the reception of the path switching request (step S316).

When the path switching is completed, the core device 16 transmits a path switching response notification to the switching destination distributed station 14-1 (step S317). The path switching response notification is a signal including contents indicating that the switching of the communication path in the core device 16 is completed.

When the optical path switching is completed, the radio station 12 transmits an optical path switching completion notification to the management control device 20 (step S318). The optical path switching completion notification is a signal including contents indicating that the optical path switching is completed. When the optical path switching is completed, the switching destination distributed station 14-1 transmits an optical path switching completion notification to the management control device 20 (step S319).

When the optical path switching completion notification is received from the transmission destination of the optical path switching start notification, the sleep control unit 232 transmits a sleep permission notification to the switching source distributed station 14-2 (step S320). When the sleep permission notification is obtained from the management control device 20, the switching source distributed station 14-2 transmits a sleep response notification to the management control device 20 (step S321). The sleep response notification is a signal including contents indicating that the sleep permission notification has been received. After transmitting the sleep response notification, the switching source distributed station 14-2 transitions to the sleep state (step S322).

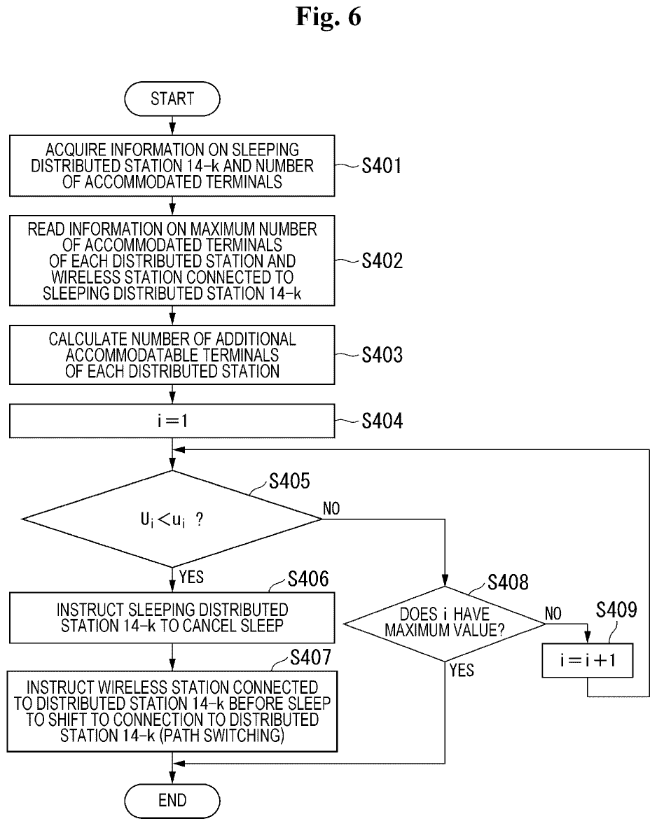

FIG. 6 is a flowchart illustrating an example of a flow of sleep cancellation processing executed by the management control device 20 according to the first embodiment. The acquisition unit 211 acquires information of the number of accommodated terminals and the sleeping distributed station 14-k from each distributed station 14 as the cooperation information (step S401). The acquisition unit 211 notifies the analysis unit 22 of the acquired information of the number of accommodated terminals and the sleeping distributed station 14-k.

The real-time analysis unit 222 reads information of the maximum number of accommodated terminals of each distributed station 14 and information of the radio station 12 connected to the sleeping distributed station 14-k from the cooperation information accumulation unit 221 (step S402). The real-time analysis unit 222 calculates the number of additionally accommodatable terminals of each distributed station 14 on the basis of the cooperation information for each distributed station 14 accumulated in the cooperation information accumulation unit 221 (step S403).

Next, the real-time analysis unit 222 substitutes a value of 1 for constant i (step S404). The real-time analysis unit 222 determines whether Uᵢ<uᵢ is satisfied (step S405). The condition indicated by Uᵢ<uᵢ is a specific example of a first sleep cancellation condition. When determining that the first sleep cancellation condition (for example, Uᵢ<uᵢ) is satisfied (step S405—YES), the real-time analysis unit 222 determines that the sleep cancellation of the sleeping distributed station 14-k and the optical path switching are necessary.

The real-time analysis unit 222 notifies the control unit 23 of the determination result. The sleep control unit 232 transmits an instruction to cancel the sleep to the sleeping distributed station 14-k on the basis of the determination result (step S406). The optical path switching control unit 231 acquires information of the radio station 12 connected to the distributed station 14-k before sleep from the information acquired in the processing of step S402. The optical path switching control unit 231 instructs the radio station 12 connected to the distributed station 14-k before sleep to change the connection to the distributed station 14-k.

In the processing of step S405, in a case where it is determined that the first sleep cancellation condition (for example, Uᵢ<uᵢ) is not satisfied (step S405—NO), the real-time analysis unit 222 determines whether or not i is the maximum value (step S408). When it is determined that i is the maximum value (step S408—YES), the real-time analysis unit 222 ends the processing.

On the other hand, when determining that i is not the maximum value (step S408—NO), the real-time analysis unit 222 adds a value of 1 to the value of i (step S409). Thereafter, the real-time analysis unit 222 executes the processing of step S405 again.

Here, the processing of FIG. 6 will be described using specific numerical values. As an example, it is assumed that the total number of the distributed stations 14 is 2 (I=2), the maximum number of accommodated terminals of the distributed station 14-1 is 1000, the number of accommodated terminals of the distributed station 14-1 is 800, the maximum number of accommodated terminals of the distributed station 14-2 is 800, and the number of accommodated terminals of the distributed station 14-2 is 1000.

When i=1, Uᵢ<uᵢ becomes 1000>800, and the first sleep cancellation condition is not satisfied. In a case where it is determined that the first sleep cancellation condition (for example, Uᵢ<uᵢ) is not satisfied (step S405—NO), the real-time analysis unit 222 determines whether or not i is the maximum value (step S408). At present, since i=1, the real-time analysis unit 222 determines that i is not the maximum value.

The real-time analysis unit 222 adds a value of 1 to the value of i to obtain i=2. The real-time analysis unit 222 executes the processing of step S405 again. When i=2, U₂<u₂ becomes 800<1000, and the first sleep cancellation condition is satisfied. Thereafter, the processing of steps S406 and S407 is executed.

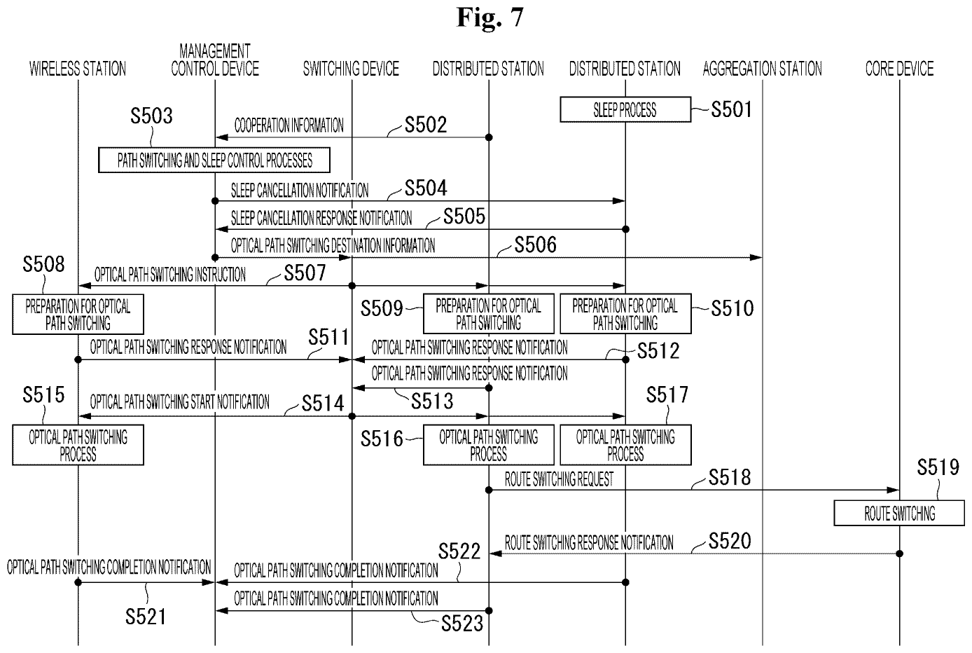

FIG. 7 is a sequence diagram illustrating an example of a detailed flow of sleep cancellation processing executed by the mobile NW system 100 according to the first embodiment. Note that, in the description of FIG. 7, it is assumed that the distributed station 14-2 is in a sleep state.

The distributed station 14-2 is in a sleep state (step S501). The acquisition unit 211 of the management control device 20 acquires the cooperation information from the distributed station 14-1 at a predetermined cycle (step S502). The acquisition unit 211 accumulates the acquired cooperation information in the cooperation information accumulation unit 221. When the cooperation information is accumulated in the cooperation information accumulation unit 221, the real-time analysis unit 222 performs optical path switching and sleep control determination (step S503). The optical path switching and the sleep control determination in step S503 are whether or not the sleep cancellation condition is satisfied. Here, it is assumed that the sleep cancellation condition is satisfied.

The sleep control unit 232 of the management control device 20 transmits a sleep cancellation notification to the distributed station 14-2 (step S504). The sleep cancellation notification is a signal including contents indicating cancellation of the sleep state. In response to the reception of the sleep cancellation notification, the distributed station 14-2 transmits a sleep cancellation response notification to the management control device 20 (step S505). The sleep cancellation response notification is a signal including contents indicating that the sleep cancellation notification has been received.

The optical path switching control unit 231 notifies the switching device 13 and the aggregation station 15 of optical path switching destination information (step S506). When notified of the optical path switching destination information from the management control device 20, the switching device 13 instructs the radio station 12, the distributed station 14-1, and the distributed station 14-2 to switch the optical path (step S507).

The radio station 12, the distributed station 14-1, and the distributed station 14-2 prepare optical path switching (step S508, step S509, and step S510). When the optical path switching preparation is completed, the radio station 12, the distributed station 14-1, and the distributed station 14-2 transmit an optical path switching response notification indicating that the switching preparation is completed to the switching device 13 (step S511, step S512, and step S513).

When the optical path switching response notification is obtained from the radio station 12, the distributed station 14-1, and the distributed station 14-2, the switching device 13 transmits an optical path switching start notification to the radio station 12, the distributed station 14-1, and the distributed station 14-2 (step S514).

The radio station 12, the distributed station 14-1, and the distributed station 14-2 switch the optical path in response to the reception of the optical path switching start notification (step S515, step S516, and step S517). The distributed station 14-1 transmits a path switching request to the core device 16 (step S518). The core device 16 switches the path in response to the reception of the path switching request (step S519). When the path switching is completed, the core device 16 transmits a path switching response notification to the distributed station 14-1 (step S520).

When the optical path switching is completed, the radio station 12 transmits an optical path switching completion notification to the management control device 20 (step S521). When the optical path switching is completed, the distributed station 14-1 transmits an optical path switching completion notification to the management control device 20 (step S522). When the optical path switching is completed, the distributed station 14-2 transmits an optical path switching completion notification to the management control device 20 (step S523).

The mobile NW system 100 configured as described above includes one or more radio stations 12 that perform wireless communication with one or more terminals 11, a plurality of distributed stations 14 connected to the one or more radio stations 12 via the switching device 13, the cooperation information collection unit 21 that acquires cooperation information indicating a state of communication between the plurality of distributed stations 14 and the one or more terminals 11 at a predetermined cycle, the optical path switching control unit 231 that controls switching of an optical path between the one or more radio stations 12 and the plurality of distributed stations 14 in a case where it is determined that switching of the optical path between the one or more radio stations 12 and the plurality of distributed stations 14 is necessary on the basis of the cooperation information, and the sleep control unit 232 that causes a distributed station capable of sleep to transition to a sleep state after switching of the optical path is performed. As a result, the optical path switching and the sleep control are performed while analyzing the load of each distributed station 14. Accordingly, it is possible to increase the effect of power saving without deterioration in communication quality.

### First Modification of First Embodiment

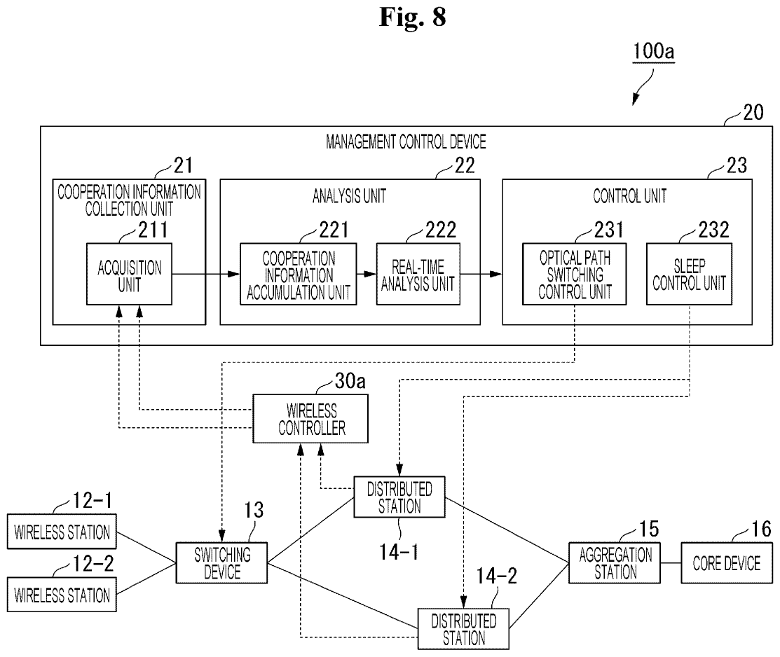

The above-described embodiment indicates the configuration in which the management control device 20 directly acquires the cooperation information from the distributed station 14. The management control device 20 may acquire the cooperation information via another device. Here, the another device is, for example, a wireless controller. FIG. 8 is a diagram illustrating a configuration example of a mobile NW system 100a according to the first modification of the first embodiment. The mobile NW system 100a includes one or more radio stations 12, a switching device 13, a plurality of distributed stations 14, an aggregation station 15, a core device 16, a management control device 20, and a wireless controller 30a. As illustrated in FIG. 8, in the mobile NW system 100a, the wireless controller 30a is provided between the management control device 20 and the distributed stations 14.

The wireless controller 30a acquires the cooperation information from each distributed station 14 at a predetermined cycle by wireless communication. The wireless controller 30a transmits the acquired cooperation information to the management control device 20 by wireless communication. Note that the wireless controller 30a may receive a sleep control instruction from the management control device 20 and transmit the sleep control instruction to the switching source distributed station.

With this configuration, the cooperation information can be collected by wireless communication.

### Second Modification of First Embodiment

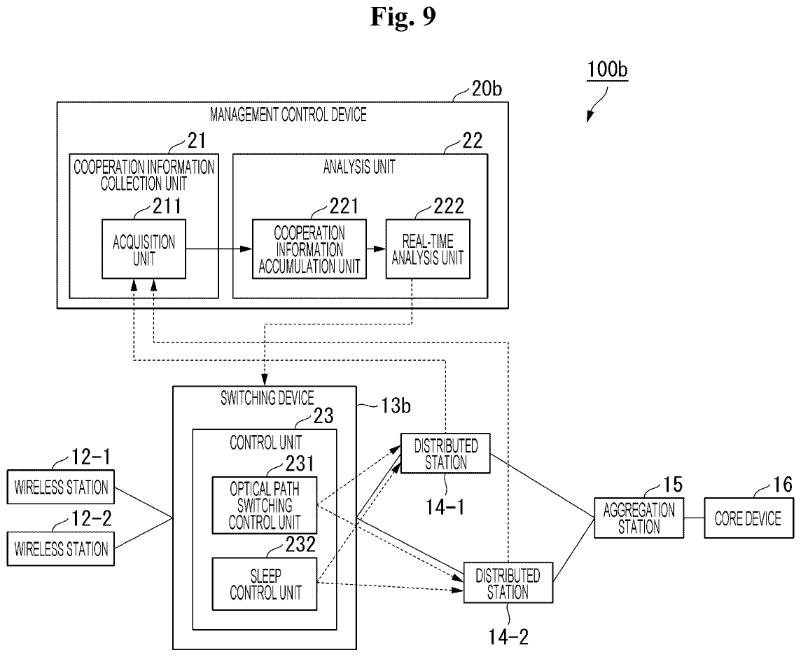

The above-described embodiment indicates the configuration in which the management control device 20 performs the optical path switching control processing and the sleep control processing. On the other hand, the switching device 13 may be configured to perform the optical path switching control processing and the sleep control processing. FIG. 9 is a diagram illustrating a configuration example of a mobile NW system 100b according to the second modification of the first embodiment. The mobile NW system 100b includes one or more radio stations 12, a switching device 13b, a plurality of distributed stations 14, an aggregation station 15, a core device 16, and a management control device 20b.

As illustrated in FIG. 9, the switching device 13b includes the control unit 23, and the management control device 20b does not include the control unit 23. The real-time analysis unit 222 of the management control device 20b notifies the switching device 13b of the analysis result. Note that the real-time analysis unit 222 may notify the switching device 13b of the analysis result only when optical path switching and sleep control are performed. The control unit 23 of the switching device 13b performs the optical path switching control processing and the sleep control processing on the basis of the analysis result notification of which has been given from the management control device 20b.

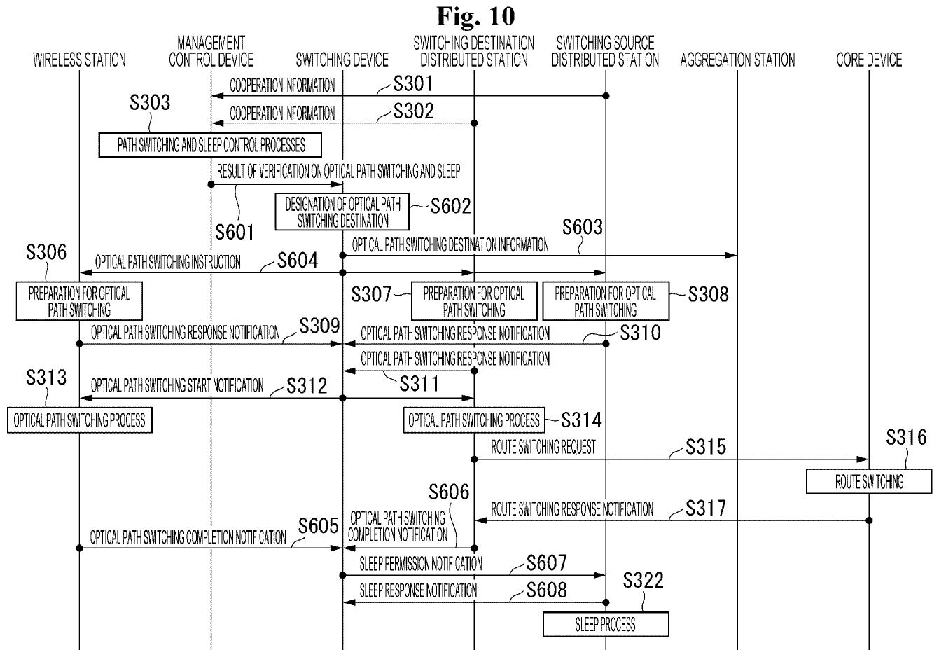

FIG. 10 is a sequence diagram illustrating an example of a detailed flow of sleep processing executed by the mobile NW system 100b according to the second modification of the first embodiment. In FIG. 10, the same processing steps as those in FIG. 5 are denoted by the same reference numerals as those used in FIG. 5, and description thereof is omitted. Note that, in the description of FIG. 10, it is assumed that the distributed station 14-1 is a switching destination distributed station and the distributed station 14-2 is a switching source distributed station. Here, the switching destination distributed station 14-1 and the switching source distributed station 14-2 will be described.

After the processing from step S301 to step S303 is executed, the real-time analysis unit 222 instructs the switching device 13b to perform optical path switching control and sleep control when the first switching condition is satisfied (step S601). The switching device 13b receives the instruction transmitted from the management control device 20b.

The optical path switching control unit 231 of the switching device 13b determines the optical path switching destination from the information included in the received instruction (step S602). The optical path switching control unit 231 notifies the aggregation station 15 of optical path switching destination information (step S603). Thereafter, the optical path switching control unit 231 instructs the radio station 12 connected to the switching source distributed station 14-2, the switching destination distributed station 14-1, and the switching source distributed station 14-2 to switch the optical path (step S604). Thereafter, the processing from step S306 to step S317 is executed.

When the optical path switching is completed, the radio station 12 transmits an optical path switching completion notification to the switching device 13b (step S605). Note that the radio station 12 may also transmit the optical path switching completion notification to the management control device 20b. When the optical path switching is completed, the switching destination distributed station 14-1 transmits an optical path switching completion notification to the switching device 13b (step S606). Note that the radio station 12 may also transmit the optical path switching completion notification to the management control device 20b.

When the optical path switching completion notification is received from the transmission destination of the optical path switching start notification, the sleep control unit 232 included in the switching device 13b transmits a sleep permission notification to the switching source distributed station 14-2 (step S607). When the sleep permission notification is obtained from the switching device 13b, the switching source distributed station 14-2 transmits a sleep response notification to the switching device 13b (step S608). After transmitting the sleep response notification, the switching source distributed station 14-2 transitions to the sleep state (step S322).

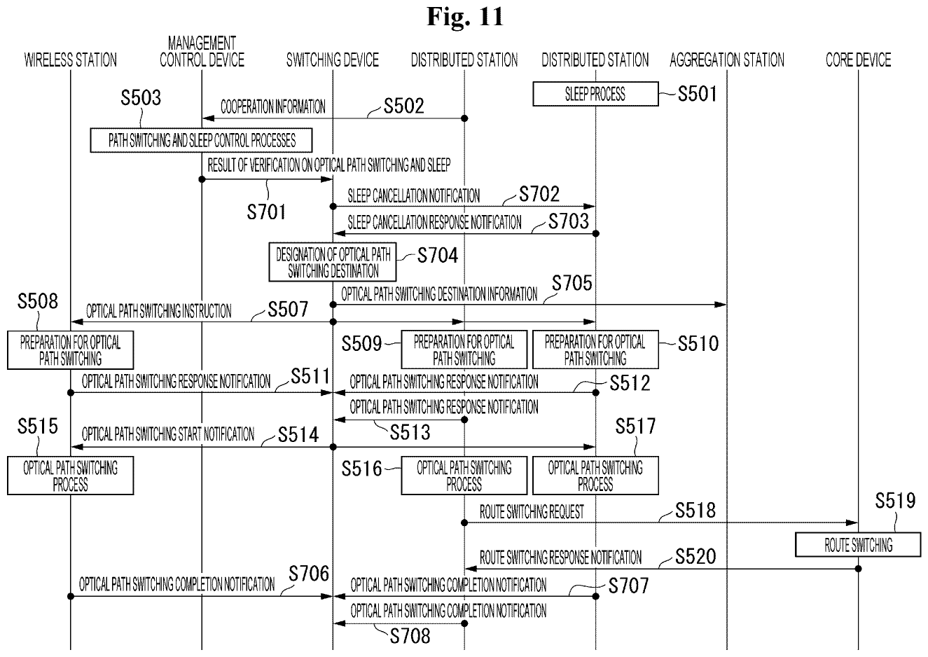

FIG. 11 is a sequence diagram illustrating an example of a detailed flow of sleep cancellation processing executed by the mobile NW system 100b according to the second modification of the first embodiment. In FIG. 11, the same processing steps as those in FIG. 7 are denoted by the same reference numerals as those used in FIG. 7, and description thereof is omitted. Note that, in the description of FIG. 11, it is assumed that the distributed station 14-2 is in a sleep state.

After the processing from step S501 to step S503 is executed, the real-time analysis unit 222 instructs the switching device 13b to perform optical path switching control and sleep control when the sleep cancellation condition is satisfied (step S701). The switching device 13b receives the instruction transmitted from the management control device 20b.

The sleep control unit 232 of the switching device 13b transmits a sleep cancellation notification to the distributed station 14-2 on the basis of the information included in the received instruction (step S702). In response to the reception of the sleep cancellation notification, the distributed station 14-2 transmits a sleep cancellation response notification to the switching device 13b (step S703).

The optical path switching control unit 231 of the switching device 13b determines the optical path switching destination from the information included in the received instruction (step S704). The optical path switching control unit 231 of the switching device 13b notifies the aggregation station 15 of optical path switching destination information (step S705). Thereafter, the processing from step S507 to step S520 is executed.

When the optical path switching is completed, the radio station 12 transmits an optical path switching completion notification to the switching device 13b (step S706). When the optical path switching is completed, the distributed station 14-1 transmits an optical path switching completion notification to the switching device 13b (step S707). When the optical path switching is completed, the distributed station 14-2 transmits an optical path switching completion notification to the switching device 13b (step S708).

### Second Embodiment

The second embodiment is different from the first embodiment in that processing load information (for example, information of the usage rate of the memory or information of the usage rate of the CPU for each distributed station) is further included as the cooperation information. In the second embodiment, as an example of the processing load information, information of the usage rate of the memory for each distributed station will be described as an example.

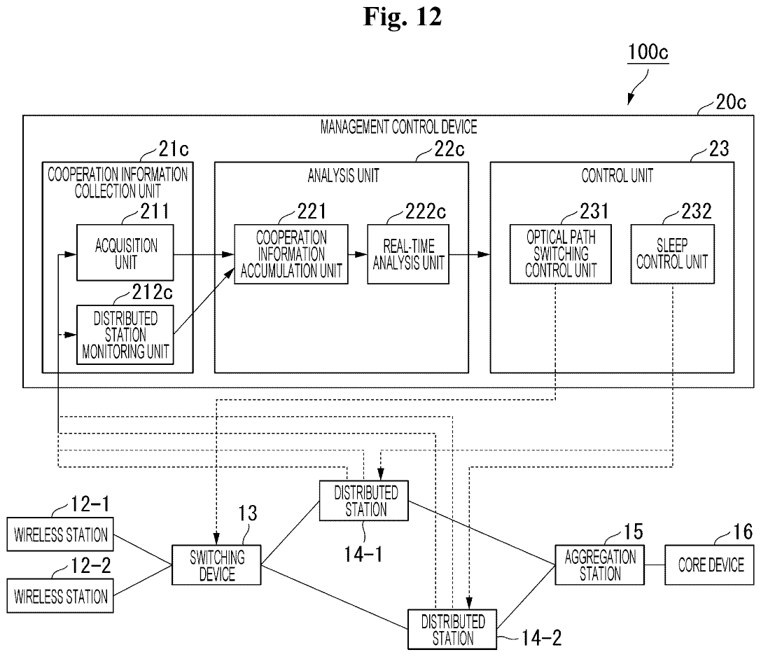

FIG. 12 is a diagram illustrating a configuration example of a mobile NW system 100c according to the second embodiment. The mobile NW system 100c according to the second embodiment includes one or more radio stations 12, a switching device 13, a plurality of distributed stations 14, an aggregation station 15, a core device 16, and a management control device 20c. The management control device 20c includes a cooperation information collection unit 21c, an analysis unit 22c, and a control unit 23.

The cooperation information collection unit 21c includes an acquisition unit 211 and a distributed station monitoring unit 212c. The distributed station monitoring unit 212c monitors each distributed station 14 and measures the memory usage rate for each distributed station 14. The distributed station monitoring unit 212c outputs information of the memory usage rate measured for each distributed station 14 to the analysis unit 22c as the cooperation information.

The analysis unit 22c includes a cooperation information accumulation unit 221 and a real-time analysis unit 222c. The real-time analysis unit 222c analyzes a state of communication in the mobile NW system 100c such as a change amount of the number of connections of the distributed station 14 per unit time on the basis of the cooperation information. Specifically, the real-time analysis unit 222c roughly calculates the memory usage rate per station by dividing the memory usage rate by the current number of accommodated terminals. Further, the real-time analysis unit 222c multiplies the number of accommodated terminals of another distributed station 14 by the memory usage rate per target distributed station 14, and determines optical path switching and sleep when the memory usage rate does not exceed 100% and the number of accommodated terminals of the distributed station 14 is smaller than the number of terminals that can be additionally accommodated in the target distributed station 14.

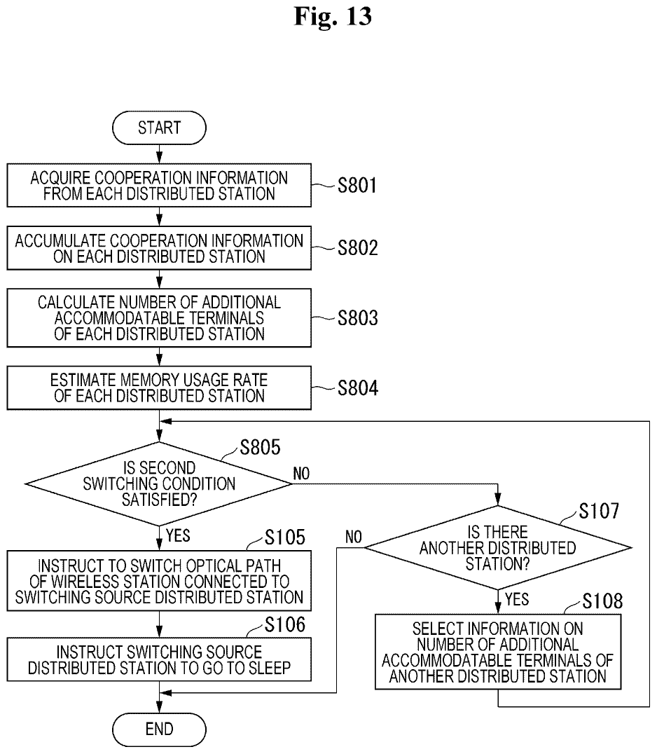

FIG. 13 is a flowchart illustrating an example of a flow of sleep processing executed by the management control device 20c according to the second embodiment. In FIG. 13, the same processing steps as those in FIG. 3 are denoted by the same reference numerals as those used in FIG. 3, and description thereof is omitted.

The cooperation information collection unit 21c acquires the cooperation information from each distributed station 14 (step S801). Specifically, the acquisition unit 211 acquires at least information of the number of accommodated terminals, information of the maximum number of accommodated terminals, and the like as the cooperation information from each distributed station 14. Further, the distributed station monitoring unit 212c measures the memory usage rate for each distributed station 14. The cooperation information collection unit 21c accumulates the acquired cooperation information of each distributed station 14 in the cooperation information accumulation unit 221 (step S802). Specifically, in addition to the cooperation information including at least the information of the number of accommodated terminals, the information of the maximum number of accommodated terminals, and the like from each distributed station 14, the cooperation information collection unit 21c accumulates information of the memory usage rate of each distributed station 14 in the cooperation information accumulation unit 221 as the cooperation information.

The real-time analysis unit 222c calculates the number of additionally accommodatable terminals of each distributed station 14 on the basis of the cooperation information for each distributed station 14 accumulated in the cooperation information accumulation unit 221 (step S803). Further, the real-time analysis unit 222c roughly calculates the memory usage rate of each distributed station 14 on the basis of the cooperation information for each distributed station 14 accumulated in the cooperation information accumulation unit 221 (step S804).

The real-time analysis unit 222c determines whether or not a second switching condition is satisfied (step S805). The second switching condition is a condition indicating that switching of the optical path between the radio station 12 and the distributed station 14 is necessary, for example, that the number of additionally accommodatable terminals in a certain distributed station 14 is larger than the number of accommodated terminals of the distributed station 14 as a sleep determination target, and the memory usage rate does not exceed 100%.

When determining that the second switching condition is satisfied (step S805—YES), the real-time analysis unit 222c executes the processing of step S105 and subsequent steps. On the other hand, when determining that the second switching condition is not satisfied (step S805—NO), the real-time analysis unit 222c executes the processing of step S107 and subsequent steps.

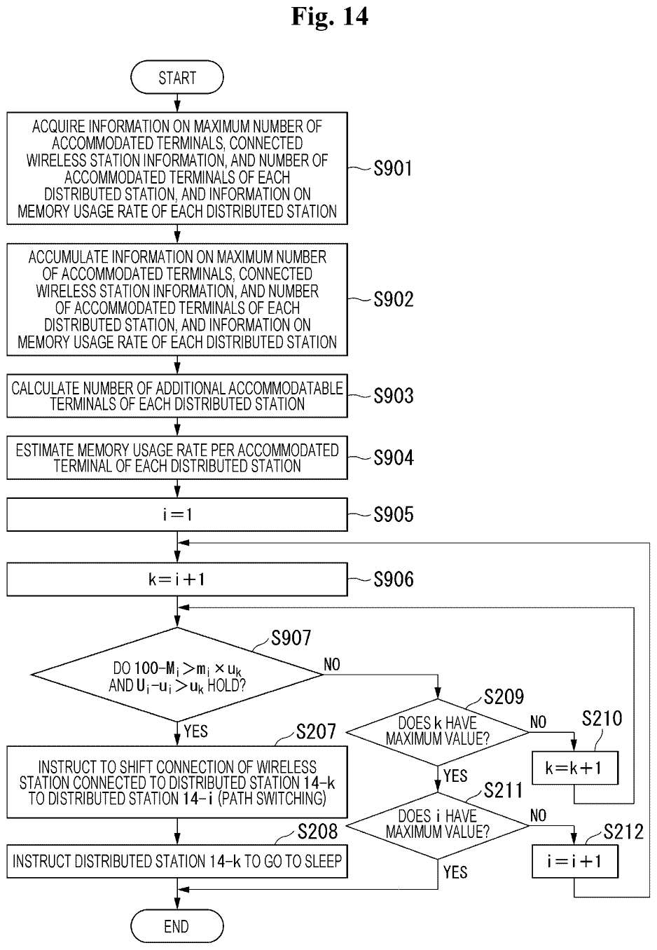

FIG. 14 is a flowchart illustrating an example of a flow of sleep processing executed by the management control device 20c according to the second embodiment. Note that, in the processing illustrated in FIG. 14, contents more specifically indicating the processing illustrated in FIG. 13 will be described. In FIG. 14, the same processing steps as those in FIG. 4 are denoted by the same reference numerals as those used in FIG. 4, and description thereof is omitted.

The acquisition unit 211 acquires, from each distributed station 14, the information of the maximum number of accommodated terminals, the connected radio station information, and the number of accommodated terminals of each distributed station as the cooperation information. Further, the distributed station monitoring unit 212c acquires information of the memory usage rate of each distributed station 14 (step S901).

The acquisition unit 211 accumulates the acquired cooperation information of each distributed station 14 in the cooperation information accumulation unit 221. The distributed station monitoring unit 212c accumulates the acquired information of the memory usage rate of each distributed station 14 as the cooperation information (step S902). The real-time analysis unit 222c calculates the number of additionally accommodatable terminals of each distributed station 14 on the basis of the cooperation information for each distributed station 14 accumulated in the cooperation information accumulation unit 221 (step S903). Further, the real-time analysis unit 222c roughly calculates the memory usage rate per distributed station 14 on the basis of the cooperation information for each distributed station 14 accumulated in the cooperation information accumulation unit 221 (step S904).

Next, the real-time analysis unit 222c substitutes a value of 1 for constant i (step S905). Next, the real-time analysis unit 222c substitutes a value of (i+1) for k (step S906). Thereafter, the real-time analysis unit 222c determines whether 100−Mᵢ>mᵢ×uₖ and Uᵢ−uᵢ>uₖ is satisfied (step S907). Mᵢ indicates the memory usage rate of the distributed station 14-i, and mᵢ indicates the memory usage rate per distributed station 14. mᵢ is calculated in the processing of step S904. The condition indicated by 100−Mᵢ>mᵢ×uₖ and Uᵢ−uᵢ>uₖ is a specific example of the second switching condition.

When determining that the second switching condition is satisfied (step S907—YES), the real-time analysis unit 222c executes the processing of step S207 and subsequent steps. On the other hand, when determining that the second switching condition is not satisfied (step S907—NO), the real-time analysis unit 222c executes the processing of step S209 and subsequent steps.

Here, the processing of FIG. 14 will be described using specific numerical values. As an example, it is assumed that the maximum number of accommodated terminals of the distributed station 14-1 is 1000, the number of accommodated terminals of the distributed station 14-1 is 100, the memory usage rate M₁ of the distributed station 14-1 is 20%, the maximum number of accommodated terminals of the distributed station 14-2 is 800, the number of accommodated terminals of the distributed station 14-2 is 200, and the memory usage rate M₂ of the distributed station 14-2 is 30%. In this case, in the processing of step S904, the real-time analysis unit 222c calculates m₁=20/100=0.2 and m₂=30/200=0.15 as rough calculation values of the memory usage rate per distributed station 14. mᵢ indicates a rough calculation value of the memory usage rate per distributed station 14-1, and m₂ indicates a rough calculation value of the memory usage rate per distributed station 14-2.

In the processing of step S907, the real-time analysis unit 222c determines whether 100−Mᵢ>mᵢ×uₖ and Uᵢ−uᵢ>uₖ are satisfied. When i=1 and k=2, those described below are indicated.

$$100 - {M}_{i} \text{=>} 100 - 20 = 80 \\ {m}_{i} \times {u}_{k} \text{=>} 0.2 \times 200 = 40 \\ {U}_{i} - {u}_{i} \text{=>} 1000 - 100 = 900$$

Based on the above results, 100−Mᵢ>mᵢ×uₖ and Uᵢ−uᵢ>uₖ are 180>40 and 900>200. In this case, the real-time analysis unit 222c determines that the second switching condition is satisfied. Thus, the real-time analysis unit 222c determines switching so as to connect the radio station 12 connected to the distributed station 14-2 to the distributed station 14-1, and determines sleep so as to cause the distributed station 14-2 transition to the sleep state. The real-time analysis unit 222c notifies the optical path switching control unit 231 of the result of the switching determination to connect the radio station 12 connected to the distributed station 14-2 to the distributed station 14-1, and notifies the sleep control unit 232 of the sleep determination result to cause the distributed station 14-2 to transition to the sleep state.

As a result, the optical path switching control unit 231 controls switching of the optical path so as to connect the radio station 12 connected to the distributed station 14-2 to the distributed station 14-1 in accordance with the notification from the real-time analysis unit 222c. The sleep control unit 232 controls sleep so as to cause the distributed station 14-2 to transition to the sleep state in accordance with the notification from the real-time analysis unit 222c.

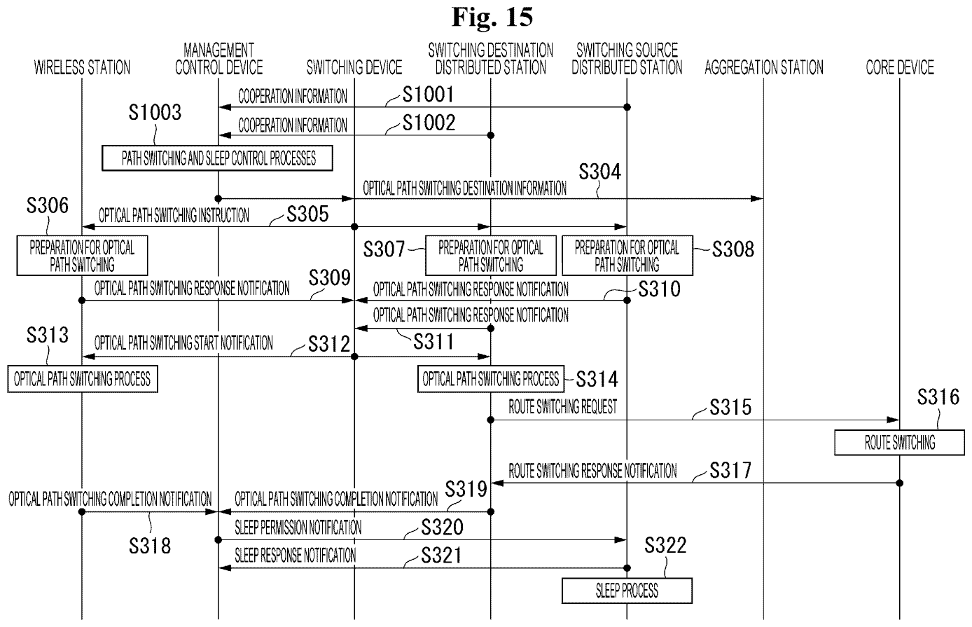

FIG. 15 is a sequence diagram illustrating an example of a detailed flow of sleep processing executed by the mobile NW system 100c according to the second embodiment. In FIG. 15, the same processing steps as those in FIG. 5 are denoted by the same reference numerals as those used in FIG. 5, and description thereof is omitted. Note that, in the description of FIG. 15, it is assumed that the distributed station 14-1 is a switching destination distributed station and the distributed station 14-2 is a switching source distributed station. Here, the switching destination distributed station 14-1 and the switching source distributed station 14-2 will be described.

The cooperation information collection unit 21c of the management control device 20c acquires the cooperation information from the switching destination distributed station 14-1 and the switching source distributed station 14-2 at a predetermined cycle (step S1001 and step S1002). Note that the cooperation information acquired in step S1001 and step S1002 includes information of the usage rate of the memory for each distributed station 14 in addition to at least the information of the number of accommodated terminals, information of the maximum number of accommodated terminals, and the like. The cooperation information collection unit 21c accumulates the acquired cooperation information in the cooperation information accumulation unit 221.

When the cooperation information is accumulated in the cooperation information accumulation unit 221, the real-time analysis unit 222c performs optical path switching and sleep control determination (step S1003). The optical path switching and the sleep control determination in step S1003 is a determination as to whether or not the second switching condition is satisfied in step S805. Here, it is assumed that the second switching condition in step S805 is satisfied. When the second switching condition is satisfied, the real-time analysis unit 222c executes the processing of step S304 and subsequent steps.

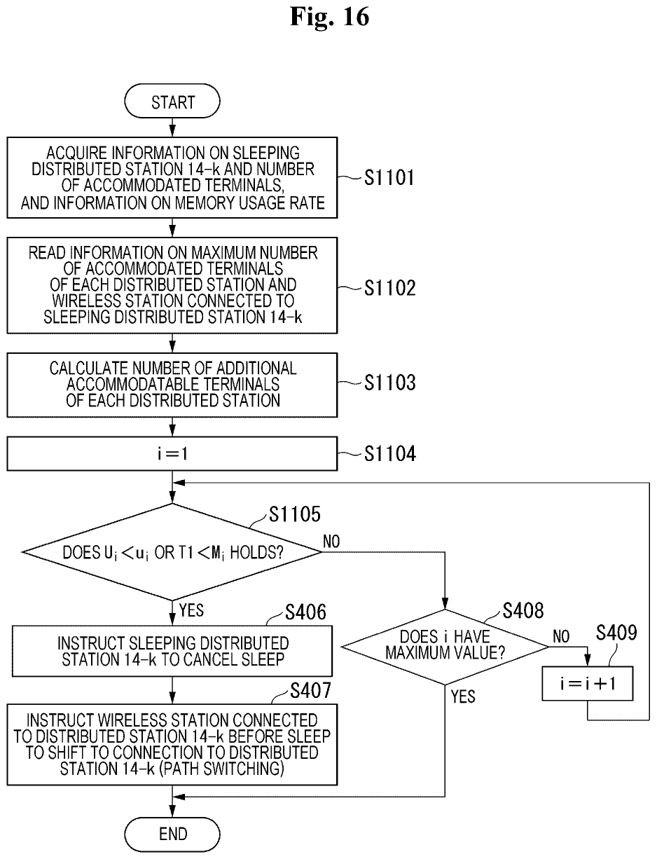

FIG. 16 is a flowchart illustrating an example of a flow of sleep cancellation processing executed by the management control device 20c according to the second embodiment. In FIG. 16, the same processing steps as those in FIG. 6 are denoted by the same reference numerals as those used in FIG. 6, and description thereof is omitted.

The acquisition unit 211 acquires information of the number of accommodated terminals and the sleeping distributed station 14-k from each distributed station 14 as the cooperation information. Further, the distributed station monitoring unit 212c acquires information of the memory usage rate of each distributed station 14 as the cooperation information (step S1101). The acquisition unit 211 notifies the analysis unit 22c of the acquired information of the number of accommodated terminals, the sleeping distributed station 14-k, and the information of the memory usage rate.

The real-time analysis unit 222c of the analysis unit 22c reads information of the maximum number of accommodated terminals of each distributed station 14 and information of the radio station 12 connected to the sleeping distributed station 14-k from the cooperation information accumulation unit 221 (step S1102). The real-time analysis unit 222c calculates the number of additionally accommodatable terminals of each distributed station 14 on the basis of the acquired cooperation information for each distributed station 14 (step S1103).

Next, the real-time analysis unit 222c substitutes a value of 1 for constant i (step S1104). The real-time analysis unit 222c determines whether either Uᵢ<uᵢ or T1<Mᵢ is satisfied (step S1105). The condition indicated by Uᵢ<uᵢ or T1<Mᵢ is a specific example of a second sleep cancellation condition. In the second sleep cancellation condition, T1<Mᵢ means that the memory usage rate Mᵢ of the distributed station 14-i exceeds a threshold T1 (for example, a predetermined value such as 80, 90, or 100%).

When determining that the second sleep cancellation condition (for example, Uᵢ<uᵢ or T1<Mᵢ) is satisfied (step S1105—YES), the real-time analysis unit 222c determines that the optical path switching and the sleep cancellation of the sleeping distributed station 14-k are necessary.

The real-time analysis unit 222c notifies the control unit 23 of the determination result. Thereafter, the processing of step S406 and subsequent steps is executed. On the other hand, when determining that the second sleep cancellation condition (for example, Uᵢ<uᵢ or T1<Mᵢ) is not satisfied (step S1105—NO), the real-time analysis unit 222c executes the processing of step S408.

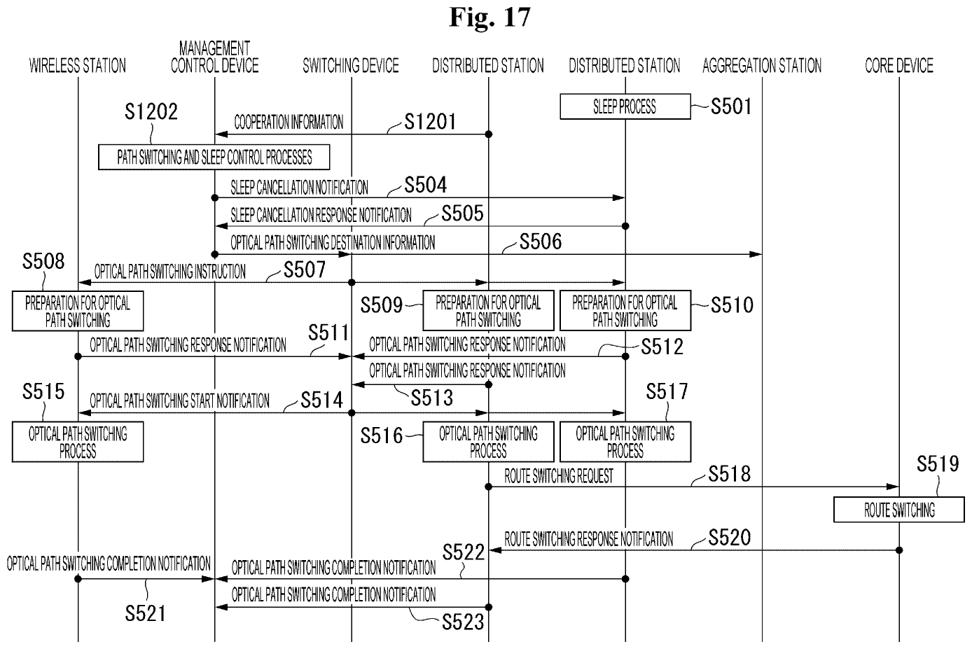

FIG. 17 is a sequence diagram illustrating an example of a detailed flow of sleep cancellation processing executed by the mobile NW system 100c according to the second embodiment. In FIG. 17, the same processing steps as those in FIG. 7 are denoted by the same reference numerals as those used in FIG. 7, and description thereof is omitted. Note that, in the description of FIG. 17, it is assumed that the distributed station 14-2 is in a sleep state.

The distributed station 14-2 is in a sleep state (step S501). The cooperation information collection unit 21c of the management control device 20c acquires the cooperation information from the distributed station 14-1 at a predetermined cycle (step S1201). Note that the cooperation information acquired in step S1201 includes information of the usage rate of the memory for each distributed station 14 in addition to at least the information of the number of accommodated terminals, information of the maximum number of accommodated terminals, and the like. The cooperation information collection unit 21c accumulates the acquired cooperation information in the cooperation information accumulation unit 221.

When the cooperation information is accumulated in the cooperation information accumulation unit 221, the real-time analysis unit 222c performs optical path switching and sleep control determination (step S1202). The optical path switching and the sleep control determination in step S1202 are whether or not the sleep cancellation condition is satisfied. Here, it is assumed that the sleep cancellation condition is satisfied. When the sleep cancellation condition is satisfied, the real-time analysis unit 222c executes the processing of step S504 and subsequent steps.

With the mobile NW system 100c according to the second embodiment configured as described above, the same effects as those of the first embodiment can be achieved. Specifically, in the mobile NW system 100c, the management control device 20c further acquires the information of the usage rate of the memory for each distributed station 14 as the cooperation information, and determines the necessity of optical path switching on the basis of the cooperation information. When it is determined that it is necessary to switch the optical path, the management control device 20c controls switching of the optical path between one or more radio stations 12 and the plurality of distributed stations 14. Further, the management control device 20c causes the distributed station capable of sleep to transition to the sleep state after the optical path switching is performed. As a result, the optical path switching and the sleep control are performed while analyzing the load of each distributed station 14. Accordingly, it is possible to increase the effect of power saving without deterioration in communication quality.

### First Modification of Second Embodiment

The above-described embodiment indicates the configuration in which the management control device 20c directly acquires the cooperation information from the distributed station 14. The management control device 20c may acquire the cooperation information via another device. Here, the another device is, for example, a wireless controller. In such a configuration, the mobile NW system 100c newly includes the wireless controller 30a, and the wireless controller 30a is provided between the management control device 20c and the distributed stations 14.

The wireless controller 30a acquires the cooperation information from each distributed station 14 at a predetermined cycle by wireless communication. The wireless controller 30a transmits the acquired cooperation information to the management control device 20c by wireless communication. Note that the wireless controller 30a may receive a sleep control instruction from the management control device 20c and transmit the sleep control instruction to the switching source distributed station.

With this configuration, the cooperation information can be collected by wireless communication.

### Second Modification of Second Embodiment

The above-described embodiment indicates the configuration in which the management control device 20c performs the optical path switching control processing and the sleep control processing. On the other hand, the switching device 13 may be configured to perform the optical path switching control processing and the sleep control processing. In such a configuration, the switching device 13 includes the control unit 23, and the management control device 20c does not include the control unit 23. The real-time analysis unit 222c of the management control device 20c notifies the switching device 13 of the analysis result. Note that the real-time analysis unit 222c may notify the switching device 13 of the analysis result only when optical path switching and sleep control are performed. The control unit 23 of the switching device 13 performs the optical path switching control processing and the sleep control processing on the basis of the analysis result notification of which has been given from the management control device 20c.

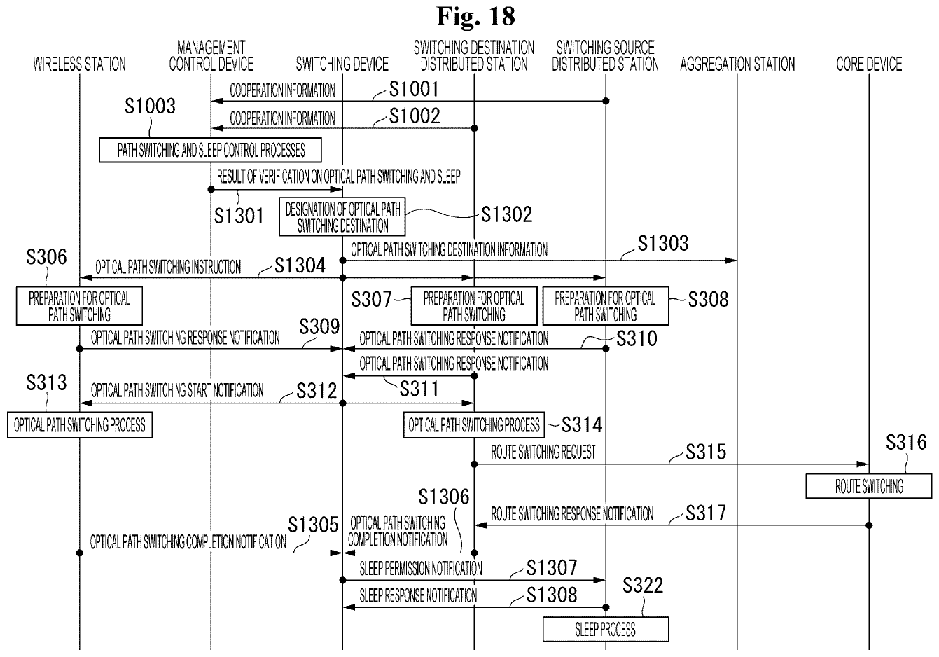

FIG. 18 is a sequence diagram illustrating an example of a detailed flow of sleep processing executed by the mobile NW system 100c according to the second modification of the second embodiment. In FIG. 18, the same processing steps as those in FIG. 15 are denoted by the same reference numerals as those used in FIG. 15, and description thereof is omitted.

After the processing from step S1001 to step S1003 is executed, the real-time analysis unit 222c instructs the switching device 13b to perform optical path switching control and sleep control when the second switching condition is satisfied (step S1301). The switching device 13b receives the instruction transmitted from the management control device 20c.

The optical path switching control unit 231 of the switching device 13b determines the optical path switching destination from the information included in the received instruction (step S1302). The optical path switching control unit 231 notifies the aggregation station 15 of optical path switching destination information (step S1303). Thereafter, the optical path switching control unit 231 instructs the radio station 12 connected to the switching source distributed station 14-2, the switching destination distributed station 14-1, and the switching source distributed station 14-2 to switch the optical path (step S1304). Thereafter, the processing from step S306 to step S317 is executed.

When the optical path switching is completed, the radio station 12 transmits an optical path switching completion notification to the switching device 13b (step S1305). Note that the radio station 12 may also transmit the optical path switching completion notification to the management control device 20c. When the optical path switching is completed, the switching destination distributed station 14-1 transmits an optical path switching completion notification to the switching device 13 (step S1306). Note that the radio station 12 may also transmit the optical path switching completion notification to the management control device 20c.

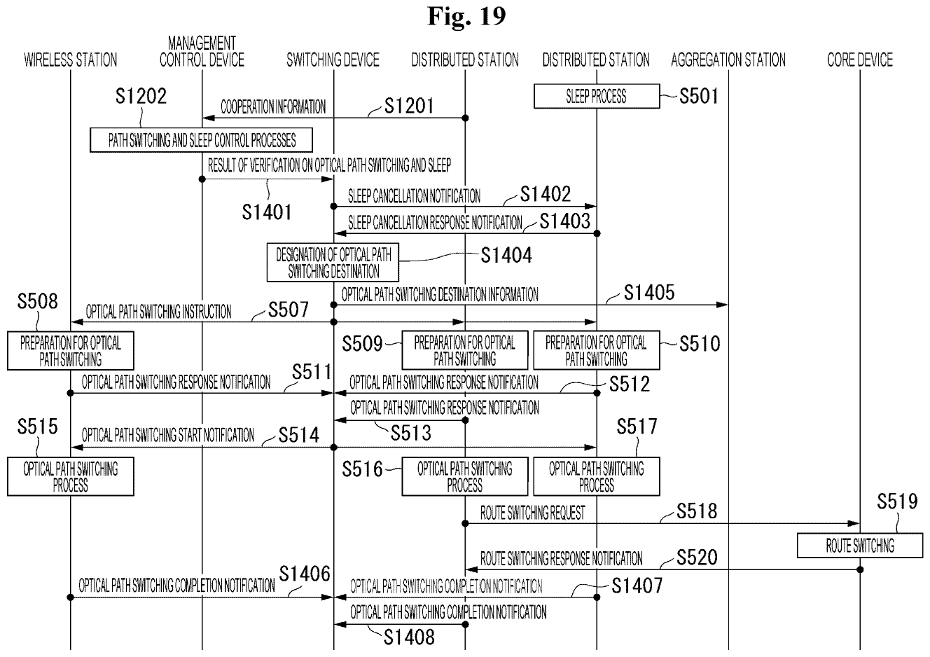

When the optical path switching completion notification is received from the transmission destination of the optical path switching start notification, the sleep control unit 232 included in the switching device 13b transmits a sleep permission notification to the switching source distributed station 14-2 (step S1307). When the sleep permission notification is obtained from the switching device 13b, the switching source distributed station 14-2 transmits a sleep response notification to the switching device 13 (step S1308). After transmitting the sleep response notification, the switching source distributed station 14-2 transitions to the sleep state (step S322). FIG. 19 is a sequence diagram illustrating an example of a detailed flow of sleep cancellation processing executed by the mobile NW system 100c according to the second modification of the second embodiment. In FIG. 19, the same processing steps as those in FIG. 17 are denoted by the same reference numerals as those used in FIG. 17, and description thereof is omitted. Note that, in the description of FIG. 17, it is assumed that the distributed station 14-2 is in a sleep state.

After the processing of step S501, step S1201, and step S1202 is executed, the real-time analysis unit 222c instructs the switching device 13b to perform optical path switching control and sleep control when the sleep cancellation condition is satisfied (step S1401). The switching device 13b receives the instruction transmitted from the management control device 20c.

The sleep control unit 232 of the switching device 13b transmits a sleep cancellation notification to the distributed station 14-2 on the basis of the information included in the received instruction (step S1402). In response to the reception of the sleep cancellation notification, the distributed station 14-2 transmits a sleep cancellation response notification to the switching device 13b (step S1403).

The optical path switching control unit 231 of the switching device 13b determines the optical path switching destination from the information included in the received instruction (step S1404). The optical path switching control unit 231 of the switching device 13b notifies the aggregation station 15 of optical path switching destination information (step S1405). Thereafter, the processing from step S507 to step S520 is executed.

When the optical path switching is completed, the radio station 12 transmits an optical path switching completion notification to the switching device 13b (step S1406). When the optical path switching is completed, the distributed station 14-1 transmits an optical path switching completion notification to the switching device 13b (step S1407). When the optical path switching is completed, the distributed station 14-2 transmits an optical path switching completion notification to the switching device 13b (step S1408).

### Third Embodiment

The third embodiment is different from the second embodiment in that processing load information (for example, information of the usage rate of the memory or information of the usage rate of the CPU for each distributed station) and processing delay information for each distributed station are further included as the cooperation information. Note that the system configuration is similar to that of the second embodiment. In the third embodiment, as an example of the processing load information, information of the usage rate of the memory for each distributed station will be described as an example.

The management control device 20c determines optical path switching and sleep on the basis of the information of the number of terminals for each distributed station 14, the information of the memory usage rate for each distributed station 14, and the processing delay information for each distributed station 14. For example, the distributed station monitoring unit 212c monitors each distributed station 14 and measures the memory usage rate for each distributed station 14. Further, the distributed station monitoring unit 212c monitors each distributed station 14 and collects the processing delay information for each distributed station 14. The distributed station monitoring unit 212c outputs information of the memory usage rate measured for each distributed station 14 and the processing delay information for each distributed station 14 to the analysis unit 22c as the cooperation information.

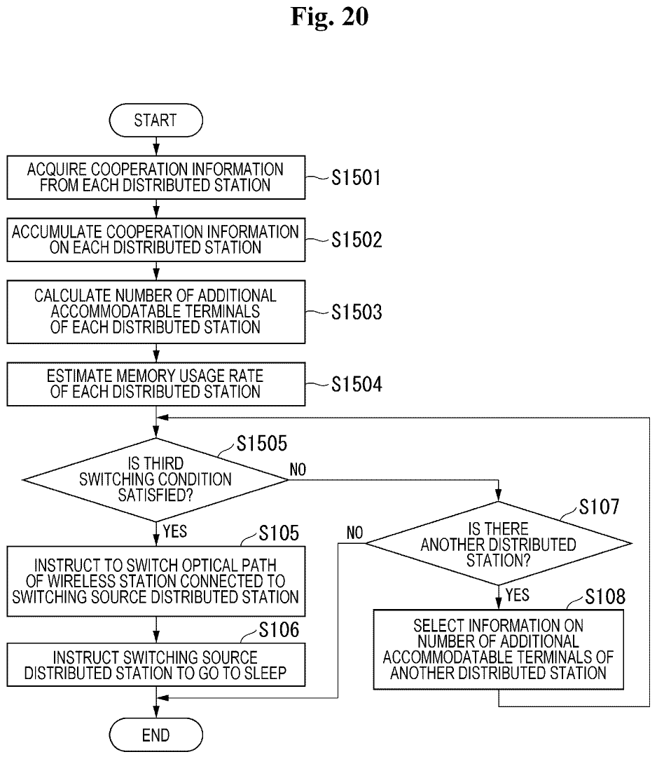

FIG. 20 is a flowchart illustrating an example of a flow of sleep processing executed by the management control device 20c according to the third embodiment. In FIG. 20, the same processing steps as those in FIG. 13 are denoted by the same reference numerals as those used in FIG. 13, and description thereof is omitted.

The cooperation information collection unit 21c acquires the cooperation information from each distributed station 14 (step S1501). Specifically, the acquisition unit 211 acquires at least information of the number of accommodated terminals, information of the maximum number of accommodated terminals, and the like as the cooperation information from each distributed station 14. Further, the distributed station monitoring unit 212c measures the memory usage rate for each distributed station 14 and acquires processing delay information for each distributed station 14. The cooperation information collection unit 21c accumulates the acquired cooperation information of each distributed station 14 in the cooperation information accumulation unit 221 (step S1502). Specifically, in addition to the cooperation information including at least the information of the number of accommodated terminals, the information of the maximum number of accommodated terminals, and the like from each distributed station 14, the cooperation information collection unit 21c accumulates information of the memory usage rate of each distributed station 14 and the processing delay information for each distributed station 14 in the cooperation information accumulation unit 221 as the cooperation information.

The real-time analysis unit 222c calculates the number of additionally accommodatable terminals of each distributed station 14 on the basis of the cooperation information for each distributed station 14 accumulated in the cooperation information accumulation unit 221 (step S1503). Further, the real-time analysis unit 222c roughly calculates the memory usage rate of each distributed station 14 on the basis of the cooperation information for each distributed station 14 accumulated in the cooperation information accumulation unit 221 (step S1504).

The real-time analysis unit 222c determines whether or not a third switching condition is satisfied (step S1505). The third switching condition is a condition indicating that switching of the optical path between the radio station 12 and the distributed station 14 is necessary, for example, that the number of additionally accommodatable terminals in a certain distributed station 14 is larger than the number of accommodated terminals of the distributed station 14 as a sleep determination target, the memory usage rate does not exceed 100%, and the processing delay of the distributed station 14 as a sleep determination target does not exceed a threshold.

When determining that the third switching condition is satisfied (step S1505—YES), the real-time analysis unit 222c executes the processing of step S105 and subsequent steps. On the other hand, when determining that the third switching condition is not satisfied (step S1505—NO), the real-time analysis unit 222c executes the processing of step S107 and subsequent steps.

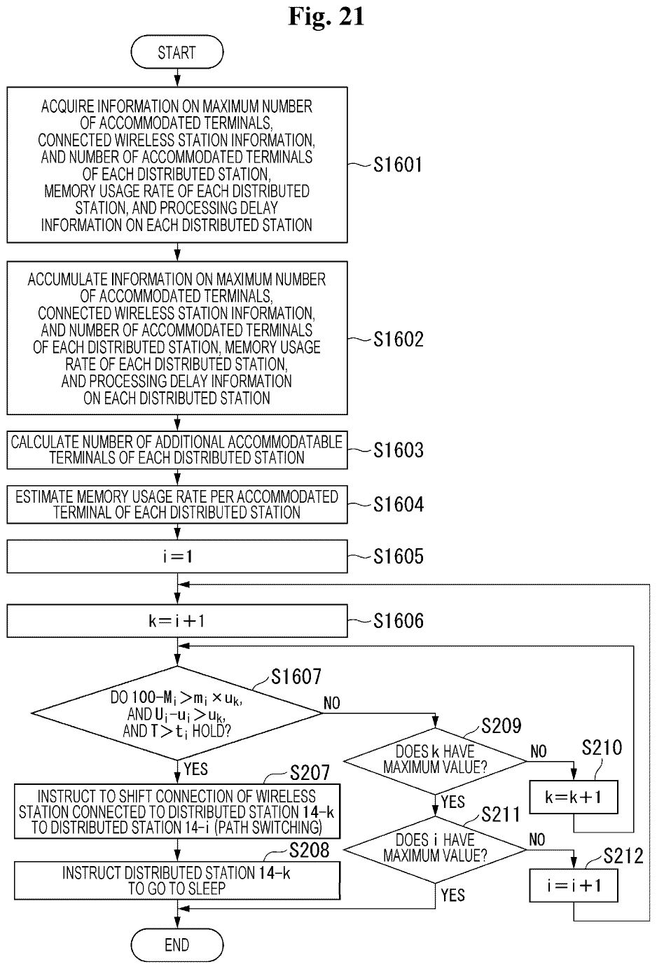

FIG. 21 is a flowchart illustrating an example of a flow of sleep processing executed by the management control device 20c according to the third embodiment. Note that, in the processing illustrated in FIG. 21, contents more specifically indicating the processing illustrated in FIG. 20 will be described. In FIG. 21, the same processing steps as those in FIG. 14 are denoted by the same reference numerals as those used in FIG. 14, and description thereof is omitted.

The acquisition unit 211 acquires, from each distributed station 14, the information of the maximum number of accommodated terminals, the connected radio station information, and the number of accommodated terminals of each distributed station as the cooperation information. Further, the distributed station monitoring unit 212c acquires information of the memory usage rate and processing delay information of each distributed station 14 (step S1601).

The acquisition unit 211 accumulates the acquired cooperation information of each distributed station 14 in the cooperation information accumulation unit 221. Further, the distributed station monitoring unit 212c accumulates the acquired information of the memory usage rate and the acquired processing delay information of each distributed station 14 as the cooperation information (step S1602). The real-time analysis unit 222c calculates the number of additionally accommodatable terminals of each distributed station 14 on the basis of the cooperation information for each distributed station 14 accumulated in the cooperation information accumulation unit 221 (step S1603). Further, the real-time analysis unit 222c roughly calculates the memory usage rate per distributed station 14 on the basis of the cooperation information for each distributed station 14 accumulated in the cooperation information accumulation unit 221 (step S1604).

Next, the real-time analysis unit 222c substitutes a value of 1 for constant i (step S1605). Next, the real-time analysis unit 222c substitutes a value of (i+1) for k (step S1606). Thereafter, the real-time analysis unit 222c determines whether 100−Mᵢ>mᵢ×uₖ, and Uᵢ−uᵢ>uₖ, and T>tᵢ is satisfied (step S1607). T indicates a threshold, and tᵢ in the third embodiment indicates a processing delay of the distributed station 14-i. The condition indicated by 100−Mᵢ>mᵢ×uₖ, and Uᵢ−uᵢ>uₖ, and T>tᵢ is a specific example of the third switching condition.

When determining that the third switching condition is satisfied (step S1607—YES), the real-time analysis unit 222c executes the processing of step S207 and subsequent steps. On the other hand, when determining that the third switching condition is not satisfied (step S1607—NO), the real-time analysis unit 222c executes the processing of step S209 and subsequent steps.

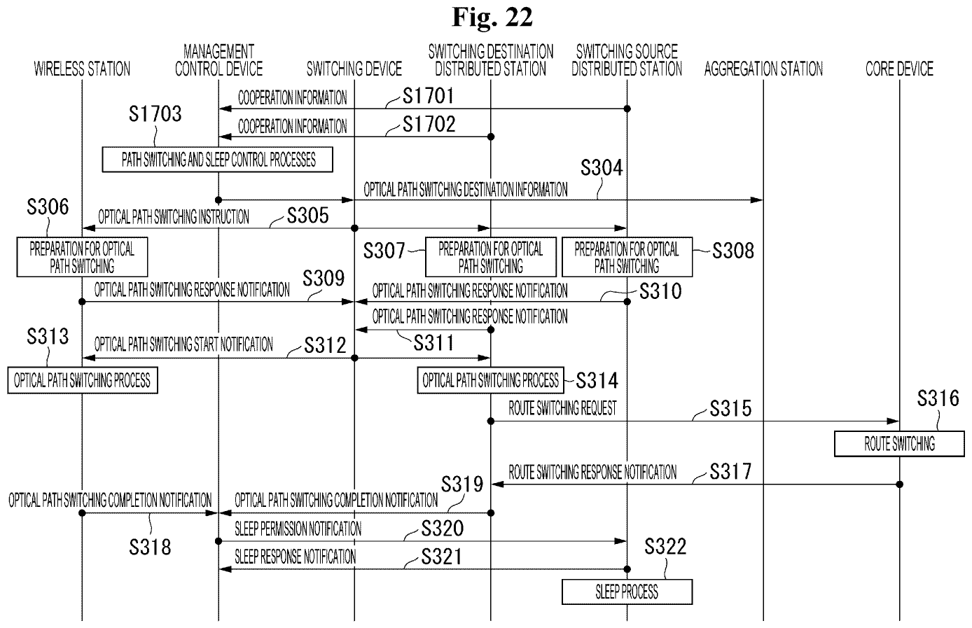

FIG. 22 is a sequence diagram illustrating an example of a detailed flow of sleep processing executed by the mobile NW system 100c according to the third embodiment. In FIG. 22, the same processing steps as those in FIG. 15 are denoted by the same reference numerals as those used in FIG. 15, and description thereof is omitted. Note that, in the description of FIG. 22, it is assumed that the distributed station 14-1 is a switching destination distributed station and the distributed station 14-2 is a switching source distributed station. Here, the switching destination distributed station 14-1 and the switching source distributed station 14-2 will be described.

The cooperation information collection unit 21c of the management control device 20c acquires the cooperation information from the switching destination distributed station 14-1 and the switching source distributed station 14-2 at a predetermined cycle (step S1701 and step S1702). Note that the cooperation information acquired in step S1701 and step S1702 includes information of the usage rate of the memory for each distributed station 14 and the processing delay information for each distributed station 14 in addition to at least the information of the number of accommodated terminals, information of the maximum number of accommodated terminals, and the like. The cooperation information collection unit 21c accumulates the acquired cooperation information in the cooperation information accumulation unit 221.

When the cooperation information is accumulated in the cooperation information accumulation unit 221, the real-time analysis unit 222c performs optical path switching and sleep control determination (step S1703). The optical path switching and the sleep control determination in step S1703 is a determination as to whether or not the third switching condition is satisfied in step S1505. Here, it is assumed that the third switching condition in step S1505 is satisfied. When the third switching condition is satisfied, the real-time analysis unit 222c executes the processing of step S304 and subsequent steps.

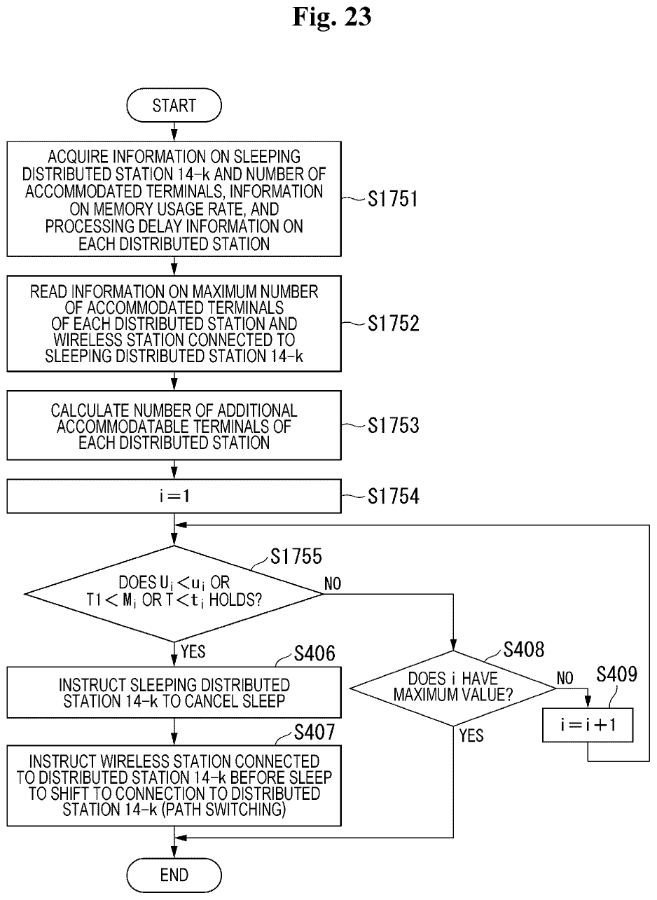

FIG. 23 is a flowchart illustrating an example of a flow of sleep cancellation processing executed by the management control device 20c according to the third embodiment. In FIG. 23, the same processing steps as those in FIG. 16 will be denoted by the same reference signs as those used in FIG. 16, and description thereof will be omitted.

The acquisition unit 211 acquires information of the number of accommodated terminals and the sleeping distributed station 14-k from each distributed station 14 as the cooperation information. Further, the distributed station monitoring unit 212c acquires information of the memory usage rate of each distributed station 14 and the processing delay information for each distributed station 14 as the cooperation information (step S1751). The acquisition unit 211 notifies the analysis unit 22c of the acquired information of the number of accommodated terminals, the sleeping distributed station 14-k, the information of the memory usage rate, and the processing delay information for each distributed station 14.

The real-time analysis unit 222c of the analysis unit 22c reads information of the maximum number of accommodated terminals of each distributed station 14 and information of the radio station 12 connected to the sleeping distributed station 14-k from the cooperation information accumulation unit 221 (step S1752). The real-time analysis unit 222c calculates the number of additionally accommodatable terminals of each distributed station 14 on the basis of the acquired cooperation information for each distributed station 14 (step S1753).

Next, the real-time analysis unit 222c substitutes a value of 1 for constant i (step S1754). The real-time analysis unit 222c determines whether either Uᵢ<uᵢ or T1<Mᵢ or T<tᵢ is satisfied (step S1755). The condition indicated by Uᵢ<uᵢ or T1<Mᵢ or T<tᵢ is a specific example of a third sleep cancellation condition. In the third sleep cancellation condition, T<tᵢ means that the processing delay of the distributed station 14-i exceeds the threshold.

When determining that the third sleep cancellation condition (for example, Uᵢ<uᵢ or T1<Mᵢ or T<tᵢ) is satisfied (step S1755—YES), the real-time analysis unit 222c determines that the optical path switching and the sleep cancellation of the sleeping distributed station 14-k are necessary.

The real-time analysis unit 222c notifies the control unit 23 of the determination result. Thereafter, the processing of step S406 and subsequent steps is executed. On the other hand, when determining that the third sleep cancellation condition (for example, Uᵢ<uᵢ or T1<Mᵢ or T<tᵢ) is not satisfied (step S1755—NO), the real-time analysis unit 222c executes the processing of step S408.

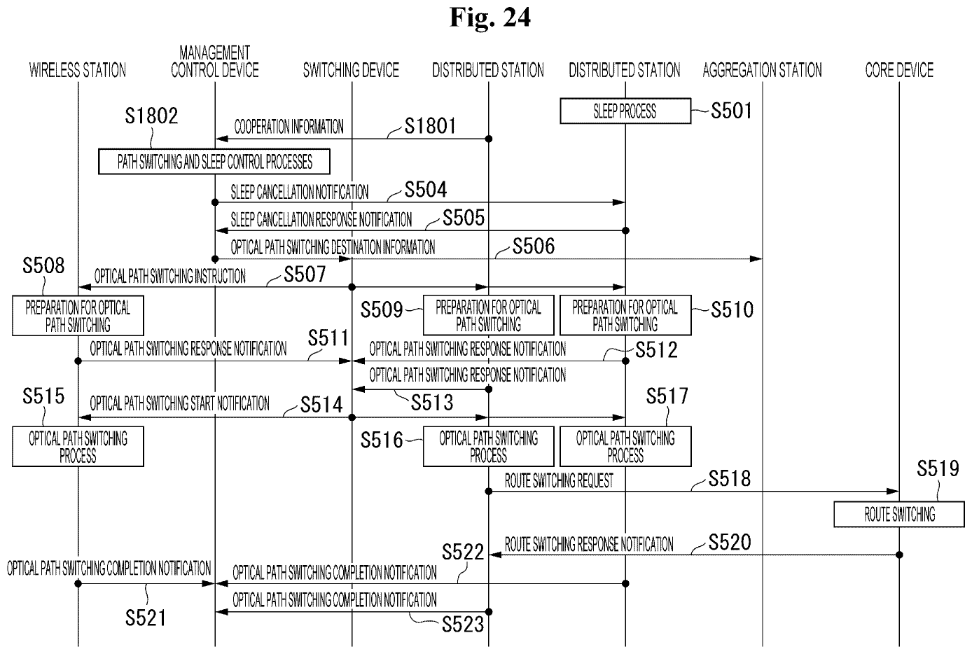

FIG. 24 is a sequence diagram illustrating an example of a detailed flow of sleep cancellation processing executed by the mobile NW system 100c according to the third embodiment. In FIG. 24, the same processing steps as those in FIG. 17 will be denoted by the same reference signs as those used in FIG. 17, and description thereof will be omitted. Note that, in the description of FIG. 17, it is assumed that the distributed station 14-2 is in a sleep state.

The distributed station 14-2 is in a sleep state (step S501). The cooperation information collection unit 21c of the management control device 20c acquires the cooperation information from the distributed station 14-1 at a predetermined cycle (step S1801). Note that the cooperation information acquired in step S1801 includes information of the usage rate of the memory and processing delay information for each distributed station 14. The cooperation information collection unit 21c accumulates the acquired cooperation information in the cooperation information accumulation unit 221.

When the cooperation information is accumulated in the cooperation information accumulation unit 221, the real-time analysis unit 222c performs optical path switching and sleep control determination (step S1802). The optical path switching and the sleep control determination in step S1802 are whether or not the sleep cancellation condition is satisfied. Here, it is assumed that the sleep cancellation condition is satisfied. When the sleep cancellation condition is satisfied, the real-time analysis unit 222c executes the processing of step S504 and subsequent steps.

With the mobile NW system 100c according to the third embodiment configured as described above, the same effects as those of the first embodiment can be achieved. Specifically, in the mobile NW system 100c according to the third embodiment, the management control device 20c further acquires the information of the usage rate of the memory for each distributed station 14 and the processing delay information for each distributed station 14 as the cooperation information, and determines the necessity of optical path switching on the basis of the cooperation information. When it is determined that it is necessary to switch the optical path, the management control device 20c controls switching of the optical path between one or more radio stations 12 and the plurality of distributed stations 14. Further, the management control device 20c causes the distributed station capable of sleep to transition to the sleep state after the optical path switching is performed. As a result, the optical path switching and the sleep control are performed while analyzing the load of each distributed station 14. Accordingly, it is possible to increase the effect of power saving without deterioration in communication quality.

### First Modification of Third Embodiment

The above-described embodiment indicates the configuration in which the management control device 20c directly acquires the cooperation information from the distributed station 14. The management control device 20c may acquire the cooperation information via another device. Here, the another device is, for example, a wireless controller. In such a configuration, the mobile NW system 100c newly includes the wireless controller 30a, and the wireless controller 30a is provided between the management control device 20c and the distributed stations 14.

The wireless controller 30a acquires the cooperation information from each distributed station 14 at a predetermined cycle by wireless communication. The wireless controller 30a transmits the acquired cooperation information to the management control device 20c by wireless communication. Note that the wireless controller 30a may receive a sleep control instruction from the management control device 20c and transmit the sleep control instruction to the switching source distributed station.

With this configuration, the cooperation information can be collected by wireless communication.

### Second Modification of Third Embodiment

The above-described embodiment indicates the configuration in which the management control device 20c performs the optical path switching control processing and the sleep control processing. On the other hand, the switching device 13 may be configured to perform the optical path switching control processing and the sleep control processing. In such a configuration, the switching device 13 includes the control unit 23, and the management control device 20c does not include the control unit 23. The real-time analysis unit 222c of the management control device 20c notifies the switching device 13 of the analysis result. Note that the real-time analysis unit 222c may notify the switching device 13 of the analysis result only when optical path switching and sleep control are performed. The control unit 23 of the switching device 13 performs the optical path switching control processing and the sleep control processing on the basis of the analysis result notification of which has been given from the management control device 20c.

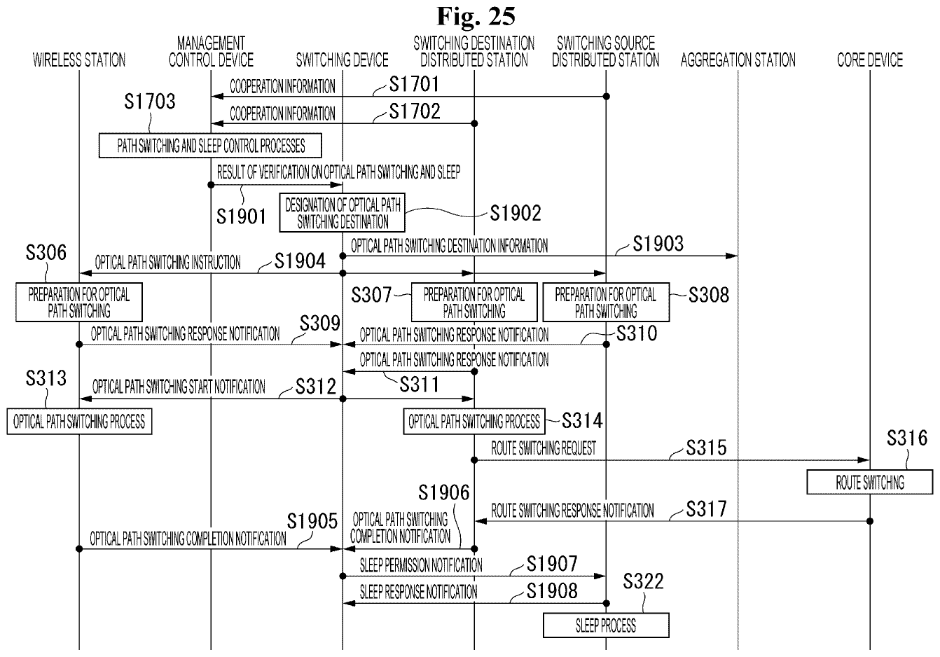

FIG. 25 is a sequence diagram illustrating an example of a detailed flow of sleep processing executed by the mobile NW system 100c according to the second modification of the third embodiment. In FIG. 25, the same processing steps as those in FIG. 22 will be denoted by the same reference signs as those used in FIG. 22, and description thereof will be omitted.

After the processing from step S1701 to step S1703 is executed, the real-time analysis unit 222c instructs the switching device 13b to perform optical path switching control and sleep control when the third switching condition is satisfied (step S1901). The switching device 13b receives the instruction transmitted from the management control device 20c.

The optical path switching control unit 231 of the switching device 13b determines the optical path switching destination from the information included in the received instruction (step S1902). The optical path switching control unit 231 notifies the aggregation station 15 of optical path switching destination information (step S1903). Thereafter, the optical path switching control unit 231 instructs the radio station 12 connected to the switching source distributed station 14-2, the switching destination distributed station 14-1, and the switching source distributed station 14-2 to switch the optical path (step S1904). Thereafter, the processing from step S306 to step S317 is executed.

When the optical path switching is completed, the radio station 12 transmits an optical path switching completion notification to the switching device 13b (step S1905). Note that the radio station 12 may also transmit the optical path switching completion notification to the management control device 20c. When the optical path switching is completed, the switching destination distributed station 14-1 transmits an optical path switching completion notification to the switching device 13 (step S1906). Note that the radio station 12 may also transmit the optical path switching completion notification to the management control device 20c.

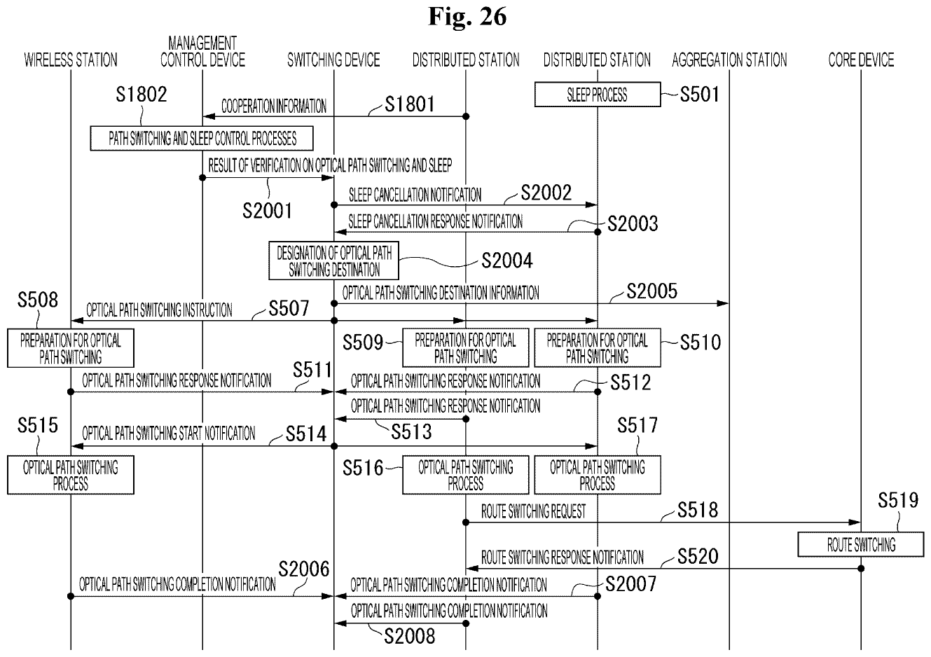

When the optical path switching completion notification is received from the transmission destination of the optical path switching start notification, the sleep control unit 232 included in the switching device 13b transmits a sleep permission notification to the switching source distributed station 14-2 (step S1907). When the sleep permission notification is obtained from the switching device 13b, the switching source distributed station 14-2 transmits a sleep response notification to the switching device 13 (step S1908). After transmitting the sleep response notification, the switching source distributed station 14-2 transitions to the sleep state (step S322). FIG. 26 is a sequence diagram illustrating an example of a detailed flow of sleep cancellation processing executed by the mobile NW system 100c according to the second modification of the third embodiment. In FIG. 26, the same processing steps as those in FIG. 23 will be denoted by the same reference signs as those used in FIG. 23, and description thereof will be omitted.

After the processing of step S501, step S1801, and step S1802 is executed, the real-time analysis unit 222c instructs the switching device 13b to perform optical path switching control and sleep control when the sleep cancellation condition is satisfied (step S2001). The switching device 13b receives the instruction transmitted from the management control device 20c.

The sleep control unit 232 of the switching device 13b transmits a sleep cancellation notification to the distributed station 14-2 on the basis of the information included in the received instruction (step S2002). In response to the reception of the sleep cancellation notification, the distributed station 14-2 transmits a sleep cancellation response notification to the switching device 13b (step S2003).

The optical path switching control unit 231 of the switching device 13b determines the optical path switching destination from the information included in the received instruction (step S2004). The optical path switching control unit 231 of the switching device 13b notifies the aggregation station 15 of optical path switching destination information (step S2005). Thereafter, the processing from step S507 to step S520 is executed.

When the optical path switching is completed, the radio station 12 transmits an optical path switching completion notification to the switching device 13b (step S2006). When the optical path switching is completed, the distributed station 14-1 transmits an optical path switching completion notification to the switching device 13b (step S2007). When the optical path switching is completed, the distributed station 14-2 transmits an optical path switching completion notification to the switching device 13b (step S2008).

### Fourth Embodiment

The fourth embodiment is different from the first embodiment in that information of a transmission delay between the terminal 11 and each distributed station 14 is further included in the cooperation information.

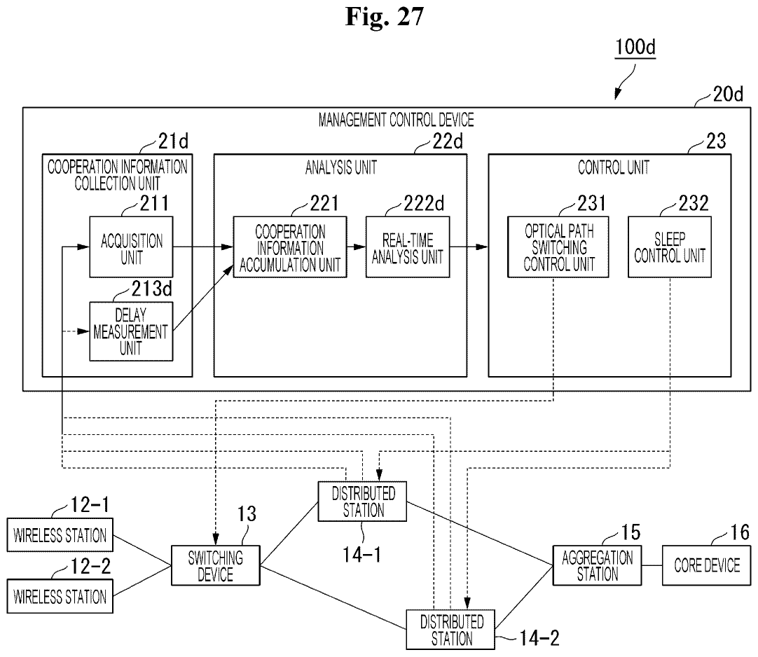

FIG. 27 is a diagram illustrating a configuration example of a mobile NW system 100d according to the fourth embodiment. The mobile NW system 100d according to the fourth embodiment includes one or more radio stations 12, a switching device 13, a plurality of distributed stations 14, an aggregation station 15, a core device 16, and a management control device 20d. The management control device 20d includes a cooperation information collection unit 21d, an analysis unit 22d, and a control unit 23.

The cooperation information collection unit 21d includes an acquisition unit 211 and a delay measurement unit 213d. The delay measurement unit 213d measures a transmission delay between the terminal 11 and each distributed station 14. For example, the delay measurement unit 213d measures a transmission delay between the terminal 11 and each distributed station 14 on the basis of a round-trip time (RTT) obtained as a result of ping transmission. The delay measurement unit 213d outputs information of propagation delay measured for each distributed station 14 to the analysis unit 22d as the cooperation information.

The analysis unit 22d includes a cooperation information accumulation unit 221 and a real-time analysis unit 222d. The real-time analysis unit 222d analyzes a state of communication in the mobile NW system 100d such as a change amount of the number of connections of the distributed station 14 per unit time on the basis of the cooperation information. Specifically, the real-time analysis unit 222d roughly calculates the delay time per station by dividing the delay time by the current number of accommodated terminals. Further, the real-time analysis unit 222d multiplies the number of accommodated terminals of another distributed station 14 by the delay time per target distributed station 14, and determines optical path switching and sleep when the delay time does not exceed a threshold and the number of accommodated terminals of the distributed station 14 is smaller than the number of terminals that can be additionally accommodated in the target distributed station 14.

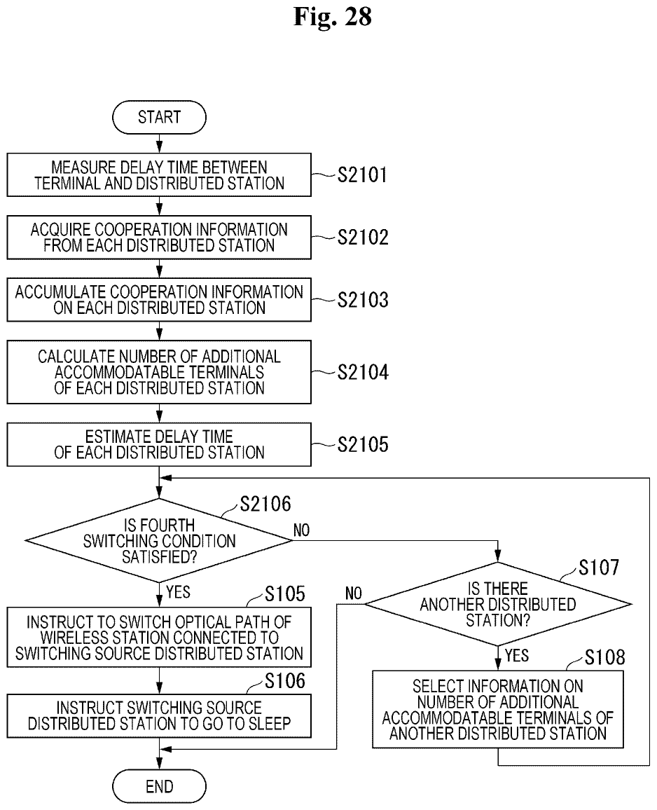

FIG. 28 is a flowchart illustrating an example of a flow of sleep processing executed by the management control device 20d according to the fourth embodiment. In FIG. 28, the same processing steps as those in FIG. 3 will be denoted by the same reference signs as those used in FIG. 3, and description thereof will be omitted.

The delay measurement unit 213d measures a transmission delay between the terminal 11 and each distributed station 14 (step S2101). The cooperation information collection unit 21d acquires the cooperation information from each distributed station 14 (step S2102). Specifically, the acquisition unit 211 acquires at least information of the number of accommodated terminals, information of the maximum number of accommodated terminals, and the like as the cooperation information from each distributed station 14. The cooperation information collection unit 21d accumulates the acquired cooperation information of each distributed station 14 in the cooperation information accumulation unit 221 (step S2103). Specifically, in addition to the cooperation information including at least the information of the number of accommodated terminals, the information of the maximum number of accommodated terminals, and the like from each distributed station 14, the cooperation information collection unit 21d accumulates information of the transmission delay between the terminal 11 and each distributed station 14 in the cooperation information accumulation unit 221 as the cooperation information.

The real-time analysis unit 222d calculates the number of additionally accommodatable terminals of each distributed station 14 on the basis of the cooperation information for each distributed station 14 accumulated in the cooperation information accumulation unit 221 (step S2104). Further, the real-time analysis unit 222d roughly calculates the delay time of each distributed station 14 on the basis of the information of the transmission delay between the terminal 11 and each distributed station 14 accumulated in the cooperation information accumulation unit 221 (step S2105).

The real-time analysis unit 222d determines whether or not a fourth switching condition is satisfied (step S2106). The fourth switching condition is a condition indicating that switching of the optical path between the radio station 12 and the distributed station 14 is necessary, for example, that the number of additionally accommodatable terminals in a certain distributed station 14 is larger than the number of accommodated terminals of the distributed station 14 as a sleep determination target, and the transmission delay does not exceed the threshold.

When determining that the fourth switching condition is satisfied (step S2106—YES), the real-time analysis unit 222d executes the processing of step S105 and subsequent steps. On the other hand, when determining that the fourth switching condition is not satisfied (step S2106—NO), the real-time analysis unit 222d executes the processing of step S107 and subsequent steps.

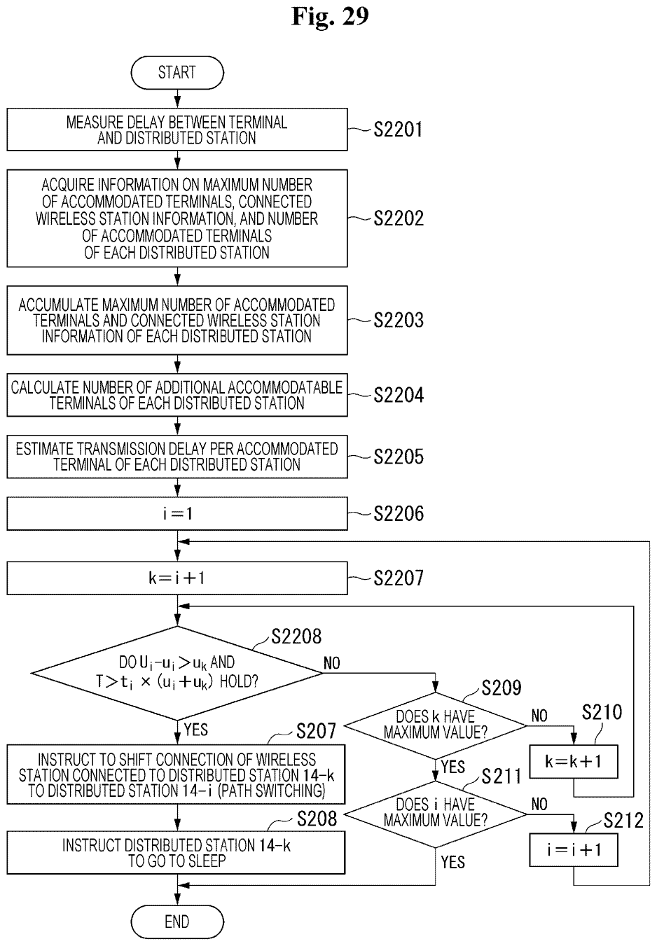

FIG. 29 is a flowchart illustrating an example of a flow of sleep processing executed by the management control device 20d according to the fourth embodiment. Note that, in the processing illustrated in FIG. 29, contents more specifically indicating the processing illustrated in FIG. 28 will be described. In FIG. 29, the same processing steps as those in FIG. 4 will be denoted by the same reference signs as those used in FIG. 4, and description thereof will be omitted.

The delay measurement unit 213d measures a transmission delay between the terminal 11 and each distributed station 14 (step S2201). The acquisition unit 211 acquires, from each distributed station 14, the information of the maximum number of accommodated terminals, the connected radio station information, and the number of accommodated terminals of each distributed station as the cooperation information (step S2202).

The acquisition unit 211 accumulates the acquired cooperation information of each distributed station 14 in the cooperation information accumulation unit 221 (step S2203). The real-time analysis unit 222d calculates the number of additionally accommodatable terminals of each distributed station 14 on the basis of the cooperation information for each distributed station 14 accumulated in the cooperation information accumulation unit 221 (step S2204). Further, the real-time analysis unit 222d roughly calculates the transmission delay per distributed station 14 on the basis of the information of the measured transmission delay between the terminal 11 and each distributed station 14 (step S2205).

Specifically, the real-time analysis unit 222d roughly calculates a transmission delay tᵢ per distributed station 14-i by dividing a value Tᵢ of the transmission delay of the distributed station 14-i obtained in the processing of step S2201 by the number of accommodated terminals uᵢ of the distributed station 14-i (Tᵢ/uᵢ). Next, the real-time analysis unit 222d substitutes a value of 1 for constant i (step S2206). Next, the real-time analysis unit 222d substitutes a value of (i+1) for k (step S2207).

Thereafter, the real-time analysis unit 222d determines whether Uᵢ−uᵢ>uₖ and T>tᵢ×(uᵢ+uₖ) is satisfied (step S2208). In the fourth embodiment, tᵢ indicates the transmission delay tᵢ per distributed station 14-i. The condition indicated by Uᵢ−uᵢ>uₖ and T>tᵢ×(uᵢ+uₖ) is a specific example of the fourth switching condition. When determining that the fourth switching condition is satisfied (step S2208—YES), the real-time analysis unit 222d executes the processing of step S207 and subsequent steps. On the other hand, when determining that the fourth switching condition is not satisfied (step S2208—NO), the real-time analysis unit 222d executes the processing of step S209 and subsequent steps.

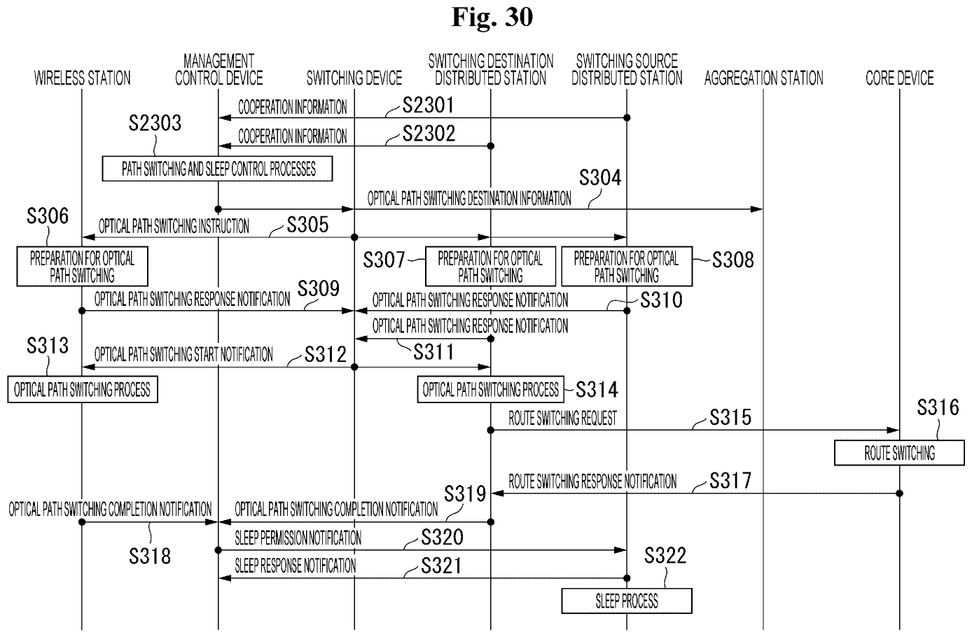

FIG. 30 is a sequence diagram illustrating an example of a detailed flow of sleep processing executed by the mobile NW system 100d according to the fourth embodiment. In FIG. 30, the same processing steps as those in FIG. 5 will be denoted by the same reference signs as those used in FIG. 5, and description thereof will be omitted. Note that, in the description of FIG. 30, it is assumed that the distributed station 14-1 is a switching destination distributed station and the distributed station 14-2 is a switching source distributed station. Here, the switching destination distributed station 14-1 and the switching source distributed station 14-2 will be described.

The cooperation information collection unit 21d of the management control device 20d acquires the cooperation information from the switching destination distributed station 14-1 and the switching source distributed station 14-2 at a predetermined cycle (step S2301 and step S2302). Note that the cooperation information acquired in step S2301 and step S2302 includes information of the transmission delay between the terminal 11 and each distributed station 14 in addition to at least the information of the number of accommodated terminals, information of the maximum number of accommodated terminals, and the like. The cooperation information collection unit 21d accumulates the acquired cooperation information in the cooperation information accumulation unit 221.

When the cooperation information is accumulated in the cooperation information accumulation unit 221, the real-time analysis unit 222d performs optical path switching and sleep control determination (step S2303). The optical path switching and the sleep control determination in step S2303 is a determination as to whether or not the fourth switching condition is satisfied in step S2106. Here, it is assumed that the fourth switching condition in step S2106 is satisfied. When the fourth switching condition is satisfied, the real-time analysis unit 222d executes the processing of step S304 and subsequent steps.

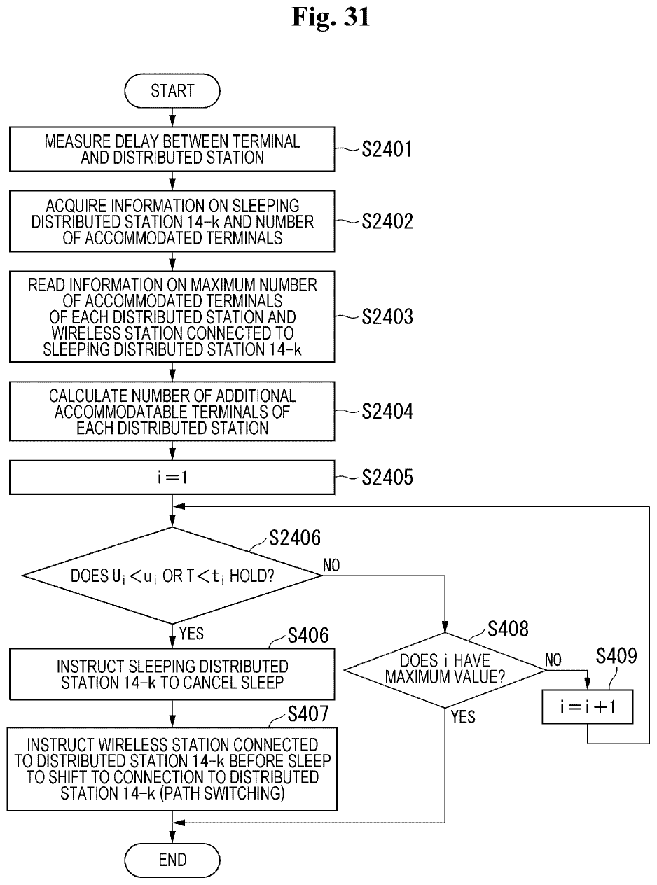

FIG. 31 is a flowchart illustrating an example of a flow of sleep cancellation processing executed by the management control device 20d according to the fourth embodiment. In FIG. 31, the same processing steps as those in FIG. 6 will be denoted by the same reference signs as those used in FIG. 6, and description thereof will be omitted.

The delay measurement unit 213d measures a transmission delay between the terminal 11 and each distributed station 14 (step S2401). The acquisition unit 211 acquires information of the number of accommodated terminals and the sleeping distributed station 14-k from each distributed station 14 as the cooperation information (step S2402). The acquisition unit 211 notifies the analysis unit 22d of the acquired information of the number of accommodated terminals, the sleeping distributed station 14-k, and the information of the transmission delay.

The real-time analysis unit 222d of the analysis unit 22d reads information of the maximum number of accommodated terminals of each distributed station 14 and information of the radio station 12 connected to the sleeping distributed station 14-k from the cooperation information accumulation unit 221 (step S2403). The real-time analysis unit 222d calculates the number of additionally accommodatable terminals of each distributed station 14 on the basis of the acquired cooperation information for each distributed station 14 (step S2404).

Next, the real-time analysis unit 222d substitutes a value of 1 for constant i (step S2405). The real-time analysis unit 222d determines whether either Uᵢ<uᵢ or T<tᵢ is satisfied (step S2406). The condition indicated by Uᵢ<uᵢ or T<tᵢ is a specific example of a fourth sleep cancellation condition. In the fourth sleep cancellation condition, T<tᵢ means that the transmission delay between the terminal 11 and the distributed station 14-i exceeds the threshold. That is, it means that the transmission delay tᵢ per distributed station 14-i exceeds the threshold.

When determining that the fourth sleep cancellation condition (for example, Uᵢ<uᵢ or T<tᵢ) is satisfied (step S2406—YES), the real-time analysis unit 222d determines that the optical path switching and the sleep cancellation of the sleeping distributed station 14-k are necessary.

The real-time analysis unit 222d notifies the control unit 23 of the determination result. Thereafter, the processing of step S406 and subsequent steps is executed. On the other hand, when determining that the fourth sleep cancellation condition (for example, Uᵢ<uᵢ or T<tᵢ) is not satisfied (step S2406—NO), the real-time analysis unit 222d executes the processing of step S408.

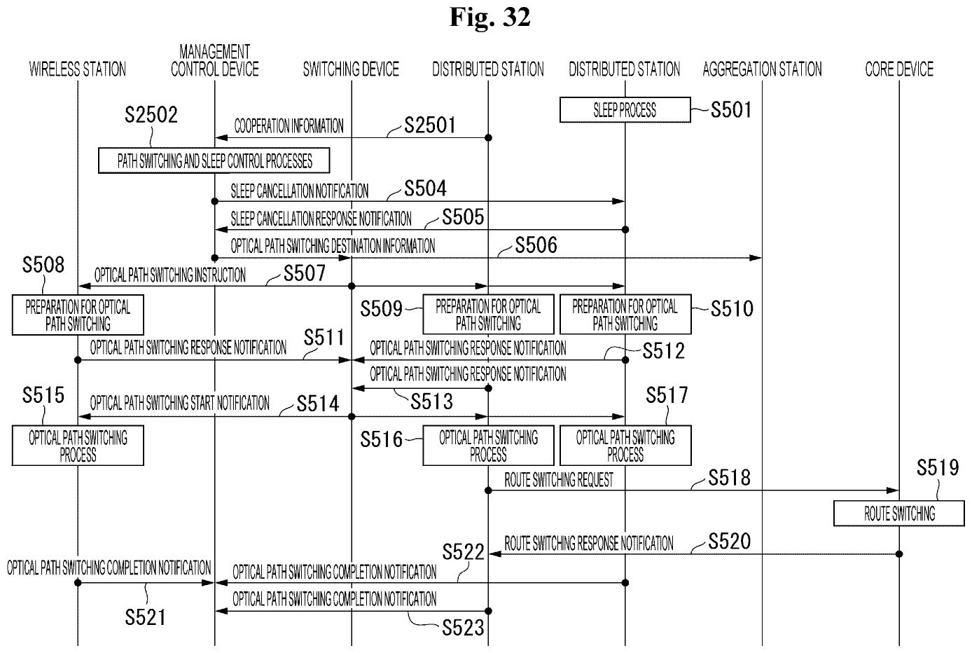

FIG. 32 is a sequence diagram illustrating an example of a detailed flow of sleep cancellation processing executed by the mobile NW system 100d according to the fourth embodiment. In FIG. 32, the same processing steps as those in FIG. 7 will be denoted by the same reference signs as those used in FIG. 7, and description thereof will be omitted. Note that, in the description of FIG. 32, it is assumed that the distributed station 14-2 is in a sleep state.

The distributed station 14-2 is in a sleep state (step S501). The cooperation information collection unit 21d of the management control device 20d acquires the cooperation information from the distributed station 14-1 at a predetermined cycle (step S2501). Note that the cooperation information acquired in step S2501 includes information of the transmission delay between the terminal 11 and each distributed station 14 in addition to at least the information of the number of accommodated terminals, information of the maximum number of accommodated terminals, and the like. The cooperation information collection unit 21d accumulates the acquired cooperation information in the cooperation information accumulation unit 221.

When the cooperation information is accumulated in the cooperation information accumulation unit 221, the real-time analysis unit 222d performs optical path switching and sleep control determination (step S2502). The optical path switching and the sleep control determination in step S2502 are whether or not the sleep cancellation condition is satisfied. Here, it is assumed that the sleep cancellation condition is satisfied. When the sleep cancellation condition is satisfied, the real-time analysis unit 222d executes the processing of step S504 and subsequent steps.

With the mobile NW system 100d configured as described above, effects similar to those of the first embodiment can be obtained. Specifically, in the mobile NW system 100d, the management control device 20d further acquires the information of the transmission delay between the terminal 11 and each distributed station 14 as the cooperation information, and determines the necessity of optical path switching on the basis of the cooperation information. When it is determined that it is necessary to switch the optical path, the management control device 20d controls switching of the optical path between one or more radio stations 12 and the plurality of distributed stations 14. Further, the management control device 20d causes the distributed station capable of sleep to transition to the sleep state after the optical path switching is performed. As a result, the optical path switching and the sleep control are performed while analyzing the load of each distributed station 14. Accordingly, power saving can be efficiently achieved as the entire system.

### First Modification of Fourth Embodiment

The above-described embodiment indicates the configuration in which the management control device 20d directly acquires the cooperation information from the distributed station 14. The management control device 20d may acquire the cooperation information via another device. Here, the another device is, for example, a wireless controller. In such a configuration, the mobile NW system 100d newly includes the wireless controller 30a, and the wireless controller 30a is provided between the management control device 20d and the distributed stations 14.

The wireless controller 30a acquires the cooperation information from each distributed station 14 at a predetermined cycle by wireless communication. The wireless controller 30a transmits the acquired cooperation information to the management control device 20d by wireless communication. Note that the wireless controller 30a may receive a sleep control instruction from the management control device 20d and transmit the sleep control instruction to the switching source distributed station.

With this configuration, the cooperation information can be collected by wireless communication.

### Second Modification of Fourth Embodiment

The above-described embodiment indicates the configuration in which the management control device 20d performs the optical path switching control processing and the sleep control processing. On the other hand, the switching device 13 may be configured to perform the optical path switching control processing and the sleep control processing. In such a configuration, the switching device 13 includes the control unit 23, and the management control device 20d does not include the control unit 23. The real-time analysis unit 222d of the management control device 20d notifies the switching device 13 of the analysis result. Note that the real-time analysis unit 222d may notify the switching device 13 of the analysis result only when optical path switching and sleep control are performed. The control unit 23 of the switching device 13 performs the optical path switching control processing and the sleep control processing on the basis of the analysis result notification of which has been given from the management control device 20d.

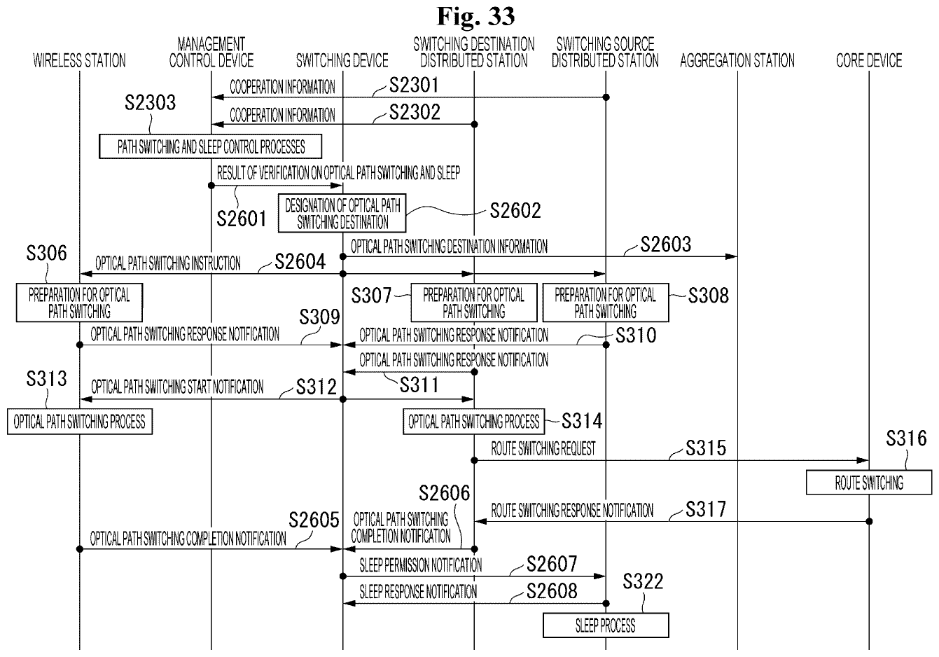

FIG. 33 is a sequence diagram illustrating an example of a detailed flow of sleep processing executed by the mobile NW system 100d according to the second modification of the fourth embodiment. In FIG. 33, the same processing steps as those in FIG. 30 will be denoted by the same reference signs as those used in FIG. 30, and description thereof will be omitted.

After the processing from step S2301 to step S2303 is executed, the real-time analysis unit 222d instructs the switching device 13b to perform optical path switching control and sleep control when the fourth switching condition is satisfied (step S2601). The switching device 13b receives the instruction transmitted from the management control device 20d.

The optical path switching control unit 231 of the switching device 13b determines the optical path switching destination from the information included in the received instruction (step S2602). The optical path switching control unit 231 notifies the aggregation station 15 of optical path switching destination information (step S2603). Thereafter, the optical path switching control unit 231 instructs the radio station 12 connected to the switching source distributed station 14-2, the switching destination distributed station 14-1, and the switching source distributed station 14-2 to switch the optical path (step S2604). Thereafter, the processing from step S306 to step S317 is executed.

When the optical path switching is completed, the radio station 12 transmits an optical path switching completion notification to the switching device 13b (step S2605). Note that the radio station 12 may also transmit the optical path switching completion notification to the management control device 20d. When the optical path switching is completed, the switching destination distributed station 14-1 transmits an optical path switching completion notification to the switching device 13 (step S2606). Note that the radio station 12 may also transmit the optical path switching completion notification to the management control device 20d.

When the optical path switching completion notification is received from the transmission destination of the optical path switching start notification, the sleep control unit 232 included in the switching device 13b transmits a sleep permission notification to the switching source distributed station 14-2 (step S2607). When the sleep permission notification is obtained from the switching device 13b, the switching source distributed station 14-2 transmits a sleep response notification to the switching device 13 (step S2608). After transmitting the sleep response notification, the switching source distributed station 14-2 transitions to the sleep state (step S322).

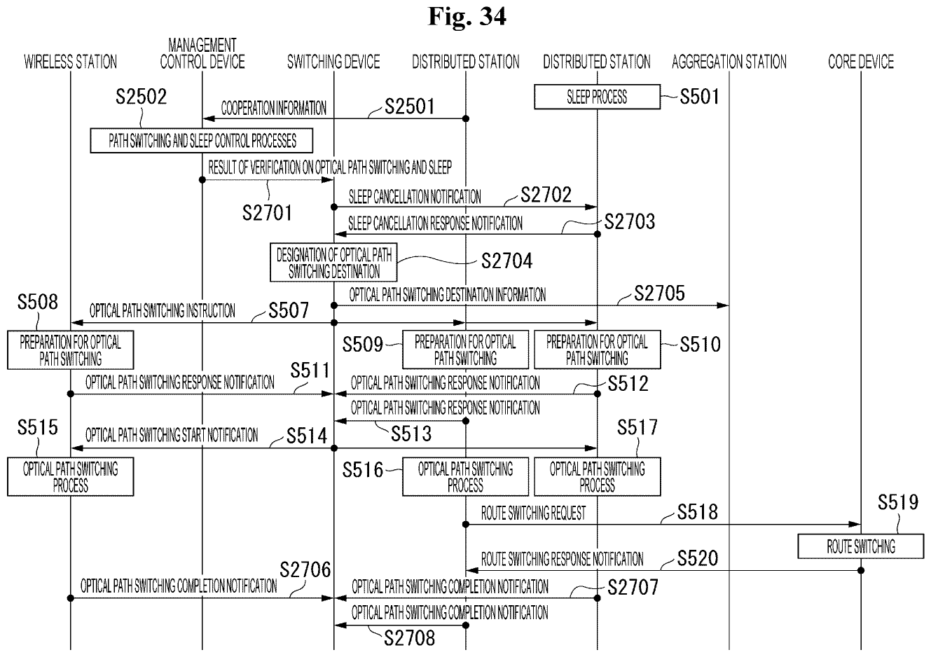

FIG. 34 is a sequence diagram illustrating an example of a detailed flow of sleep cancellation processing executed by the mobile NW system 100d according to the second modification of the fourth embodiment. In FIG. 34, the same processing steps as those in FIG. 31 will be denoted by the same reference signs as those used in FIG. 31, and description thereof will be omitted. Note that, in the description of FIG. 31, it is assumed that the distributed station 14-2 is in a sleep state.

After the processing of step S501, step S2501, and step S2502 is executed, the real-time analysis unit 222d instructs the switching device 13b to perform optical path switching control and sleep control when the sleep cancellation condition is satisfied (step S2701). The switching device 13b receives the instruction transmitted from the management control device 20d.

The sleep control unit 232 of the switching device 13b transmits a sleep cancellation notification to the distributed station 14-2 on the basis of the information included in the received instruction (step S2702). In response to the reception of the sleep cancellation notification, the distributed station 14-2 transmits a sleep cancellation response notification to the switching device 13b (step S2703).

The optical path switching control unit 231 of the switching device 13b determines the optical path switching destination from the information included in the received instruction (step S2704). The optical path switching control unit 231 of the switching device 13b notifies the aggregation station 15 of optical path switching destination information (step S2705). Thereafter, the processing from step S507 to step S520 is executed.

When the optical path switching is completed, the radio station 12 transmits an optical path switching completion notification to the switching device 13b (step S2706). When the optical path switching is completed, the distributed station 14-1 transmits an optical path switching completion notification to the switching device 13b (step S2707). When the optical path switching is completed, the distributed station 14-2 transmits an optical path switching completion notification to the switching device 13b (step S2708).

### First Modification Common to First to Fourth Embodiments

The mobile NW systems 100, 100a, 100c, and 100d may not include the switching device 13. In such a configuration, each radio station 12 and each distributed station 14 are connected in advance in a full-mesh network form. Further, when switching the optical path, the optical path switching control unit 231 instructs the radio station 12 and the distributed station 14, which are optical path switching targets, to switch the optical path. For example, the optical path switching control unit 231 transmits an optical path switching instruction (for example, the processing of step S305 in FIG. 5) to the radio station 12 and the distributed station 14, which are optical path switching targets, and transmits an optical path switching start notification (for example, the processing of step S312 in FIG. 5) to the radio station 12 and the distributed station 14, which are optical path switching targets, after an optical path switching response notification is obtained from the radio station 12 and the distributed station 14.

### Second Modification Common to First to Fourth Embodiments

Each embodiment indicates the configuration in which the switching source distributed station transitions to the sleep state as triggered by a sleep instruction given from the management control devices 20, 20c, and 20d to the switching source distributed station. The switching source distributed station may be configured to autonomously transition to the sleep state regardless of the sleep instruction from the management control devices 20, 20c, and 20d. With such a configuration, the switching source distributed station autonomously transitions to the sleep state when an autonomous sleep condition is satisfied. The autonomous sleep condition is a condition for the switching source distributed station to autonomously transition to the sleep state, and is, for example, that there is no radio station 12 connected to the switching source distributed station (radio station 12 connected to the switching source distributed station is zero) or that there is no traffic inflow for a certain time ΔT. In such a configuration, the switching source distributed station includes the sleep control unit. The sleep control unit included in the switching source distributed station causes the own device (switching source distributed station) to transition to the sleep state when the autonomous sleep condition is satisfied. Note that this configuration is also applicable to a case where the switching device 13b includes the control unit 23.

### Third Modification Common to First to Fourth Embodiments

In addition to the number of accommodated terminals, the number of terminals of each distributed station 14, the number of terminals of each radio station 12, an actual traffic amount, and a value obtained by multiplying the number of accommodated terminals by an average throughput of one terminal can be used as the information collected by the management control devices 20, 20c, and 20d.

### Fourth Modification Common to First to Fourth Embodiments

Each embodiment indicated in the first to fourth embodiments indicates the configuration in which the distributed station 14 (for example, the switching source distributed station) that is a sleep target is caused to sleep after the optical path switching is completed in FIGS. 3, 4, 5, 10, 13, 14, 15, 18, 20, 21, 22, 25, 28, 29, 30, and 33. Specifically, the configuration has been indicated in which the management control devices 20, 20b, 20c, and 20d cause the distributed station 14 (for example, the switching source distributed station) that is a sleep target to sleep after the optical path switching is completed (for example, after receiving the optical path switching completion notification).

On the other hand, the mobile NW systems 100, 100a, 100b, 100c, and 100d may be configured such that after the distributed station 14 (for example, the switching source distributed station) that is a sleep target is caused to sleep, the optical path switching is performed in FIGS. 3, 4, 5, 10, 13, 14, 15, 18, 20, 21, 22, 25, 28, 29, 30, and 33. In the case of such a configuration, the management control devices 20, 20b, 20c, and 20d cause the distributed station 14 (for example, the switching source distributed station) that is a sleep target to sleep and then executes the optical path switching. Here, the time after the distributed station 14 (for example, the switching source distributed station) that is a sleep target is caused to sleep may be after the management control devices 20, 20b, 20c, and 20d receive a sleep response notification from the distributed station 14 (for example, the switching source distributed station) that is a sleep target, or may be after transmission of a sleep permission notification to the distributed station 14 (for example, the switching source distributed station) that is a sleep target.

### Fifth Embodiment

In the first to fourth embodiments described above, the configuration for solving the problem occurring in the mobile NW system has been described. Specifically, in the first to fourth embodiments, since each base station autonomously determines the necessity of sleep in the mobile NW system in which wireless communication is performed between the terminal and each base station, the configuration for solving the problem that the overall optimization cannot be performed and the effect of power saving may be limited has been described. On the other hand, such a problem may occur not only in the mobile NW system but also in a wired NW system in which terminals are connected by wire. Therefore, in the fifth embodiment, a configuration for solving the above problem that may also occur in a wired NW system will be described.

### (Overview of Overall Configuration and Processing of Wired NW System)

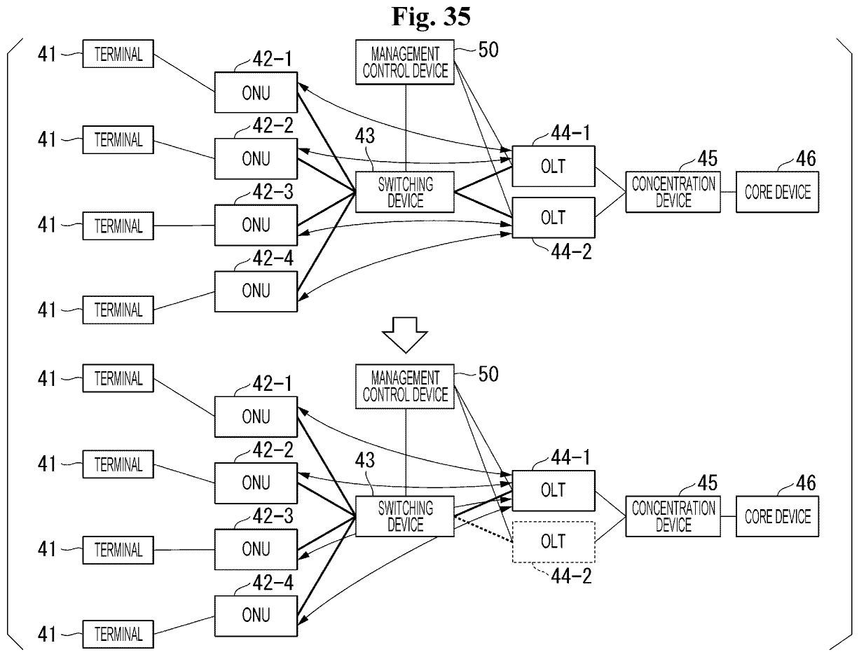

FIG. 35 is a diagram for describing an overview of an overall configuration and processing of a wired NW system according to an embodiment. First, an overall configuration of a wired NW system will be described. The wired NW system is an example of a communication system. The wired NW system is a passive optical network (PON). In the following description, a case where the wired NW system is a PON will be described, but the wired NW system may have another configuration as long as the terminal is configured to be connected by wire. For example, the wired NW system may have a configuration in which terminals are connected in a point-to-point manner. The wired NW system includes one or more ONUs 42, a switching device 43, a plurality of OLTs 44, a concentration device 45, a core device 46, and a management control device 50.

The ONU 42 and the switching device 43, the switching device 43 and the OLT 44, the OLT 44 and the concentration device 45, and the concentration device 45 and the core device 46 are connected by an optical fiber that transmits an optical signal. The switching device 43 and the management control device 50, and the OLT 44 and the management control device 50 are connected by an electric line that transmits an electric signal or an optical fiber. The example illustrated in FIG. 35 illustrates a case where there are four ONUs 42 and two OLTs 44. Note that a plurality of switching devices 43 may be provided, but the case where the number of switching devices 43 is one will be described as an example in the following description.

The ONU 42 is an optical network unit that is provided in a user's home and terminates an optical signal. One or more terminals 41 are connected to each ONU 42 by wire such as an electric line. Each ONU 42 performs wired communication with the terminal 41. For example, each ONU 42 receives an electric signal transmitted from the terminal 41, and converts the received electric signal into an optical signal. Each ONU 42 transmits the converted optical signal to the OLT 44 connected via the switching device 43. Each ONU 42 receives the optical signal via the switching device 43. Each ONU 42 converts the received optical signal into an electric signal and transmits the electric signal to the terminal 41. The ONU 42 is an aspect of a terminal accommodation station.

The switching device 43 is provided between the ONU 42 and the OLT 44. The switching device 43 switches an optical path in accordance with an instruction from the management control device 50. The switching device 43 switches the connection between the ONU 42 and the OLT 44 by switching the optical path.

The OLT 44 is an optical line terminal that is provided on an electricity provider side and terminates an optical signal. The OLT 44 receives an uplink signal transmitted by the ONU 42 via the switching device 43. The OLT 44 transmits a downlink signal to the ONU 42 via the switching device 43. Note that the uplink signal is a signal obtained by converting a signal transmitted by the terminal 41 into an optical signal, and the downlink signal is an optical signal addressed to the terminal 41. Each OLT 44 transitions to a sleep state in accordance with an instruction from the management control device 50. Information acquired by the management control device 50 from the OLT 44 is referred to as cooperation information. The cooperation information in the fifth to eighth embodiments described below is information indicating a state of communication between each OLT 44 and the terminal 41. The OLT 44 is an aspect of a communication station.

The cooperation information includes, for example, information related to the number of accommodated terminals. Note that the information regarding the number of accommodated terminals in the fifth to eighth embodiments indicates information regarding the number of terminals 41 accommodated for each OLT 44. The cooperation information includes, for example, the maximum number of accommodated terminals in the OLT 44. The maximum number of accommodated terminals in the OLT 44 is the maximum number that can be accommodated in the OLT 44. The cooperation information includes, for example, information (hereinafter referred to as “connected ONU information”) of the ONU 42 to which the OLT 44 on the optical path is connected. The cooperation information includes, for example, processing load information. Note that the processing load information in the fifth to eighth embodiments is information regarding the processing load of the OLT 44, and may be, for example, information of the usage rate of the memory or information of the usage rate of the CPU of the OLT 44. The cooperation information includes, for example, processing delay information. Note that the processing delay information in the fifth to eighth embodiments indicates information regarding the processing delay for each OLT 44. The cooperation information includes, for example, delay information. Note that the delay information in the fifth to eighth embodiments indicates information regarding the transmission delay between the terminal 41 and each OLT 44.

The OLT 44 includes at least a transmission unit, a reception unit, and sleep processing unit. The transmission unit transmits the cooperation information upon a request from the management control device 50 or voluntarily to the management control device. The reception unit receives an optical path switching instruction from the management control device 50. The OLT 44 receiving the optical path switching instruction from the management control device 50 indicates that the management control device 50 determines that it is necessary to switch the optical path between the ONU 42 and the OLT 44 on the basis of the cooperation information. The sleep processing unit transitions to the sleep state after the optical path is switched on the basis of the optical path switching instruction. Further, the OLT 44 includes an optical path switching processing unit for performing optical path switching processing.

The concentration device 45 aggregates uplink signals transmitted by the OLTs 44. The concentration device 45 distributes downlink signals.

The core device 46 executes signal processing on the uplink signals aggregated by the concentration device 45. The concentration device 45 transmits a signal obtained as a result of executing the signal processing on the uplink signals to an external network. The core device 46 receives a signal from the external network.

The core device 46 performs prescribed predetermined signal processing on the signal received from the external network. The core device 46 transmits a signal obtained as a result of executing the signal processing on the signal received from the external network to the concentration device 45 as a downlink signal.

The management control device 50 acquires the cooperation information from the OLT 44. The management control device 50 determines the necessity of the optical path switching and the sleep control on the basis of the acquired cooperation information. The management control device 50 performs optical path switching control processing and sleep control processing when it is determined that optical path switching and sleep control are necessary. The optical path switching control processing in the fifth to eighth embodiments is processing of switching the optical path between the ONU 42 and the OLT 44. For example, the management control device 50 instructs the switching device 43 to control switching of the optical path between the ONU 42 and the OLT 44. The sleep control processing in the fifth to eighth embodiments is processing of causing the OLT 44 to execute sleep or to cancel sleep.

Next, an overview of processing of the wired NW system will be described.

The upper diagram of FIG. 35 indicates the connection state of the wired NW system before optical path switching, and the lower diagram of FIG. 35 indicates the connection state of the wired NW system after optical path switching. The upper diagram of FIG. 35 indicates an example in which ONUs 42-1 and 42-2 are connected to an OLT 44-1, and ONUs 42-3 and 42-4 are connected to an OLT 44-2.

The management control device 50 determines whether or not to perform the optical path switching control processing on the basis of the cooperation information collected from each OLT 44. The management control device 50 determines to perform the optical path switching control processing when there is an OLT 44 capable of transition to the sleep state. The OLT 44 capable of transition to the sleep state is, for example, an OLT 44 that does not accommodate the terminals 41.

On the other hand, the management control device 50 determines not to perform the optical path switching control processing when there is no OLT 44 capable of transition to the sleep state. When determining to perform the optical path switching control processing, the management control device 50 instructs the switching device 43 to switch the optical path. The switching device 43 switches the optical path between the ONU 42 and the OLT 44 in accordance with the instruction from the management control device 50. The switching device 43 notifies the management control device 50 of the completion of the optical path switching after the optical path switching is completed.

Upon receiving the notification of optical path switching completion from the switching device 43, the management control device 50 transmits a sleep permission notification to the OLT 44 capable of transition to the sleep state. The sleep permission notification in the fifth to eighth embodiments is a signal including an instruction for causing the OLT 44 to transition to the sleep state. As a result, the OLT 44 capable of transition to the sleep state transitions to the sleep state.

The lower diagram of FIG. 35 illustrates an example in which the ONUs 42-1 to 42-4 are connected to the OLT 44-1 and the OLT 44-2 transitions to the sleep state. As described above, in the wired NW system, the terminal 41 connected to the OLT 44 capable of transition to the sleep state is connected to another OLT 44 on the basis of the cooperation information collected from each OLT 44, whereby the OLT 44 capable of transition to the sleep state transitions to the sleep state. Hereinafter, the OLT 44 capable of transition to the sleep state is referred to as a switching source OLT, and the OLT 44 to be a new connection destination of the terminal 41 connected to the switching source OLT is referred to as a switching destination OLT. Hereinafter, specific configurations will be described using the fifth to eighth embodiments as examples.

### Fifth Embodiment

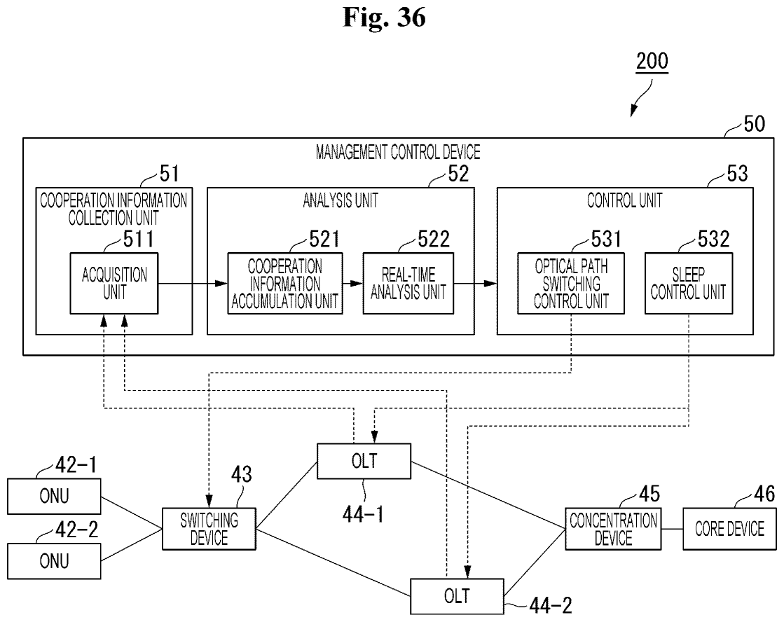

FIG. 36 is a diagram illustrating a configuration example of a wired NW system 200 according to the fifth embodiment. The wired NW system 200 in the fifth embodiment includes one or more ONUs 42, a switching device 43, a plurality of OLTs 44, a concentration device 45, a core device 46, and a management control device 50. Since the ONU 42, the switching device 43, the OLT 44, the concentration device 45, and the core device 46 have been described with reference to FIG. 35, the description thereof will be omitted. The management control device 50 includes a cooperation information collection unit 51, an analysis unit 52, and a control unit 53.

The cooperation information collection unit 51 includes an acquisition unit 511. The acquisition unit 511 collects the cooperation information from the OLT 44 at a predetermined cycle or at an arbitrary timing. The arbitrary timing may be, for example, a timing at which a predetermined time has come, or may be a timing at which an instruction to collect the cooperation information is input from the outside to the management control device 50.

The analysis unit 52 includes a cooperation information accumulation unit 521 and a real-time analysis unit 522. The cooperation information accumulation unit 521 records the collected cooperation information in a predetermined storage device. The real-time analysis unit 522 analyzes a state of communication between each OLT 44 and the terminal 41 such as a change amount of the number of connections of the OLT 44 per unit time on the basis of the cooperation information. Specifically, the real-time analysis unit 522 determines the necessity of optical path switching and sleep control on the basis of the cooperation information.

For example, in a case where all the terminals 41 accommodated in the switching source OLT can be accommodated in another OLT 44, the real-time analysis unit 522 determines that optical path switching and sleep control are necessary. In this case, the real-time analysis unit 522 notifies the control unit 53 of information indicating the OLT 44 to be an optical path switching destination and information indicating the OLT 44 to be a sleep target.

For example, in a case where the number of terminals 41 accommodated in the OLT 44 exceeds the maximum number of accommodated terminals, the real-time analysis unit 522 determines that optical path switching and sleep control are necessary. In this case, the real-time analysis unit 522 notifies the control unit 53 of information indicating the OLT 44 to be an optical path switching destination and information indicating the OLT 44 to be a sleep cancellation target.

The control unit 53 includes an optical path switching control unit 531 and a sleep control unit 532. The optical path switching control unit 531 determines the OLT 44 to be the optical path switching destination on the basis of the analysis result of the real-time analysis unit 522, and instructs the switching device 43 to switch the optical path. For example, the optical path switching control unit 531 determines the OLT 44 to be the optical path switching destination on the basis of the information indicating the OLT 44 to be the optical path switching destination notification of which has been given from the real-time analysis unit 522.

The sleep control unit 532 causes the OLT 44 to execute sleep or cancel sleep on the basis of the analysis result of the real-time analysis unit 522.

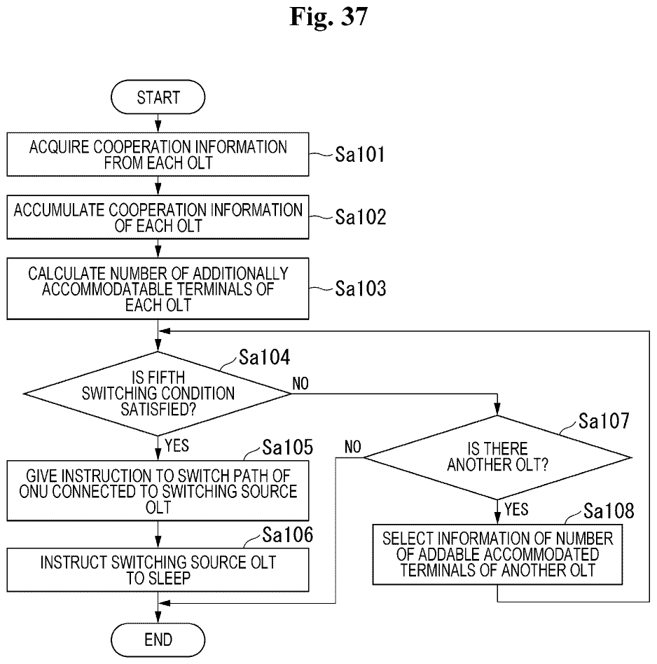

FIG. 37 is a flowchart illustrating an example of a flow of sleep processing executed by the management control device 50 according to the fifth embodiment. In FIG. 37, a case where the cooperation information includes at least information of the number of accommodated terminals of each OLT 44 and information of the maximum number of accommodated terminals will be described as an example. The flow of the processing in FIG. 37 is repeatedly executed at a predetermined cycle.

The acquisition unit 511 acquires the cooperation information from each OLT 44 (step Sa101). The acquisition unit 511 accumulates the acquired cooperation information of each OLT 44 in the cooperation information accumulation unit 521 (step Sa102). The real-time analysis unit 522 calculates the number of additionally accommodatable terminals of each OLT 44 on the basis of the cooperation information for each OLT 44 accumulated in the cooperation information accumulation unit 521 (step Sa103). Here, the number of additionally accommodatable terminals indicates the number of terminals 41 that can be additionally accommodated in addition to the number of terminals currently accommodated in the OLT 44. For example, the number of additionally accommodatable terminals is obtained by subtracting the number of accommodated terminals from the maximum number of accommodated terminals.

The real-time analysis unit 522 determines whether or not a fifth switching condition is satisfied (step Sa104). The fifth switching condition is a condition indicating that switching of the optical path between the ONU 42 and the OLT 44 is necessary, and is, for example, that the number of additionally accommodatable terminals in a certain OLT 44 is larger than the number of accommodated terminals of the OLT 44 as a sleep determination target.

When determining that the fifth switching condition is satisfied (step Sa104—YES), the real-time analysis unit 522 notifies the control unit 53 of an optical path switching instruction and a sleep control instruction. The optical path switching control unit 531 instructs the switching device 43 to switch the optical path of the ONU 42 connected to the switching source OLT on the basis of the optical path switching instruction notification of which has been given from the real-time analysis unit 522 (step Sa105). Specifically, the optical path switching control unit 531 instructs the optical path of the ONU 42 connected to the switching source OLT to head for the switching destination OLT.

The sleep control unit 532 transmits a sleep permission notification to the switching source OLT (step Sa106). For example, the sleep control unit 532 may transmit a sleep instruction to the switching source OLT when an optical path switching completion notification is obtained from the ONU 42 connected to the switching source OLT and the switching destination OLT. As a result, the switching source OLT can transition to the sleep state.

In a case where it is determined that the fifth switching condition is not satisfied in the processing of step Sa104 (step Sa104—NO), the real-time analysis unit 522 determines whether or not there is another OLT 44 (step Sa107). The another OLT 44 is, for example, an OLT 44 that is not compared with the OLT 44 that is a sleep determination target. When it is determined that there is no other OLT 44 (step Sa107—NO), the real-time analysis unit 522 ends the processing.

On the other hand, in a case where it is determined that there is another OLT 44 (step Sa107—YES), the real-time analysis unit 522 selects information of the number of addable accommodated terminals of the another OLT 44 (step Sa108). The real-time analysis unit 522 executes the processing of step Sa104 again by using the information of the number of addable accommodated terminals of the selected another OLT 44.

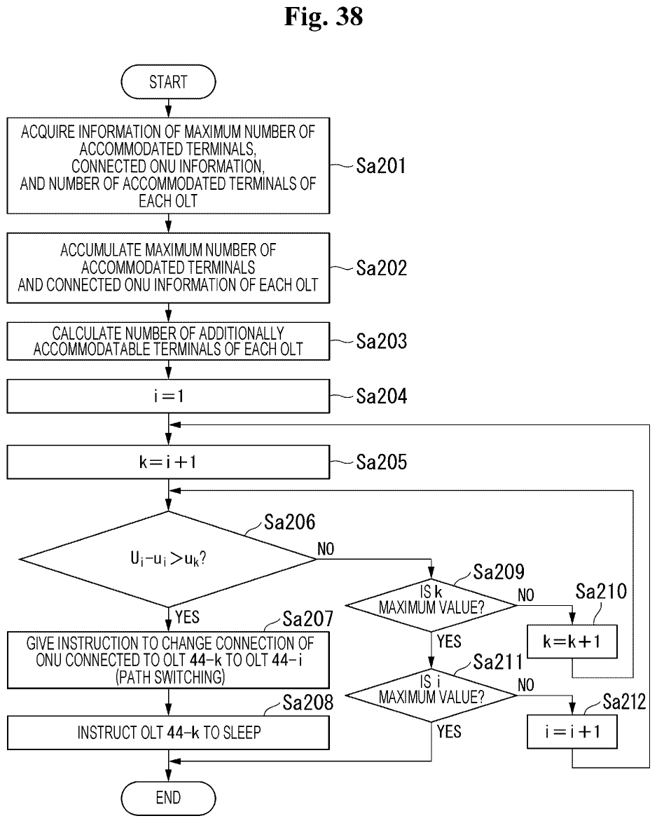

FIG. 38 is a flowchart illustrating an example of a flow of sleep processing executed by the management control device 50 according to the fifth embodiment. Note that, in the processing illustrated in FIG. 38, contents more specifically indicating the processing illustrated in FIG. 37 will be described.

The acquisition unit 511 acquires, from each OLT 44, the information of the maximum number of accommodated terminals, the connected ONU information, and the number of accommodated terminals of each OLT 44 as the cooperation information (step Sa201).

The acquisition unit 511 accumulates the acquired cooperation information of each OLT 44 in the cooperation information accumulation unit 521 (step Sa202). The real-time analysis unit 522 calculates the number of additionally accommodatable terminals of each OLT 44 on the basis of the cooperation information for each OLT 44 accumulated in the cooperation information accumulation unit 521 (step Sa203). Next, the real-time analysis unit 522 substitutes a value of 1 for constant i (step Sa204). In the fifth to eighth embodiments, i indicates, for example, an OLT 44-i to be a switching destination. When i=1, the OLT 44-1 is the switching destination OLT. i is a value of 1≤i≤I. I is the total number of OLTs 44.

Next, the real-time analysis unit 522 substitutes a value of (i+1) for k (step Sa205). In the fifth to eighth embodiments, k indicates, for example, an OLT 44-k to be a switching source. When k=2 (i=1), the OLT 44-2 is the switching source OLT. k is a value of 2≤k≤K. K is the total number of OLTs 44-1, i.e., K=(I−1).

Thereafter, the real-time analysis unit 522 determines whether Uᵢ−uᵢ>uₖ is satisfied (step Sa206). Uᵢ indicates the maximum number of accommodated terminals of the OLT 44-i in the fifth to eighth embodiments, uᵢ indicates the number of accommodated terminals of the OLT 44-i in the fifth to eighth embodiments, and uₖ indicates the number of accommodated terminals of the OLT 44-k in the fifth to eighth embodiments. The condition indicated by Uᵢ−uᵢ>uₖ is a specific example of the fifth switching condition in the fifth embodiment. Here, as an example, it is assumed that the maximum number of accommodated terminals of the OLT 44-1 is 1000, the number of accommodated terminals of the OLT 44-1 is 100, the maximum number of accommodated terminals of the OLT 44-2 is 800, and the number of accommodated terminals of the OLT 44-2 is 200.

When i=1 and k=2, those described below are indicated.

$${U}_{1} - {u}_{1} \text{=>} 1000 - 100 = 900$$

Based on the above results, U₁−uᵢ>u₂ becomes 900>200, and the fifth switching condition is satisfied. When determining that the fifth switching condition (for example, Uᵢ−uᵢ>uₖ) is satisfied (step Sa206—YES), the real-time analysis unit 522 notifies the control unit 53 of an optical path switching instruction and a sleep control instruction.

The optical path switching control unit 531 instructs the switching device 43 to switch the optical path of the ONU 42 connected to the OLT 44-k on the basis of the optical path switching instruction notification of which has been given from the real-time analysis unit 522 (step Sa207). Specifically, the optical path switching control unit 531 gives an instruction so that the optical path of the ONU 42 connected to the OLT 44-k (for example, the OLT 44-2) to head for the OLT 44-i (for example, the OLT 44-1) which is the switching destination OLT. The sleep control unit 532 transmits a sleep permission notification to the OLT 44-k (for example, OLT 44-2) (step Sa208).

On the other hand, as an example, a case is considered in which the maximum number of accommodated terminals of the OLT 44-1 is 1000, the number of accommodated terminals of the OLT 44-1 is 500, the maximum number of accommodated terminals of the OLT 44-2 is 800, and the number of accommodated terminals of the OLT 44-2 is 700. When i=1 and k=2, those described below are indicated.

$${U}_{1} - {u}_{1} \text{=>} 1000 - 500 = 500$$

Based on the above results, U₁−u₁>u₂ becomes 500<700, and the fifth switching condition is not satisfied. In a case where it is determined that the fifth switching condition (for example, Uᵢ−uᵢ>uₖ) is not satisfied (step Sa206—NO), the real-time analysis unit 522 determines whether or not k is the maximum value (step Sa209).

When determining that k is not the maximum value (step Sa209—NO), the real-time analysis unit 522 adds a value of 1 to the value of k (step Sa210). Thereafter, the real-time analysis unit 522 executes the processing of step Sa206 again. For example, as in the above-described example, in a case where i=1 and k=2 and k is not the maximum value, the real-time analysis unit 522 adds a value of 1 to the value of k to obtain k=3. Then, the real-time analysis unit 522 determines whether U₁−u₁>u₃ is satisfied.

On the other hand, when determining that k is the maximum value (step Sa209—YES), the real-time analysis unit 522 determines whether i is the maximum value (step Sa211). When it is determined that i is the maximum value (step Sa211—YES), the real-time analysis unit 522 ends the processing.

On the other hand, when determining that i is not the maximum value (step Sa211—NO), the real-time analysis unit 522 adds a value of 1 to the value of i (step Sa212). Thereafter, the real-time analysis unit 522 executes the processing of step Sa205 again. For example, in a case where i=1, k=3, k is the maximum value, and i is not the maximum value, the real-time analysis unit 522 adds a value of 1 to the value of i to obtain i=2.

Then, the real-time analysis unit 522 substitutes a value of (i+1) for k in the processing of step Sa205 (step Sa205). In this case, i=2 and k=3. Thereafter, the real-time analysis unit 522 determines whether U₂−u₂>u₃ is satisfied in the processing of step Sa206.

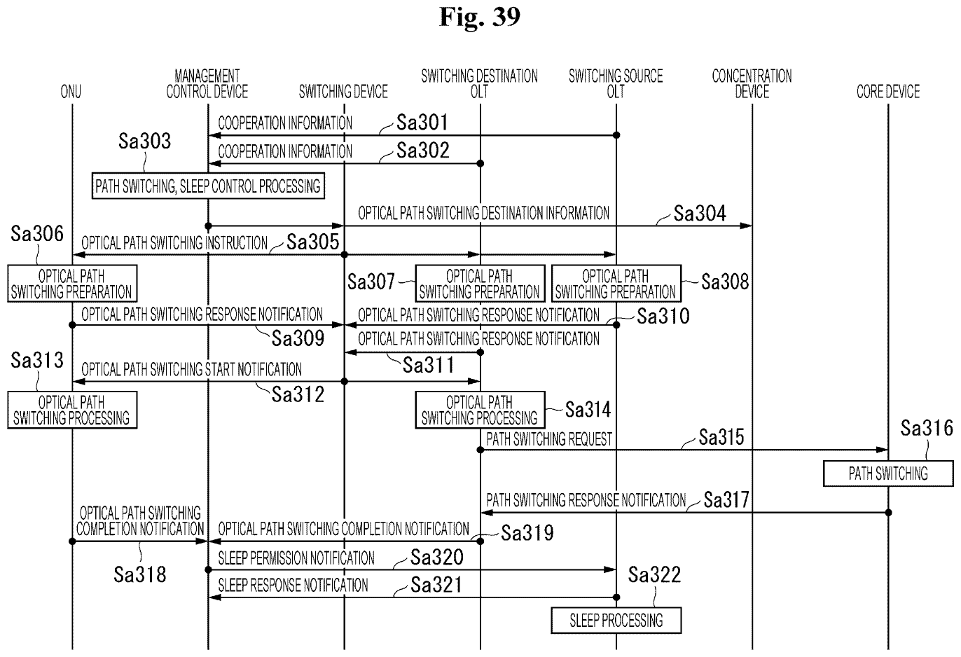

FIG. 39 is a sequence diagram illustrating an example of a detailed flow of sleep processing executed by the wired NW system 200 according to the fifth embodiment. Note that, in the description of FIG. 39, it is assumed that the OLT 44-1 is a switching destination OLT and the OLT 44-2 is a switching source OLT. Here, the switching destination OLT 44-1 and the switching source OLT 44-2 will be described.

The acquisition unit 511 of the management control device 50 acquires the cooperation information from the switching destination OLT 44-1 and the switching source OLT 44-2 at a predetermined cycle or at an arbitrary timing (step Sa301 and step Sa302). The acquisition unit 511 accumulates the acquired cooperation information in the cooperation information accumulation unit 521. When the cooperation information is accumulated in the cooperation information accumulation unit 521, the real-time analysis unit 522 performs optical path switching and sleep control determination (step Sa303).

The optical path switching and the sleep control determination in step Sa303 is a determination as to whether or not the fifth switching condition is satisfied in step Sa104. Here, it is assumed that the fifth switching condition in step Sa104 is satisfied. When the fifth switching condition is satisfied, the real-time analysis unit 522 instructs the optical path switching control unit 531 to perform optical path switching control, and instructs the sleep control unit 532 to perform sleep control.

The optical path switching control unit 531 notifies the switching device 43 and the concentration device 45 of optical path switching destination information (step Sa304). The optical path switching destination information is information regarding an optical path switching destination. In the example illustrated in FIG. 39, the optical path switching destination information includes information indicating the switching destination OLT 44-1 as the optical path switching destination. When notified of the optical path switching destination information from the management control device 50, the switching device 43 instructs the ONU 42 connected to the switching source OLT 44-2, the switching destination OLT 44-1, and the switching source OLT 44-2 to switch the optical path (step Sa305). For example, the switching device 43 instructs the ONU 42 connected to the switching source OLT 44-2 to switch the optical path to the switching destination OLT 44-1, instructs the switching destination OLT 44-1 to switch so that the optical path is connected to the ONU 42 connected to the switching source OLT 44-2, and instructs the switching source OLT 44-2 not to set the optical path.

The ONU 42 connected to the switching source OLT 44-2, the switching destination OLT 44-1, and the switching source OLT 44-2 prepare optical path switching (step Sa306, step Sa307, and step Sa308). The ONU 42 connected to the switching source OLT 44-2, the switching destination OLT 44-1, and the switching source OLT 44-2 transmit an optical path switching response notification to the switching device 43 (step Sa309, step Sa310, and step Sa311). When the optical path switching response notification is obtained from the ONU 42 connected to the switching source OLT 44-2, the switching destination OLT 44-1, and the switching source OLT 44-2, the switching device 43 transmits an optical path switching start notification to the ONU 42 connected to the switching source OLT 44-2 and the switching destination OLT 44-1 (step Sa312).

The ONU 42 connected to the switching source OLT 44-2 and the switching destination OLT 44-1 switch the optical path in response to the reception of the optical path switching start notification (step Sa313 and step Sa314). With this processing, the optical path of the ONU 42 connected to the switching source OLT 44-2 is switched to head for the switching destination OLT 44-1. That is, the ONU 42 and the switching destination OLT 44-1 become a communicable state.

The switching destination OLT 44-1 transmits a path switching request to the core device 46 (step Sa315). The core device 46 switches the path in response to the reception of the path switching request (step Sa316). When the path switching is completed, the core device 46 transmits a path switching response notification to the switching destination OLT 44-1 (step Sa317).

When the optical path switching is completed, the ONU 42 transmits an optical path switching completion notification to the management control device 50 (step Sa318). When the optical path switching is completed, the switching destination OLT 44-1 transmits an optical path switching completion notification to the management control device 50 (step Sa319).

When the optical path switching completion notification is received from the transmission destination of the optical path switching start notification, the sleep control unit 532 of the management control device 50 transmits a sleep permission notification to the switching source OLT 44-2 (step Sa320). When the sleep permission notification is obtained from the management control device 50, the switching source OLT 44-2 transmits a sleep response notification to the management control device 50 (step Sa321). After transmitting the sleep response notification, the switching source OLT 44-2 transitions to the sleep state (step Sa322).

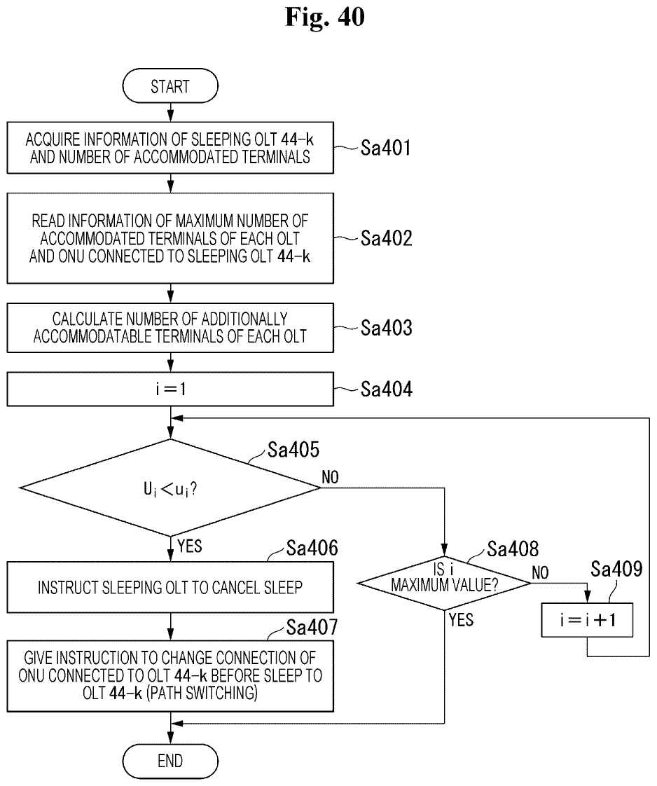

FIG. 40 is a flowchart illustrating an example of a flow of sleep cancellation processing executed by the management control device 50 according to the fifth embodiment. The acquisition unit 511 acquires information of the number of accommodated terminals and the sleeping OLT 44-k from each OLT 44 as the cooperation information (step Sa401). The acquisition unit 511 notifies the analysis unit 52 of the acquired information of the number of accommodated terminals and the sleeping OLT 44-k.

The real-time analysis unit 522 reads information of the maximum number of accommodated terminals of each OLT 44 and information of the ONU 42 connected to the sleeping OLT 44-k from the cooperation information accumulation unit 521 (step Sa402). The real-time analysis unit 522 calculates the number of additionally accommodatable terminals of each OLT 44 on the basis of the cooperation information for each OLT 44 accumulated in the cooperation information accumulation unit 521 (step Sa403).

Next, the real-time analysis unit 522 substitutes a value of 1 for constant i (step Sa404). The real-time analysis unit 522 determines whether Uᵢ<uᵢ is satisfied (step Sa405). The condition indicated by Uᵢ<uᵢ is a specific example of a first sleep cancellation condition. When determining that the first sleep cancellation condition (for example, Uᵢ<uᵢ) is satisfied (step Sa405—YES), the real-time analysis unit 522 determines that the sleep cancellation of the sleeping OLT 44-k and the optical path switching are necessary.

The real-time analysis unit 522 notifies the control unit 53 of the determination result. The sleep control unit 532 transmits an instruction to cancel the sleep to the sleeping OLT 44-k on the basis of the determination result (step Sa406). The optical path switching control unit 531 acquires information of the ONU 42 connected to the OLT 44-k before sleep from the information acquired in the processing of step Sa402. The optical path switching control unit 531 instructs the ONU 42 connected to the OLT 44-k before sleep to change the connection to the OLT 44-k.

In the processing of step Sa405, in a case where it is determined that the first sleep cancellation condition (for example, Uᵢ<uᵢ) is not satisfied (step Sa405—NO), the real-time analysis unit 522 determines whether or not i is the maximum value (step Sa408). When it is determined that i is the maximum value (step Sa408—YES), the real-time analysis unit 522 ends the processing.

On the other hand, when determining that i is not the maximum value (step Sa408—NO), the real-time analysis unit 522 adds a value of 1 to the value of i (step Sa409). Thereafter, the real-time analysis unit 522 executes the processing of step Sa405 again.

Here, the processing of FIG. 40 will be described using specific numerical values. As an example, it is assumed that the total number of the OLTs 44 is 2 (I=2), the maximum number of accommodated terminals of the OLT 44-1 is 1000, the number of accommodated terminals of the OLT 44-1 is 800, the maximum number of accommodated terminals of the OLT 44-2 is 800, and the number of accommodated terminals of the OLT 44-2 is 1000.

When i=1, U₁<u₁ becomes 1000>800, and the first sleep cancellation condition is not satisfied. In a case where it is determined that the first sleep cancellation condition (for example, Uᵢ<uᵢ) is not satisfied (step Sa405—NO), the real-time analysis unit 522 determines whether or not i is the maximum value (step Sa408). At present, since i=1, the real-time analysis unit 522 determines that i is not the maximum value.

The real-time analysis unit 522 adds a value of 1 to the value of i to obtain i=2. The real-time analysis unit 522 executes the processing of step Sa405 again. When i=2, U₂<u₂ becomes 800<1000, and the first sleep cancellation condition is satisfied. Thereafter, the processing of steps Sa406 and Sa407 is executed.

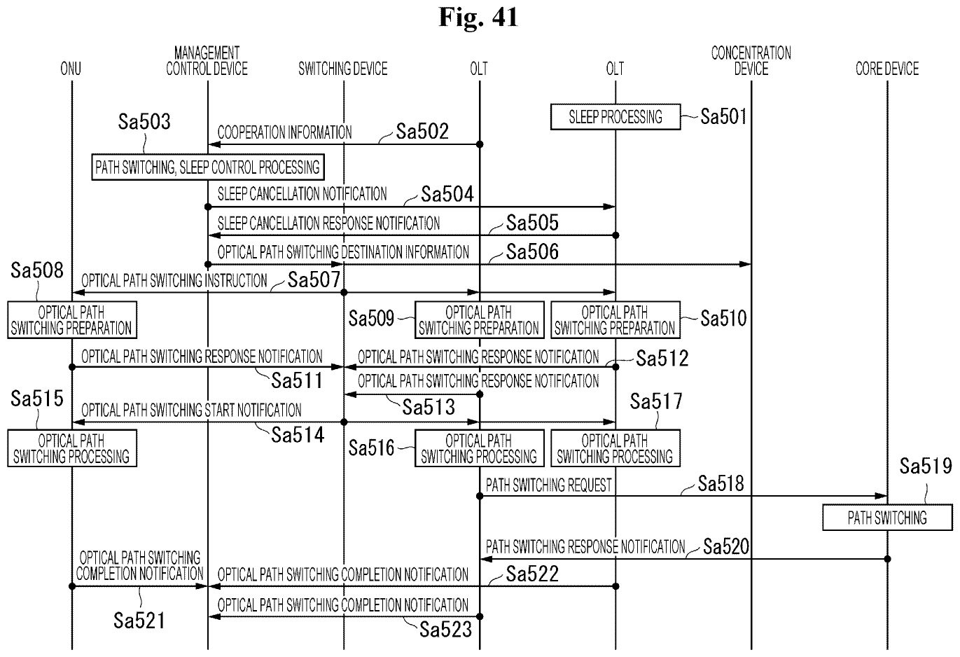

FIG. 41 is a sequence diagram illustrating an example of a detailed flow of sleep cancellation processing executed by the wired NW system 200 according to the fifth embodiment. Note that, in the description of FIG. 41, it is assumed that the OLT 44-2 is in a sleep state.

The OLT 44-2 is in a sleep state (step Sa501). The acquisition unit 511 of the management control device 50 acquires the cooperation information from the OLT 44-1 at a predetermined cycle or at an arbitrary timing (step Sa502). The acquisition unit 511 accumulates the acquired cooperation information in the cooperation information accumulation unit 521. When the cooperation information is accumulated in the cooperation information accumulation unit 521, the real-time analysis unit 522 performs optical path switching and sleep control determination (step Sa503). The optical path switching and the sleep control determination in step Sa503 are whether or not the sleep cancellation condition is satisfied. Here, it is assumed that the sleep cancellation condition is satisfied.

The sleep control unit 532 of the management control device 50 transmits a sleep cancellation notification to the OLT 44-2 (step Sa504). In response to the reception of the sleep cancellation notification, the OLT 44-2 transmits a sleep cancellation response notification to the management control device 50 (step Sa505).

The optical path switching control unit 531 notifies the switching device 43 and the concentration device 45 of optical path switching destination information (step Sa506). When notified of the optical path switching destination information from the management control device 50, the switching device 43 instructs the ONU 42, the OLT 44-1, and the OLT 44-2 to switch the optical path (step Sa507).

The ONU 42, the OLT 44-1, and the OLT 44-2 prepare optical path switching (step Sa508, step Sa509, and step Sa510). When the optical path switching preparation is completed, the ONU 42, the OLT 44-1, and the OLT 44-2 transmit an optical path switching response notification indicating that the switching preparation is completed to the switching device 43 (step Sa511, step Sa512, and step Sa513).

When the optical path switching response notification is obtained from the ONU 42, the OLT 44-1, and the OLT 44-2, the switching device 43 transmits the optical path switching start notification to the ONU 42, the OLT 44-1, and the OLT 44-2 (step Sa514).

The ONU 42, the OLT 44-1, and the OLT 44-2 switch the optical path in response to the reception of the optical path switching start notification (step Sa515, step Sa516, and step Sa517). The OLT 44-1 transmits a path switching request to the concentration device 45 (step Sa518). The concentration device 45 switches the path in response to the reception of the path switching request (step Sa519). When the path switching is completed, the concentration device 45 transmits a path switching response notification to the OLT 44-1 (step Sa520).

When the optical path switching is completed, the ONU 42 transmits an optical path switching completion notification to the management control device 50 (step Sa521). When the optical path switching is completed, the OLT 44-1 transmits an optical path switching completion notification to the management control device 50 (step Sa522). When the optical path switching is completed, the OLT 44-2 transmits an optical path switching completion notification to the management control device 50 (step Sa523).

The wired NW system 200 configured as described above includes the one or more ONUs 42 that perform wired communication with one or more terminals 41, the plurality of OLTs 44 connected to the one or more ONUs 42 via the switching device 43, the cooperation information collection unit 51 that acquires cooperation information indicating a state of communication between the plurality of OLTs 44 and the one or more terminals 41 at a predetermined cycle or at an arbitrary timing, the optical path switching control unit 531 that controls switching of an optical path between the one or more ONUs 42 and the plurality of OLTs 44 in a case where it is determined that switching of the optical path between the one or more ONUs 42 and the plurality of OLTs 44 is necessary on the basis of the cooperation information, and the sleep control unit 532 that causes an OLT 44 capable of sleep to transition to a sleep state after switching of the optical path is performed. As a result, the optical path switching and the sleep control are performed while analyzing the load of each OLT 44. Accordingly, it is possible to increase the effect of power saving without deterioration in communication quality.

### First Modification of Fifth Embodiment

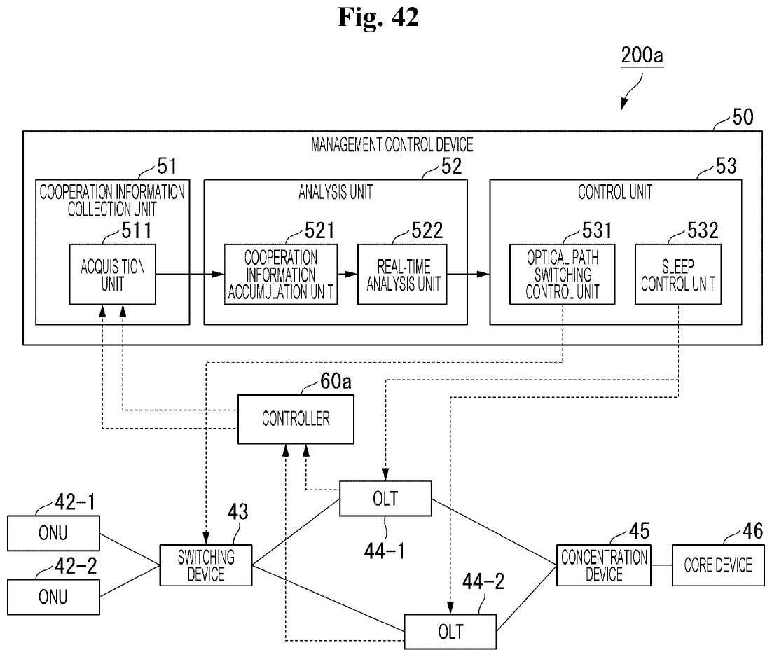

The above-described embodiment indicates the configuration in which the management control device 50 directly acquires the cooperation information from the OLT 44. The management control device 50 may acquire the cooperation information via another device (for example, a controller). FIG. 42 is a diagram illustrating a configuration example of a wired NW system 200a according to a first modification of the fifth embodiment. The wired NW system 200a includes one or more ONUs 42, a switching device 43, a plurality of OLTs 44, a concentration device 45, a core device 46, a management control device 50, and a controller 60a. As illustrated in FIG. 42, in the wired NW system 200a, the controller 60a is provided between the management control device 50 and the OLTs 44.

The controller 60a acquires the cooperation information from each OLT 44 at a predetermined cycle or at an arbitrary timing. The controller 60a transmits the acquired cooperation information to the management control device 50. Note that the controller 60a may receive a sleep control instruction from the management control device 50 and transmit the sleep control instruction to the switching source OLT.

With this configuration, the management control device 50 can collect the cooperation information by wireless communication.

### Second Modification of Fifth Embodiment

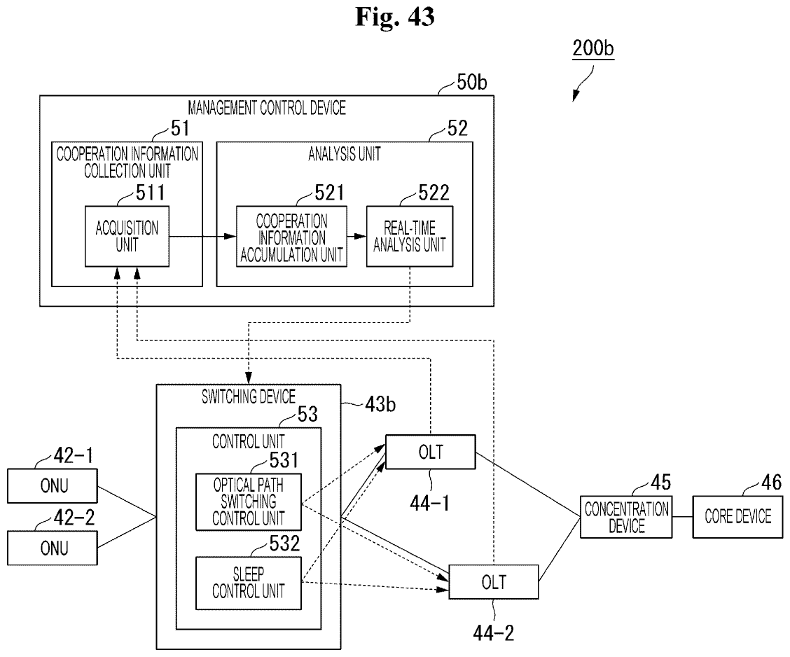

The above-described embodiment indicates the configuration in which the management control device 50 performs the optical path switching control processing and the sleep control processing. On the other hand, the switching device 43 may be configured to perform the optical path switching control processing and the sleep control processing. FIG. 43 is a diagram illustrating a configuration example of a wired NW system 200b according to a second modification of the fifth embodiment. The wired NW system 200b includes one or more ONUs 42, a switching device 43b, a plurality of OLTs 44, a concentration device 45, a core device 46, and a management control device 50b.

As illustrated in FIG. 43, the switching device 43b includes the control unit 53, and the management control device 50b does not include the control unit 53. The real-time analysis unit 522 of the management control device 50b notifies the switching device 43b of the analysis result. Note that the real-time analysis unit 522 may notify the switching device 43b of the analysis result only when optical path switching and sleep control are performed. The control unit 53 of the switching device 43b performs the optical path switching control processing and the sleep control processing on the basis of the analysis result notification of which has been given from the management control device 50b.

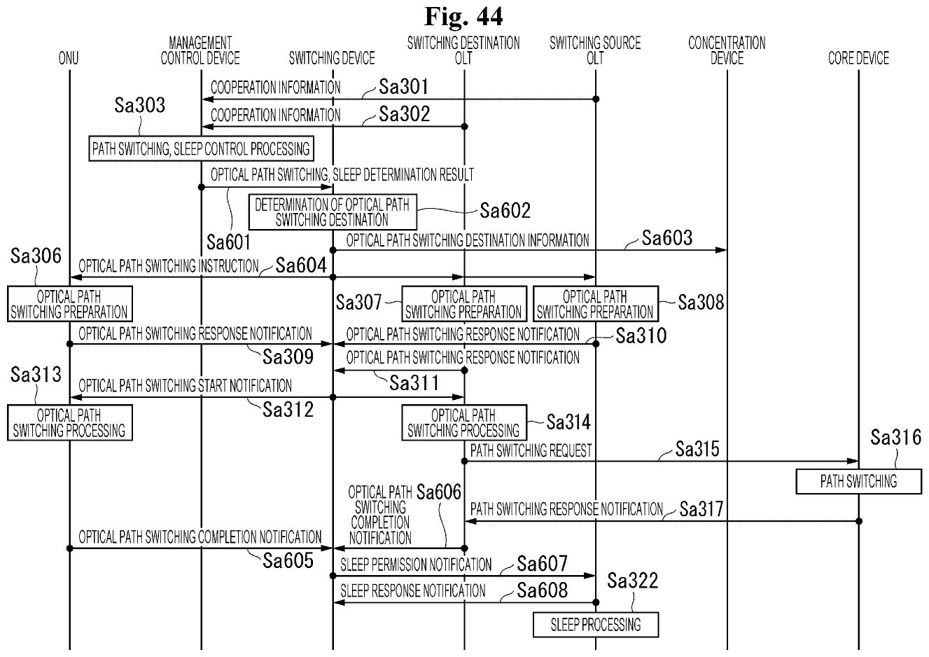

FIG. 44 is a sequence diagram illustrating an example of a detailed flow of sleep processing executed by the wired NW system 200b according to a second modification of the fifth embodiment. In FIG. 44, the same processing steps as those in FIG. 39 will be denoted by the same reference signs as those used in FIG. 39, and description thereof will be omitted. Note that, in the description of FIG. 44, it is assumed that the OLT 44-1 is a switching destination OLT and the OLT 44-2 is a switching source OLT. Here, the switching destination OLT 44-1 and the switching source OLT 44-2 will be described.

After the processing from step Sa301 to step Sa303 is executed, the real-time analysis unit 522 instructs the switching device 43b to perform optical path switching control and sleep control when the fifth switching condition is satisfied (step Sa601). The switching device 43b receives the instruction transmitted from the management control device 50b.

The optical path switching control unit 531 of the switching device 43b determines the optical path switching destination from the information included in the received instruction (step Sa602). The optical path switching control unit 531 notifies the concentration device 45 of optical path switching destination information (step Sa603). Thereafter, the optical path switching control unit 531 instructs the ONU 42 connected to the switching source OLT 44-2, the switching destination OLT 44-1, and the switching source OLT 44-2 to switch the optical path (step Sa604). Thereafter, the processing from step Sa306 to step Sa317 is executed.

When the optical path switching is completed, the ONU 42 transmits an optical path switching completion notification to the switching device 43b (step Sa605). Note that the ONU 42 may also transmit the optical path switching completion notification to the management control device 50b. When the optical path switching is completed, the switching destination OLT 44-1 transmits an optical path switching completion notification to the switching device 43b (step Sa606). Note that the ONU 42 may also transmit the optical path switching completion notification to the management control device 50b.

When the optical path switching completion notification is received from the transmission destination of the optical path switching start notification, the sleep control unit 532 included in the switching device 43b transmits a sleep permission notification to the switching source OLT 44-2 (step Sa607). When the sleep permission notification is obtained from the switching device 43b, the switching source OLT 44-2 transmits a sleep response notification to the switching device 43b (step Sa608). After transmitting the sleep response notification, the switching source OLT 44-2 transitions to the sleep state (step Sa322).

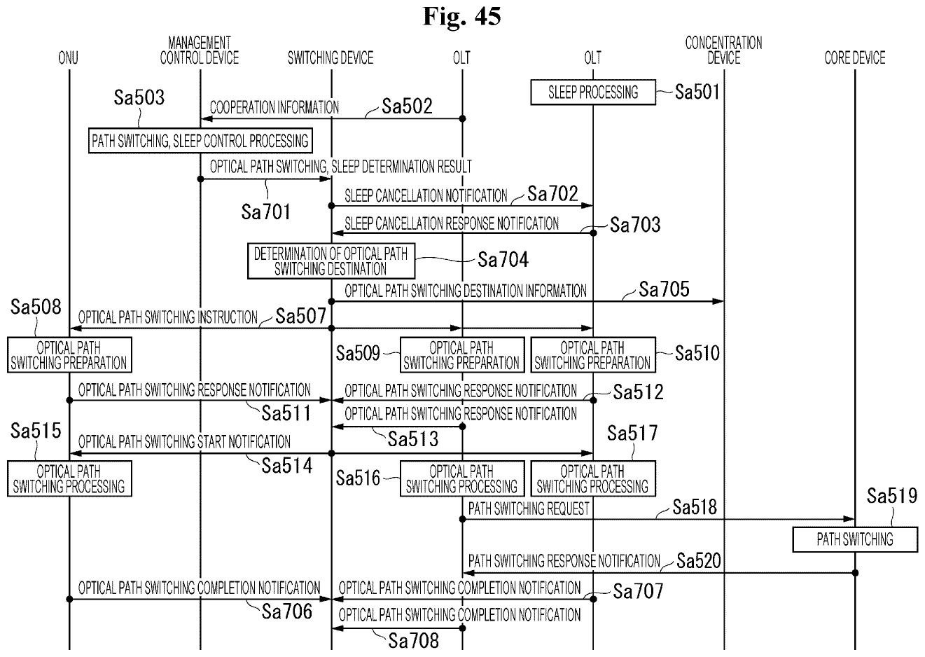

FIG. 45 is a sequence diagram illustrating an example of a detailed flow of sleep cancellation processing executed by the wired NW system 200b according to the second modification of the fifth embodiment. In FIG. 45, the same processing steps as those in FIG. 41 will be denoted by the same reference signs as those used in FIG. 41, and description thereof will be omitted. Note that, in the description of FIG. 45, it is assumed that the OLT 44-2 is in a sleep state.

After the processing from step Sa501 to step Sa503 is executed, the real-time analysis unit 522 instructs the switching device 43b to perform optical path switching control and sleep control when the sleep cancellation condition is satisfied (step Sa701). The switching device 43b receives the instruction transmitted from the management control device 50b.

The sleep control unit 532 of the switching device 43b transmits a sleep cancellation notification to the OLT 44-2 on the basis of the information included in the received instruction (step Sa702). In response to the reception of the sleep cancellation notification, the OLT 44-2 transmits a sleep cancellation response notification to the switching device 43b (step Sa703). The optical path switching control unit 531 of the switching device 43b determines the optical path switching destination from the information included in the received instruction (step Sa704). The optical path switching control unit 531 of the switching device 43b notifies the concentration device 45 of optical path switching destination information (step Sa705). Thereafter, the processing from step Sa507 to step Sa520 is executed.

When the optical path switching is completed, the ONU 42 transmits an optical path switching completion notification to the switching device 43b (step Sa706). When the optical path switching is completed, the OLT 44-1 transmits an optical path switching completion notification to the switching device 43b (step Sa707). When the optical path switching is completed, the OLT 44-2 transmits an optical path switching completion notification to the switching device 43b (step Sa708).

### Sixth Embodiment

The sixth embodiment is different from the fifth embodiment in that processing load information (for example, information of the usage rate of the memory or information of the usage rate of the CPU for each OLT 44) is further included as the cooperation information. In the sixth embodiment, as an example of the processing load information, information of the usage rate of the memory for each OLT 44 will be described as an example.

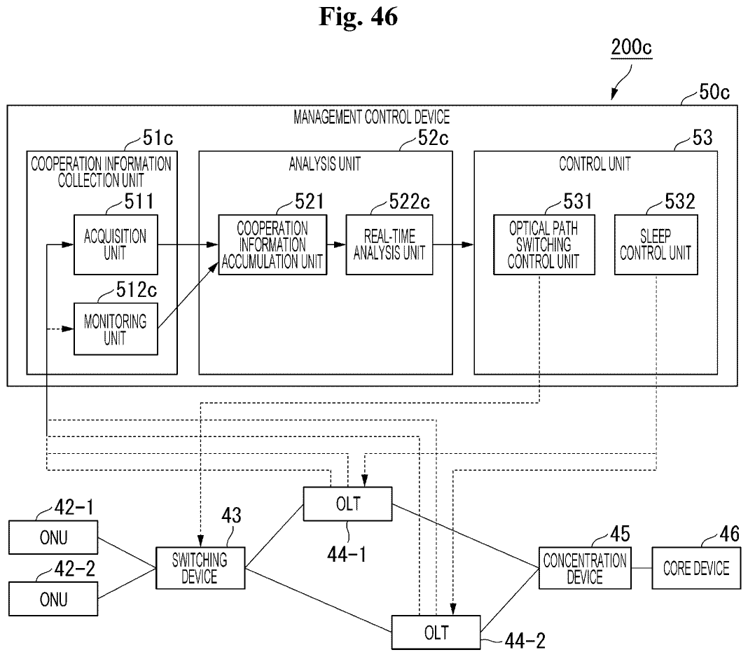

FIG. 46 is a diagram illustrating a configuration example of a wired NW system 200c according to the sixth embodiment. The wired NW system 200c in the sixth embodiment includes one or more ONUs 42, a switching device 43, a plurality of OLTs 44, a concentration device 45, a core device 46, and a management control device 50c. The management control device 50c includes a cooperation information collection unit 51c, an analysis unit 52c, and a control unit 53.

The cooperation information collection unit 51c includes an acquisition unit 511 and a monitoring unit 512c. The monitoring unit 512c monitors each OLT 44 and measures the memory usage rate for each OLT 44. The monitoring unit 512c outputs information of the memory usage rate measured for each OLT 44 to the analysis unit 52c as the cooperation information.

The analysis unit 52c includes a cooperation information accumulation unit 521 and a real-time analysis unit 522c. The real-time analysis unit 522c analyzes a state of communication in the wired NW system 200c such as a change amount of the number of connections of the OLT 44 per unit time on the basis of the cooperation information. Specifically, the real-time analysis unit 522c roughly calculates the memory usage rate per OLT by dividing the memory usage rate by the current number of accommodated terminals. Further, the real-time analysis unit 522c multiplies the number of accommodated terminals of another OLT 44 by the memory usage rate per target OLT 44, and determines optical path switching and sleep when the memory usage rate does not exceed 100% and the number of accommodated terminals of the OLT 44 is smaller than the number of terminals that can be additionally accommodated in the target OLT 44.

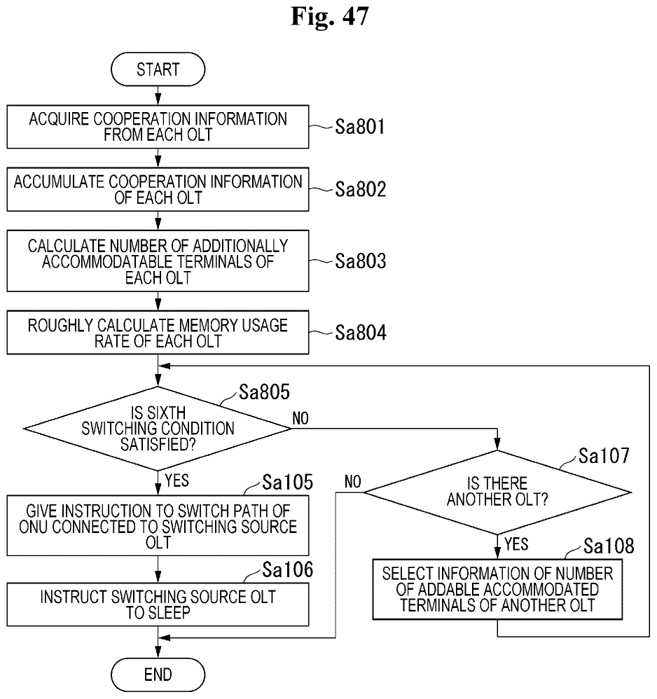

FIG. 47 is a flowchart illustrating an example of a flow of sleep processing executed by the management control device 50c according to the sixth embodiment. In FIG. 47, the same processing steps as those in FIG. 37 will be denoted by the same reference signs as those used in FIG. 37, and description thereof will be omitted.

The cooperation information collection unit 51c acquires the cooperation information from each OLT 44 (step Sa801). Specifically, the acquisition unit 511 acquires at least information of the number of accommodated terminals, information of the maximum number of accommodated terminals, and the like as the cooperation information from each OLT 44. Further, the monitoring unit 512c measures the memory usage rate for each OLT 44. The cooperation information collection unit 51c accumulates the acquired cooperation information of each OLT 44 in the cooperation information accumulation unit 521 (step Sa802). Specifically, in addition to the cooperation information including at least the information of the number of accommodated terminals, the information of the maximum number of accommodated terminals, and the like from each OLT 44, the cooperation information collection unit 51c accumulates information of the memory usage rate of each OLT 44 in the cooperation information accumulation unit 521 as the cooperation information.

The real-time analysis unit 522c calculates the number of additionally accommodatable terminals of each OLT 44 on the basis of the cooperation information for each OLT 44 accumulated in the cooperation information accumulation unit 521 (step Sa803). Further, the real-time analysis unit 522c roughly calculates the memory usage rate of each OLT 44 on the basis of the cooperation information for each OLT 44 accumulated in the cooperation information accumulation unit 521 (step Sa804).

The real-time analysis unit 522c determines whether or not a sixth switching condition is satisfied (step Sa805). The sixth switching condition is a condition indicating that switching of the optical path between the ONU 42 and the OLT 44 is necessary, for example, that the number of additionally accommodatable terminals in a certain OLT 44 is larger than the number of accommodated terminals of the OLT 44 as a sleep determination target, and the memory usage rate does not exceed 100%.

When determining that the sixth switching condition is satisfied (step Sa805—YES), the real-time analysis unit 522c executes the processing of step Sa105 and subsequent steps. On the other hand, when determining that the sixth switching condition is not satisfied (step Sa805—NO), the real-time analysis unit 522c executes the processing of step Sa107 and subsequent steps.

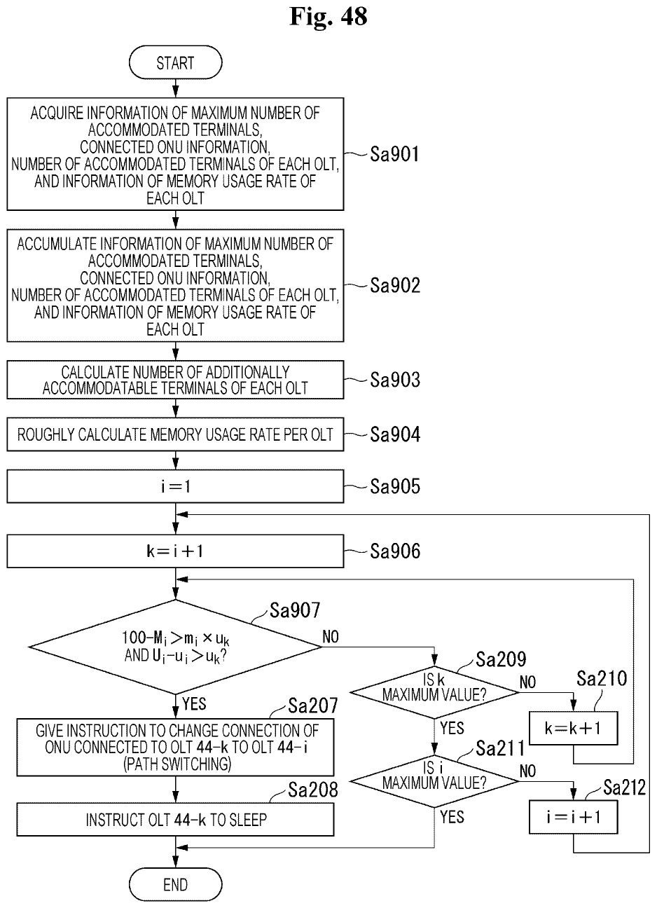

FIG. 48 is a flowchart illustrating an example of a flow of sleep processing executed by the management control device 50c according to the sixth embodiment. Note that, in the processing illustrated in FIG. 48, contents more specifically indicating the processing illustrated in FIG. 47 will be described. In FIG. 48, the same processing steps as those in FIG. 38 will be denoted by the same reference signs as those used in FIG. 38, and description thereof will be omitted.

The acquisition unit 511 acquires, from each OLT 44, the information of the maximum number of accommodated terminals, the connected ONU information, and the number of accommodated terminals of each OLT 44 as the cooperation information. Further, the monitoring unit 512c acquires information of the memory usage rate of each OLT 44 (step Sa901).

The acquisition unit 511 accumulates the acquired cooperation information of each OLT 44 in the cooperation information accumulation unit 521. The monitoring unit 512c accumulates the acquired information of the memory usage rate of each OLT 44 as the cooperation information (step Sa902). The real-time analysis unit 522c calculates the number of additionally accommodatable terminals of each OLT 44 on the basis of the cooperation information for each OLT 44 accumulated in the cooperation information accumulation unit 521 (step Sa903). Further, the real-time analysis unit 522c roughly calculates the memory usage rate per OLT 44 on the basis of the cooperation information for each OLT 44 accumulated in the cooperation information accumulation unit 521 (step Sa904).

Next, the real-time analysis unit 522c substitutes a value of 1 for constant i (step Sa905). Next, the real-time analysis unit 522c substitutes a value of (i+1) for k (step Sa906). Thereafter, the real-time analysis unit 522c determines whether 100−Mᵢ>mᵢ×uₖ and Uᵢ−uᵢ>uₖ is satisfied (step Sa907). In the sixth to eighth embodiments, Mᵢ indicates the memory usage rate of an OLT 44-i, and in the sixth to eighth embodiments, mᵢ indicates the memory usage rate per OLT 44. mᵢ is calculated in the processing of step Sa904. The condition indicated by 100−Mᵢ>mᵢ×uₖ and Uᵢ−uᵢ>uₖ is a specific example of the sixth switching condition.

When determining that the sixth switching condition is satisfied (step Sa907—YES), the real-time analysis unit 522c executes the processing of step Sa207 and subsequent steps. On the other hand, when determining that the sixth switching condition is not satisfied (step Sa907—NO), the real-time analysis unit 522c executes the processing of step Sa209 and subsequent steps.

Here, the processing of FIG. 48 will be described using specific numerical values. As an example, it is assumed that the maximum number of accommodated terminals of the OLT 44-1 is 1000, the number of accommodated terminals of the OLT 44-1 is 100, the memory usage rate M₁ of the OLT 44-1 is 20%, the maximum number of accommodated terminals of the OLT 44-2 is 800, the number of accommodated terminals of the OLT 44-2 is 200, and the memory usage rate M₂ of the OLT 44-2 is 30%. In this case, in the processing of step Sa904, the real-time analysis unit 522c calculates m1=20/100=0.2 and m2=30/200=0.15 as rough calculation values of the memory usage rate per OLT 44. m1 indicates a rough calculation value of the memory usage rate per OLT 44-1, and m2 indicates a rough calculation value of the memory usage rate per OLT 44-2.

In the processing of step Sa907, the real-time analysis unit 522c determines whether 100-Mᵢ>mᵢ×uₖ and Uᵢ−uᵢ>uₖ are satisfied. When i=1 and k=2, those described below are indicated.

$$100 - {M}_{i} \text{=>} 100 - 20 = 80 \\ {m}_{i} \times {u}_{k} \text{=>} 0.2 \times 200 = 40 \\ {U}_{i} - {u}_{i} \text{=>} 1000 - 100 = 900$$

Based on the above results, 100−Mᵢ>mᵢ×uₖ and Uᵢ−uᵢ>uₖ are 180>40 and 900>200. In this case, the real-time analysis unit 522c determines that the sixth switching condition is satisfied. Thus, the real-time analysis unit 522c determines switching so as to connect the ONU 42 connected to the OLT 44-2 to the OLT 44-1, and determines sleep so as to cause the OLT 44-2 transition to the sleep state. The real-time analysis unit 522c notifies the optical path switching control unit 531 of the result of the switching determination to connect the ONU 42 connected to the OLT 44-2 to the OLT 44-1, and notifies the sleep control unit 532 of the sleep determination result to cause the OLT 44-2 to transition to the sleep state.

As a result, the optical path switching control unit 531 controls switching of the optical path so as to connect the ONU 42 connected to the OLT 44-2 to the OLT 44-1 in accordance with the notification from the real-time analysis unit 522c. The sleep control unit 532 controls sleep so as to cause the OLT 44-2 to transition to the sleep state in accordance with the notification from the real-time analysis unit 522c.

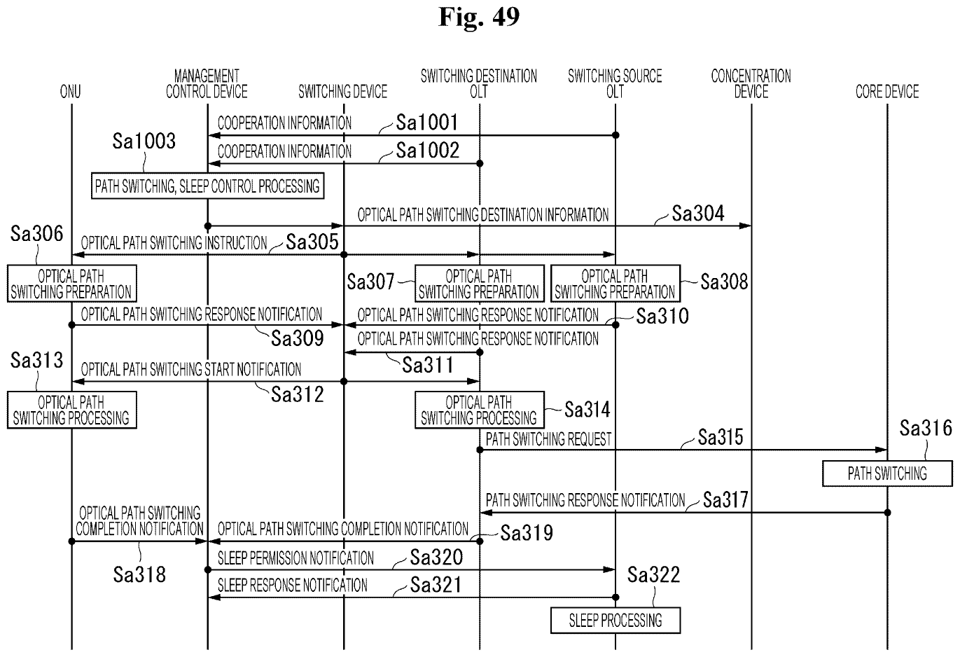

FIG. 49 is a sequence diagram illustrating an example of a detailed flow of sleep processing executed by the wired NW system 200c according to the sixth embodiment. In FIG. 49, the same processing steps as those in FIG. 39 will be denoted by the same reference signs as those used in FIG. 39, and description thereof will be omitted. Note that, in the description of FIG. 49, it is assumed that the OLT 44-1 is a switching destination OLT and the OLT 44-2 is a switching source OLT. Here, the switching destination OLT 44-1 and the switching source OLT 44-2 will be described.

The cooperation information collection unit 51c of the management control device 50c acquires the cooperation information from the switching destination OLT 44-1 and the switching source OLT 44-2 at a predetermined cycle or at an arbitrary timing (step Sa1001 and step Sa1002). Note that the cooperation information acquired in step Sa1001 and step Sa1002 includes information of the usage rate of the memory for each OLT 44 in addition to at least the information of the number of accommodated terminals, information of the maximum number of accommodated terminals, and the like. The cooperation information collection unit 51c accumulates the acquired cooperation information in the cooperation information accumulation unit 521.

When the cooperation information is accumulated in the cooperation information accumulation unit 521, the real-time analysis unit 522c performs optical path switching and sleep control determination (step Sa1003). The optical path switching and the sleep control determination in step Sa1003 is a determination as to whether or not the sixth switching condition is satisfied in step Sa805. Here, it is assumed that the sixth switching condition in step Sa805 is satisfied. When the sixth switching condition is satisfied, the real-time analysis unit 522c executes the processing of step Sa304 and subsequent steps.

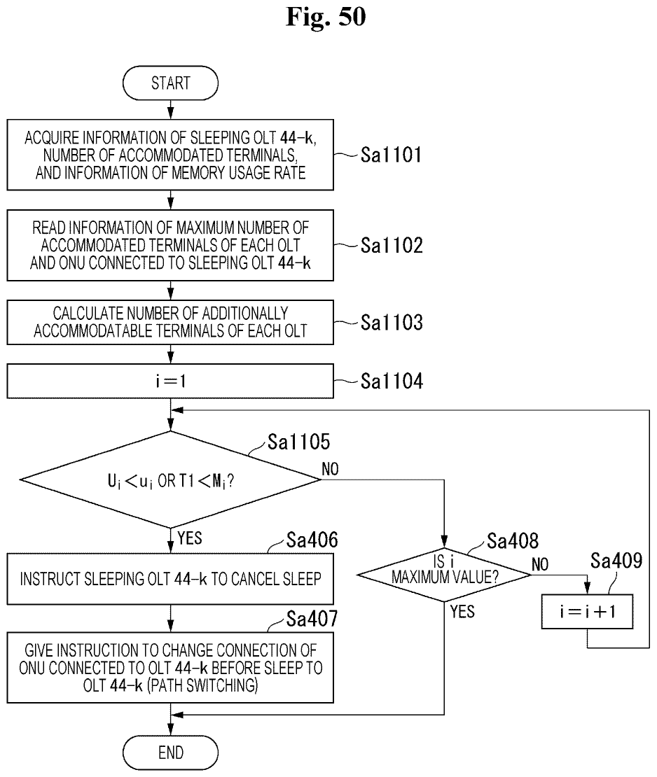

FIG. 50 is a flowchart illustrating an example of a flow of sleep cancellation processing executed by the management control device 50c according to the sixth embodiment. In FIG. 50, the same processing steps as those in FIG. 40 will be denoted by the same reference signs as those used in FIG. 40, and description thereof will be omitted.

The acquisition unit 511 acquires information of the number of accommodated terminals and the sleeping OLT 44-k from each OLT 44 as the cooperation information. Further, the monitoring unit 512c acquires information of the memory usage rate of each OLT 44 as the cooperation information (step Sa1101). The acquisition unit 511 notifies the analysis unit 52c of the acquired information of the number of accommodated terminals, the sleeping OLT 44-k, and the information of the memory usage rate.

The real-time analysis unit 522c of the analysis unit 52c reads information of the maximum number of accommodated terminals of each OLT 44 and information of the ONU 42 connected to the sleeping OLT 44-k from the cooperation information accumulation unit 521 (step Sa1102). The real-time analysis unit 522c calculates the number of additionally accommodatable terminals of each OLT 44 on the basis of the acquired cooperation information for each OLT 44 (step Sa1103).

Next, the real-time analysis unit 522c substitutes a value of 1 for constant i (step Sa1104). The real-time analysis unit 522c determines whether either Uᵢ<uᵢ or T₁<Mᵢ is satisfied (step Sa1105). The condition indicated by Uᵢ<uᵢ or T₁<Mᵢ is a specific example of a second sleep cancellation condition. In the second sleep cancellation condition, T1<Mᵢ means that the memory usage rate Mᵢ of the OLT 44-i exceeds a threshold T1 (for example, a predetermined value such as 80, 90, or 100%).

When determining that the second sleep cancellation condition (for example, Uᵢ<uᵢ or T1<Mᵢ) is satisfied (step Sa1105—YES), the real-time analysis unit 522c determines that the optical path switching and the sleep cancellation of the sleeping OLT 44-k are necessary.

The real-time analysis unit 522c notifies the control unit 53 of the determination result. Thereafter, the processing in step Sa406 and subsequent steps is executed. On the other hand, when determining that the second sleep cancellation condition (for example, Uᵢ<uᵢ or T₁<Mᵢ) is not satisfied (step Sa1105—NO), the real-time analysis unit 522c executes the processing of step Sa408.

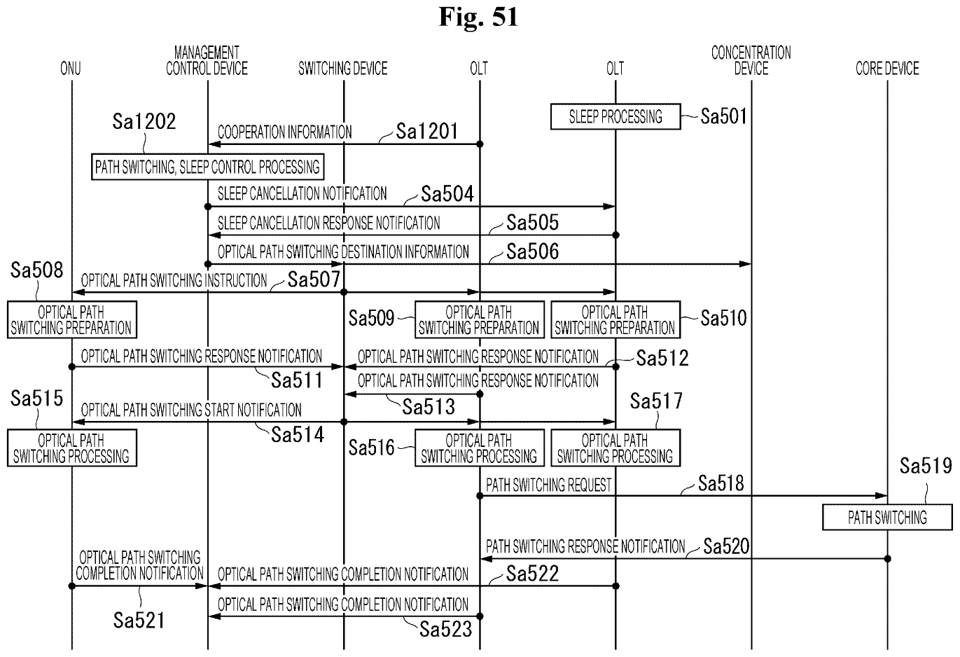

FIG. 51 is a sequence diagram illustrating an example of a detailed flow of sleep cancellation processing executed by the wired NW system 200c according to the sixth embodiment. In FIG. 51, the same processing steps as those in FIG. 41 will be denoted by the same reference signs as those used in FIG. 41, and description thereof will be omitted. Note that, in the description of FIG. 51, it is assumed that the OLT 44-2 is in a sleep state.

The OLT 44-2 is in a sleep state (step Sa501). The cooperation information collection unit 51c of the management control device 50c acquires the cooperation information from the OLT 44-1 at a predetermined cycle or at an arbitrary timing (step Sa1201). Note that the cooperation information acquired in step Sa1201 includes information of the usage rate of the memory for each OLT 44 in addition to at least the information of the number of accommodated terminals, information of the maximum number of accommodated terminals, and the like. The cooperation information collection unit 51c accumulates the acquired cooperation information in the cooperation information accumulation unit 521.

When the cooperation information is accumulated in the cooperation information accumulation unit 521, the real-time analysis unit 522c performs optical path switching and sleep control determination (step Sa1202). The optical path switching and the sleep control determination in step Sa1202 are whether or not the sleep cancellation condition is satisfied. Here, it is assumed that the sleep cancellation condition is satisfied. When the sleep cancellation condition is satisfied, the real-time analysis unit 522c executes the processing of step Sa504 and subsequent steps.

With the wired NW system 200c according to the sixth embodiment configured as described above, the same effects as those of the fifth embodiment can be achieved. Specifically, in the wired NW system 200c, the management control device 50c further acquires the information of the usage rate of the memory for each OLT 44 as the cooperation information, and determines the necessity of optical path switching on the basis of the cooperation information. When it is determined that it is necessary to switch the optical path, the management control device 50c controls switching of the optical path between one or more ONUs 42 and the plurality of OLTs 44. Further, the management control device 50c causes the OLT 44 capable of sleep to transition to the sleep state after the optical path switching is performed. As a result, the optical path switching and the sleep control are performed while analyzing the load of each OLT 44. Accordingly, it is possible to increase the effect of power saving without deterioration in communication quality.

### First Modification of Sixth Embodiment

The above-described embodiment indicates the configuration in which the management control device 50c directly acquires the cooperation information from the OLT 44. The management control device 50c may acquire the cooperation information via another device (for example, a controller). The wired NW system 200c newly includes a controller 60a, and the controller 60a is provided between the management control device 50c and the OLT 44.

The controller 60a acquires the cooperation information from each OLT 44 at a predetermined cycle or at an arbitrary timing. The controller 60a transmits the acquired cooperation information to the management control device 50c. Note that the controller 60a may receive a sleep control instruction from the management control device 50c and transmit the sleep control instruction to the switching source OLT.

With this configuration, the management control device 50c can collect the cooperation information by wireless communication.

### Second Modification of Sixth Embodiment

The above-described embodiment indicates the configuration in which the management control device 50c performs the optical path switching control processing and the sleep control processing. On the other hand, the switching device 43 may be configured to perform the optical path switching control processing and the sleep control processing. In such a configuration, the switching device 43 includes the control unit 53, and the management control device 50c does not include the control unit 53. The real-time analysis unit 522c of the management control device 50c notifies the switching device 43 of the analysis result. Note that the real-time analysis unit 522c may notify the switching device 43 of the analysis result only when optical path switching and sleep control are performed. The control unit 53 of the switching device 43 performs the optical path switching control processing and the sleep control processing on the basis of the analysis result notification of which has been given from the management control device 50c.

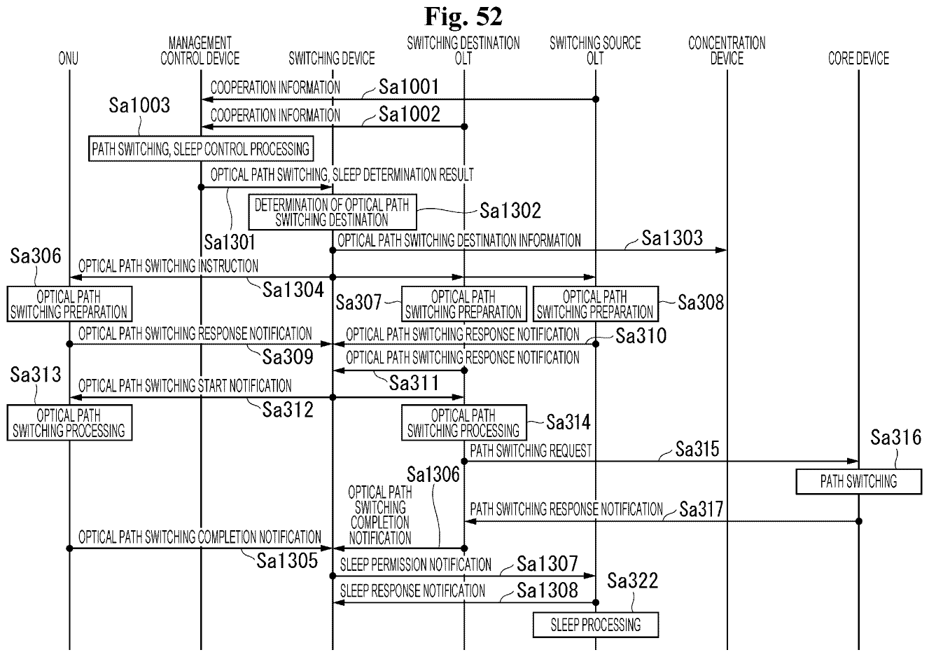

FIG. 52 is a sequence diagram illustrating an example of a detailed flow of sleep processing executed by the wired NW system 200c according to a second modification of the sixth embodiment. In FIG. 52, the same processing steps as those in FIG. 49 will be denoted by the same reference signs as those used in FIG. 49, and description thereof will be omitted.

After the processing from step Sa1001 to step Sa1003 is executed, the real-time analysis unit 522c instructs the switching device 43b to perform optical path switching control and sleep control when the sixth switching condition is satisfied (step Sa1301). The switching device 43b receives the instruction transmitted from the management control device 50c.

The optical path switching control unit 531 of the switching device 43b determines the optical path switching destination from the information included in the received instruction (step Sa1302). The optical path switching control unit 531 notifies the concentration device 45 of optical path switching destination information (step Sa1303). Thereafter, the optical path switching control unit 531 instructs the ONU 42 connected to the switching source OLT 44-2, the switching destination OLT 44-1, and the switching source OLT 44-2 to switch the optical path (step Sa1304). Thereafter, the processing from step Sa306 to step Sa317 is executed.

When the optical path switching is completed, the ONU 42 transmits an optical path switching completion notification to the switching device 43b (step Sa1305). Note that the ONU 42 may also transmit the optical path switching completion notification to the management control device 50c. When the optical path switching is completed, the switching destination OLT 44-1 transmits an optical path switching completion notification to the switching device 43b (step Sa1306). Note that the ONU 42 may also transmit the optical path switching completion notification to the management control device 50c.

When the optical path switching completion notification is received from the transmission destination of the optical path switching start notification, the sleep control unit 532 included in the switching device 43b transmits a sleep permission notification to the switching source OLT 44-2 (step Sa1307). When the sleep permission notification is obtained from the switching device 43b, the switching source OLT 44-2 transmits a sleep response notification to the switching device 43b (step Sa1308). After transmitting the sleep response notification, the switching source OLT 44-2 transitions to the sleep state (step Sa322).

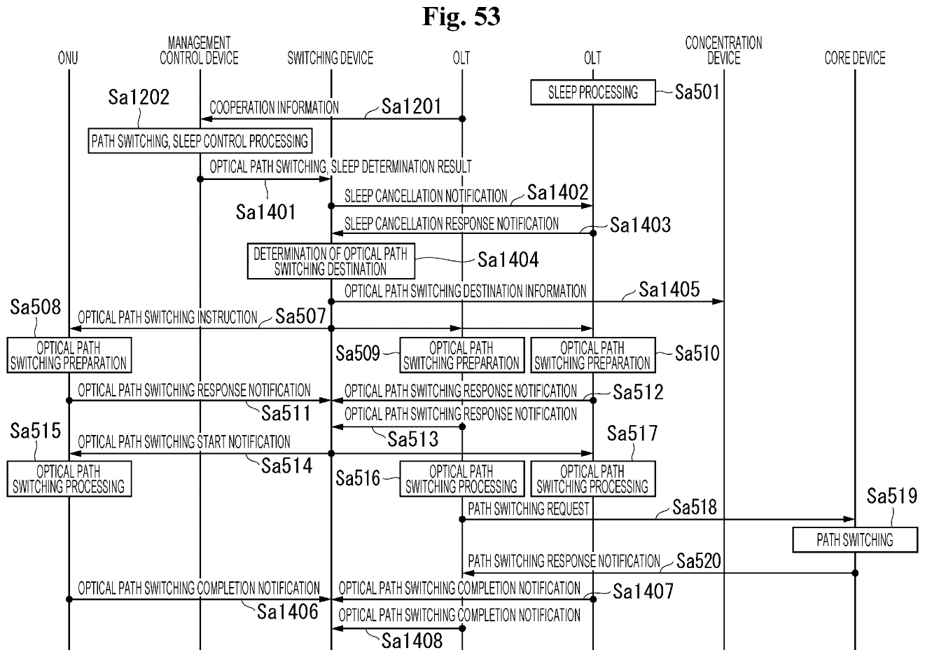

FIG. 53 is a sequence diagram illustrating an example of a detailed flow of sleep cancellation processing executed by the wired NW system 200c according to the second modification of the sixth embodiment. In FIG. 53, the same processing steps as those in FIG. 51 will be denoted by the same reference signs as those used in FIG. 51, and description thereof will be omitted. Note that, in the description of FIG. 51, it is assumed that the OLT 44-2 is in a sleep state.

After the processing of step Sa501, step Sa1201, and step Sa1202 is executed, the real-time analysis unit 522c instructs the switching device 43b to perform optical path switching control and sleep control when the sleep cancellation condition is satisfied (step Sa1401). The switching device 43b receives the instruction transmitted from the management control device 50c.

The sleep control unit 532 of the switching device 43b transmits a sleep cancellation notification to the OLT 44-2 on the basis of the information included in the received instruction (step Sa1402). In response to the reception of the sleep cancellation notification, the OLT 44-2 transmits a sleep cancellation response notification to the switching device 43b (step Sa1403).

The optical path switching control unit 531 of the switching device 43b determines the optical path switching destination from the information included in the received instruction (step Sa1404). The optical path switching control unit 531 of the switching device 43b notifies the concentration device 45 of optical path switching destination information (step Sa1405). Thereafter, the processing from step Sa507 to step Sa520 is executed.

When the optical path switching is completed, the ONU 42 transmits an optical path switching completion notification to the switching device 43b (step Sa1406). When the optical path switching is completed, the OLT 44-1 transmits an optical path switching completion notification to the switching device 43b (step Sa1407). When the optical path switching is completed, the OLT 44-2 transmits an optical path switching completion notification to the switching device 43b (step Sa1408).

### Seventh Embodiment

The seventh embodiment is different from the sixth embodiment in that processing load information (for example, information of the usage rate of the memory or information of the usage rate of the CPU for each OLT 44) and processing delay information for each OLT 44 are further included as the cooperation information. Note that the system configuration is similar to that of the sixth embodiment. In the seventh embodiment, as an example of the processing load information, information of the usage rate of the memory for each OLT 44 will be described as an example.

The management control device 50c determines optical path switching and sleep on the basis of the information of the number of terminals for each OLT 44, the information of the memory usage rate for each OLT 44, and the processing delay information for each OLT 44. For example, the monitoring unit 512c monitors each OLT 44 and measures the memory usage rate for each OLT 44. Further, the monitoring unit 512c monitors each OLT 44 and collects the processing delay information for each OLT 44. The monitoring unit 512c outputs information of the memory usage rate measured for each OLT 44 and the processing delay information for each OLT 44 to the analysis unit 52c as the cooperation information.

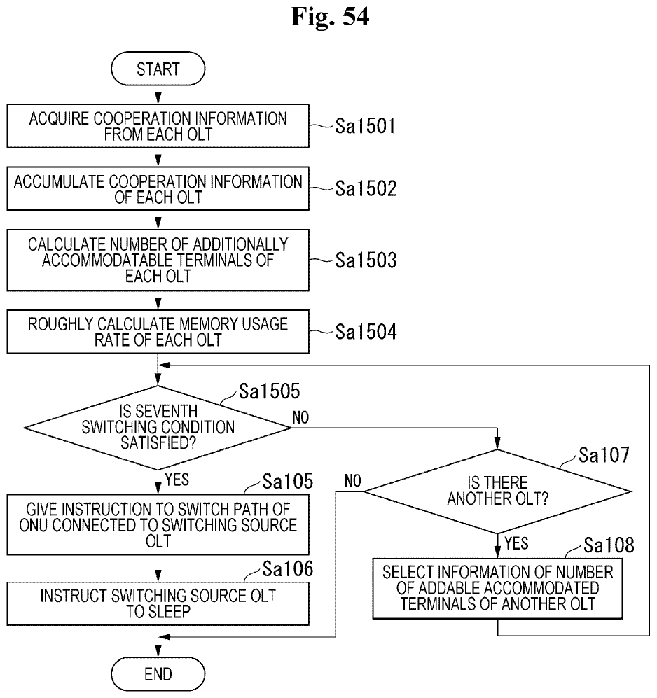

FIG. 54 is a flowchart illustrating an example of a flow of sleep processing executed by the management control device 50c according to the seventh embodiment. In FIG. 54, the same processing steps as those in FIG. 47 will be denoted by the same reference signs as those used in FIG. 47, and description thereof will be omitted.

The cooperation information collection unit 51c acquires the cooperation information from each OLT 44 (step Sa1501). Specifically, the acquisition unit 511 acquires at least information of the number of accommodated terminals, information of the maximum number of accommodated terminals, and the like as the cooperation information from each OLT 44. Further, the monitoring unit 512c measures the memory usage rate for each OLT 44 and acquires processing delay information for each OLT 44. The cooperation information collection unit 51c accumulates the acquired cooperation information of each OLT 44 in the cooperation information accumulation unit 521 (step Sa1502). Specifically, in addition to the cooperation information including at least the information of the number of accommodated terminals, the information of the maximum number of accommodated terminals, and the like from each OLT 44, the cooperation information collection unit 51c accumulates information of the memory usage rate of each OLT 44 and the processing delay information for each OLT 44 in the cooperation information accumulation unit 521 as the cooperation information.

The real-time analysis unit 522c calculates the number of additionally accommodatable terminals of each OLT 44 on the basis of the cooperation information for each OLT 44 accumulated in the cooperation information accumulation unit 521 (step Sa1503). Further, the real-time analysis unit 522c roughly calculates the memory usage rate of each OLT 44 on the basis of the cooperation information for each OLT 44 accumulated in the cooperation information accumulation unit 521 (step Sa1504).

The real-time analysis unit 522c determines whether or not a seventh switching condition is satisfied (step Sa1505). The seventh switching condition is a condition indicating that switching of the optical path between the ONU 42 and the OLT 44 is necessary, for example, that the number of additionally accommodatable terminals in a certain OLT 44 is larger than the number of accommodated terminals of the OLT 44 as a sleep determination target, the memory usage rate does not exceed 100%, and the processing delay of the OLT 44 as a sleep determination target does not exceed a threshold.

When determining that the seventh switching condition is satisfied (step Sa1505—YES), the real-time analysis unit 522c executes the processing of step Sa105 and subsequent steps. On the other hand, when determining that the seventh switching condition is not satisfied (step Sa1505—NO), the real-time analysis unit 522c executes the processing of step Sa107 and subsequent steps.

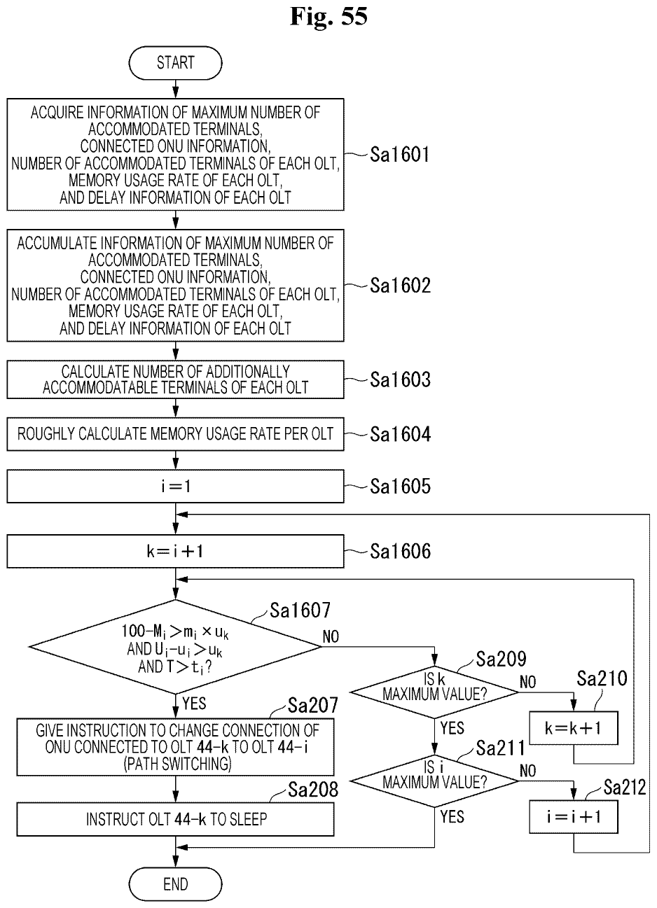

FIG. 55 is a flowchart illustrating an example of a flow of sleep processing executed by the management control device 50c according to the seventh embodiment. Note that, in the processing illustrated in FIG. 55, contents more specifically indicating the processing illustrated in FIG. 54 will be described. In FIG. 55, the same processing steps as those in FIG. 48 will be denoted by the same reference signs as those used in FIG. 48, and description thereof will be omitted.

The acquisition unit 511 acquires, from each OLT 44, the information of the maximum number of accommodated terminals, the connected ONU information, and the number of accommodated terminals of each OLT 44 as the cooperation information. Further, the monitoring unit 512c acquires information of the memory usage rate and processing delay information of each OLT 44 (step Sa1601).

The acquisition unit 511 accumulates the acquired cooperation information of each OLT 44 in the cooperation information accumulation unit 521. Further, the monitoring unit 512c accumulates the acquired information of the memory usage rate and the acquired processing delay information of each OLT 44 as the cooperation information (step Sa1602). The real-time analysis unit 522c calculates the number of additionally accommodatable terminals of each OLT 44 on the basis of the cooperation information for each OLT 44 accumulated in the cooperation information accumulation unit 521 (step Sa1603). Further, the real-time analysis unit 522c roughly calculates the memory usage rate per OLT 44 on the basis of the cooperation information for each OLT 44 accumulated in the cooperation information accumulation unit 521 (step Sa1604).

Next, the real-time analysis unit 522c substitutes a value of 1 for constant i (step Sa1605). Next, the real-time analysis unit 522c substitutes a value of (i+1) for k (step Sa1606). Thereafter, the real-time analysis unit 522c determines whether 100−Mᵢ>mᵢ×uₖ, and Uᵢ−uᵢ>uₖ, and T>tᵢ is satisfied (step Sa1607). T indicates a threshold, and tᵢ in the seventh embodiment indicates a processing delay of the OLT 44-i. The condition indicated by 100−Mᵢ>mᵢ×uₖ, and Uᵢ−uᵢ>uₖ, and T>tᵢ is a specific example of the seventh switching condition.

When determining that the seventh switching condition is satisfied (step Sa1607—YES), the real-time analysis unit 522c executes the processing of step Sa207 and subsequent steps. On the other hand, when determining that the seventh switching condition is not satisfied (step Sa1607—NO), the real-time analysis unit 522c executes the processing of step Sa209 and subsequent steps.

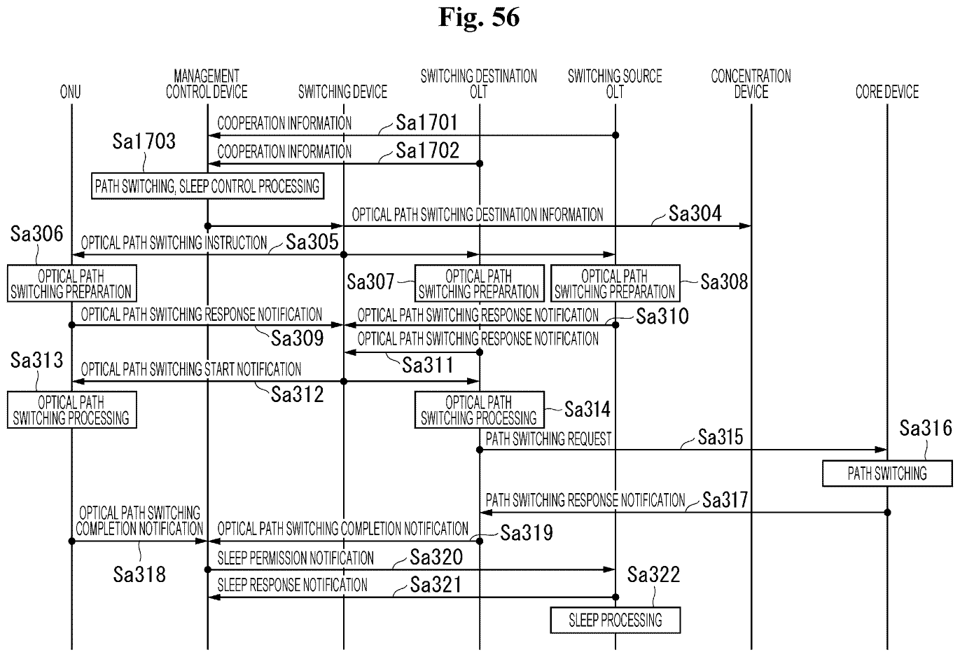

FIG. 56 is a sequence diagram illustrating an example of a detailed flow of sleep processing executed by the wired NW system 200c according to the seventh embodiment. In FIG. 56, the same processing steps as those in FIG. 49 will be denoted by the same reference signs as those used in FIG. 49, and description thereof will be omitted. Note that, in the description of FIG. 56, it is assumed that the OLT 44-1 is a switching destination OLT and the OLT 44-2 is a switching source OLT. Here, the switching destination OLT 44-1 and the switching source OLT 44-2 will be described.

The cooperation information collection unit 51c of the management control device 50c acquires the cooperation information from the switching destination OLT 44-1 and the switching source OLT 44-2 at a predetermined cycle or at an arbitrary timing (step Sa1701 and step Sa1702). Note that the cooperation information acquired in step Sa1701 and step Sa1702 includes information of the usage rate of the memory for each OLT 44 and the processing delay information for each OLT 44 in addition to at least the information of the number of accommodated terminals, information of the maximum number of accommodated terminals, and the like. The cooperation information collection unit 51c accumulates the acquired cooperation information in the cooperation information accumulation unit 521.

When the cooperation information is accumulated in the cooperation information accumulation unit 521, the real-time analysis unit 522c performs optical path switching and sleep control determination (step Sa1703). The optical path switching and the sleep control determination in step Sa1703 is a determination as to whether or not the seventh switching condition is satisfied in step Sa1505. Here, it is assumed that the seventh switching condition in step Sa1505 is satisfied. When the fifth switching condition is satisfied, the real-time analysis unit 522c executes the processing of step Sa304 and subsequent steps.

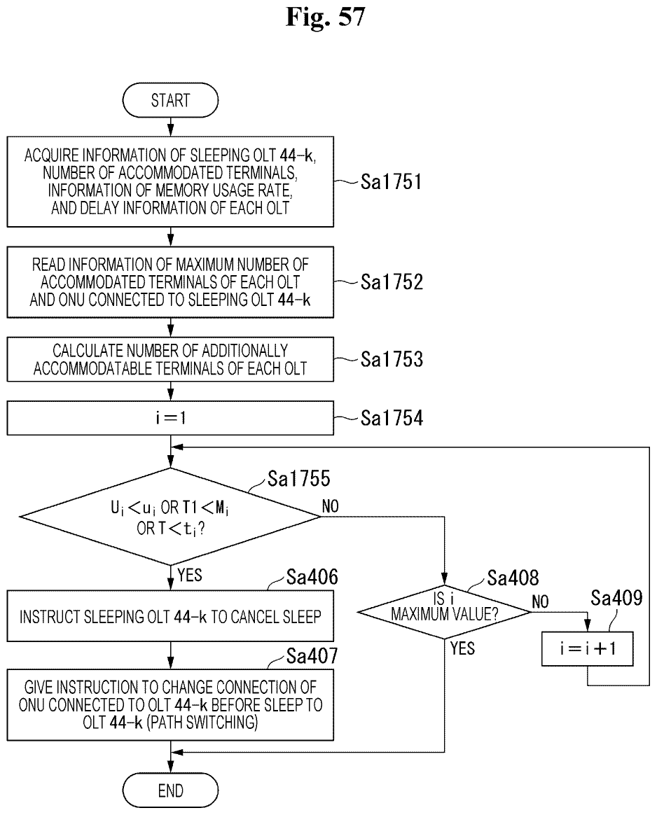

FIG. 57 is a flowchart illustrating an example of a flow of sleep cancellation processing executed by the management control device 50c according to the seventh embodiment. In FIG. 57, the same processing steps as those in FIG. 50 will be denoted by the same reference signs as those used in FIG. 50, and description thereof will be omitted.

The acquisition unit 511 acquires information of the number of accommodated terminals and the sleeping OLT 44-k from each OLT 44 as the cooperation information. Further, the monitoring unit 512c acquires information of the memory usage rate of each OLT 44 and the processing delay information for each OLT 44 as the cooperation information (step Sa1751). The acquisition unit 511 notifies the analysis unit 52c of the acquired information of the number of accommodated terminals, the sleeping OLT 44-k, the information of the memory usage rate, and the processing delay information for each OLT 44.

The real-time analysis unit 522c of the analysis unit 52c reads information of the maximum number of accommodated terminals of each OLT 44 and information of the ONU 42 connected to the sleeping OLT 44-k from the cooperation information accumulation unit 521 (step Sa1752). The real-time analysis unit 522c calculates the number of additionally accommodatable terminals of each OLT 44 on the basis of the acquired cooperation information for each OLT 44 (step Sa1753).

Next, the real-time analysis unit 522c substitutes a value of 1 for constant i (step Sa1754). The real-time analysis unit 522c determines whether either Uᵢ<uᵢ or T₁<Mᵢ or T<tᵢ is satisfied (step Sa1755). The condition indicated by Uᵢ<uᵢ or T₁<Mᵢ or T<tᵢ is a specific example of a third sleep cancellation condition. In the third sleep cancellation condition, T<tᵢ means that the processing delay of the OLT 44-i exceeds the threshold.

When determining that the third sleep cancellation condition (for example, Uᵢ<uᵢ or T₁<Mᵢ or T<tᵢ) is satisfied (step Sa1755—YES), the real-time analysis unit 522c determines that the optical path switching and the sleep cancellation of the sleeping OLT 44-k are necessary. The real-time analysis unit 522c notifies the control unit 53 of the determination result. Thereafter, the processing in step Sa406 and subsequent steps is executed. On the other hand, when determining that the third sleep cancellation condition (for example, Uᵢ<uᵢ or T₁<Mᵢ or T<tᵢ) is not satisfied (step Sa1755—NO), the real-time analysis unit 522c executes the processing of step Sa408.

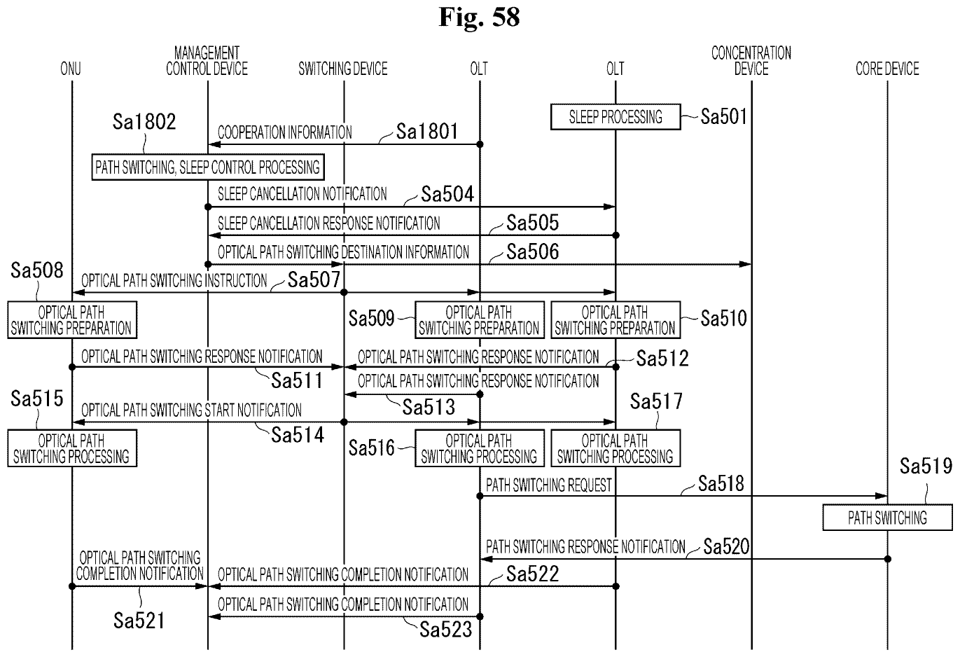

FIG. 58 is a sequence diagram illustrating an example of a detailed flow of sleep cancellation processing executed by the wired NW system 200c according to the seventh embodiment. In FIG. 58, the same processing steps as those in FIG. 51 will be denoted by the same reference signs as those used in FIG. 51, and description thereof will be omitted. Note that, in the description of FIG. 51, it is assumed that the OLT 44-2 is in a sleep state.

The OLT 44-2 is in a sleep state (step Sa501). The cooperation information collection unit 51c of the management control device 50c acquires the cooperation information from the OLT 44-1 at a predetermined cycle or at an arbitrary timing (step Sa1801). Note that the cooperation information acquired in step Sa1801 includes information of the usage rate of the memory and processing delay information for each OLT 44. The cooperation information collection unit 51c accumulates the acquired cooperation information in the cooperation information accumulation unit 521.

When the cooperation information is accumulated in the cooperation information accumulation unit 521, the real-time analysis unit 522c performs optical path switching and sleep control determination (step Sa1802). The optical path switching and the sleep control determination in step Sa1802 are whether or not the sleep cancellation condition is satisfied. Here, it is assumed that the sleep cancellation condition is satisfied. When the sleep cancellation condition is satisfied, the real-time analysis unit 522c executes the processing of step Sa504 and subsequent steps.

With the wired NW system 200c according to the seventh embodiment configured as described above, the same effects as those of the fifth embodiment can be achieved. Specifically, in the wired NW system 200c according to the seventh embodiment, the management control device 50c further acquires the information of the usage rate of the memory for each OLT 44 and the processing delay information for each OLT 44 as the cooperation information, and determines the necessity of optical path switching on the basis of the cooperation information. When it is determined that it is necessary to switch the optical path, the management control device 50c controls switching of the optical path between one or more ONUs 42 and the plurality of OLTs 44. Further, the management control device 50c causes the OLT 44 capable of sleep to transition to the sleep state after the optical path switching is performed. As a result, the optical path switching and the sleep control are performed while analyzing the load of each OLT 44. Accordingly, it is possible to increase the effect of power saving without deterioration in communication quality.

### First Modification of Seventh Embodiment

The above-described embodiment indicates the configuration in which the management control device 50c directly acquires the cooperation information from the OLT 44. The management control device 50c may acquire the cooperation information via another device (for example, a controller). In such a configuration, the wired NW system 200c newly includes a controller 60a, and the controller 60a is provided between the management control device 50c and the OLT 44.

The controller 60a acquires the cooperation information from each OLT 44 at a predetermined cycle or at an arbitrary timing. The controller 60a transmits the acquired cooperation information to the management control device 50c. Note that the controller 60a may receive a sleep control instruction from the management control device 50c and transmit the sleep control instruction to the switching source OLT.

With this configuration, the management control device 50c can collect the cooperation information by wireless communication.

### Second Modification of Seventh Embodiment

The above-described embodiment indicates the configuration in which the management control device 50c performs the optical path switching control processing and the sleep control processing. On the other hand, the switching device 43 may be configured to perform the optical path switching control processing and the sleep control processing. In such a configuration, the switching device 43 includes the control unit 53, and the management control device 50c does not include the control unit 53. The real-time analysis unit 522c of the management control device 50c notifies the switching device 43 of the analysis result. Note that the real-time analysis unit 522c may notify the switching device 43 of the analysis result only when optical path switching and sleep control are performed. The control unit 53 of the switching device 43 performs the optical path switching control processing and the sleep control processing on the basis of the analysis result notification of which has been given from the management control device 50c.

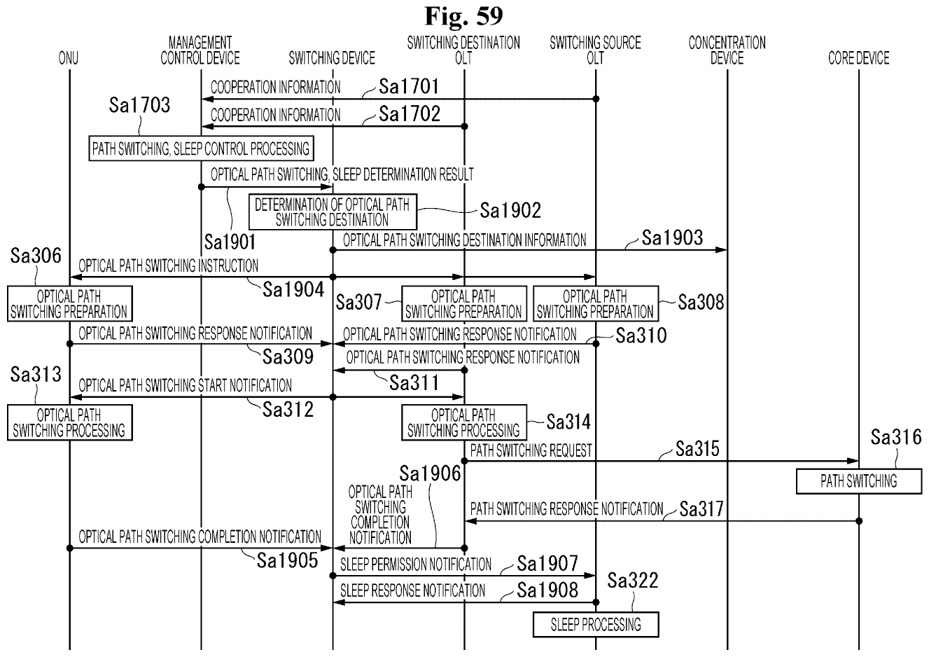

FIG. 59 is a sequence diagram illustrating an example of a detailed flow of sleep processing executed by the wired NW system 200c according to a second modification of the seventh embodiment. In FIG. 59, the same processing steps as those in FIG. 56 will be denoted by the same reference signs as those used in FIG. 56, and description thereof will be omitted.

After the processing from step Sa1701 to step Sa1703 is executed, the real-time analysis unit 522c instructs the switching device 43b to perform optical path switching control and sleep control when the seventh switching condition is satisfied (step Sa1901). The switching device 43b receives the instruction transmitted from the management control device 50c.

The optical path switching control unit 531 of the switching device 43b determines the optical path switching destination from the information included in the received instruction (step Sa1902). The optical path switching control unit 531 notifies the concentration device 45 of optical path switching destination information (step Sa1903). Thereafter, the optical path switching control unit 531 instructs the ONU 42 connected to the switching source OLT 44-2, the switching destination OLT 44-1, and the switching source OLT 44-2 to switch the optical path (step Sa1904). Thereafter, the processing from step Sa306 to step Sa317 is executed.

When the optical path switching is completed, the ONU 42 transmits an optical path switching completion notification to the switching device 43b (step Sa1905). Note that the ONU 42 may also transmit the optical path switching completion notification to the management control device 50c. When the optical path switching is completed, the switching destination OLT 44-1 transmits an optical path switching completion notification to the switching device 43b (step Sa1906). Note that the ONU 42 may also transmit the optical path switching completion notification to the management control device 50c.

When the optical path switching completion notification is received from the transmission destination of the optical path switching start notification, the sleep control unit 532 included in the switching device 43b transmits a sleep permission notification to the switching source OLT 44-2 (step Sa1907). When the sleep permission notification is obtained from the switching device 43b, the switching source OLT 44-2 transmits a sleep response notification to the switching device 43b (step Sa1908). After transmitting the sleep response notification, the switching source OLT 44-2 transitions to the sleep state (step Sa322).

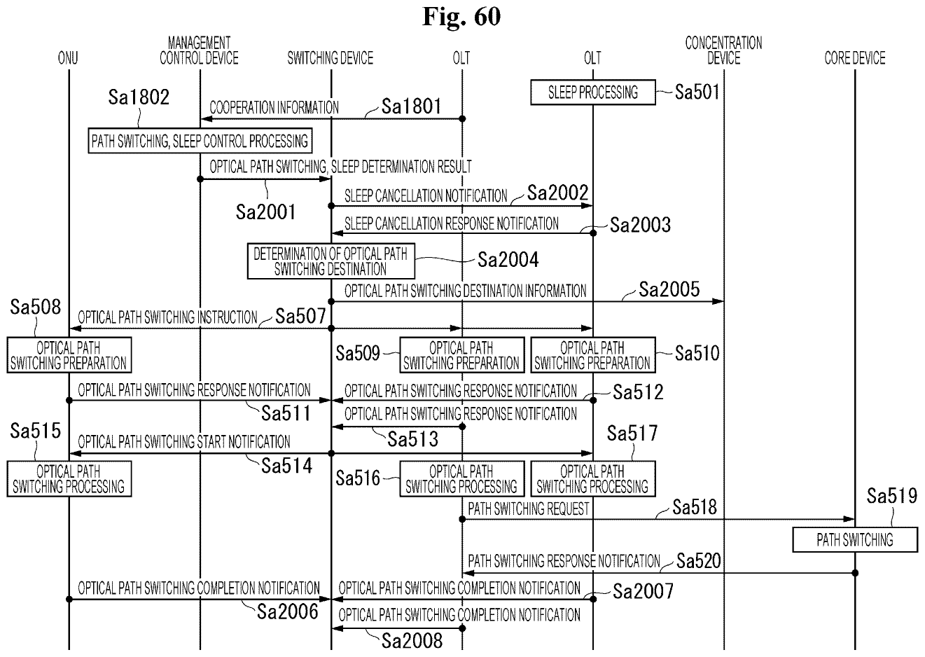

FIG. 60 is a sequence diagram illustrating an example of a detailed flow of sleep cancellation processing executed by the wired NW system 200c according to the second modification of the seventh embodiment. In FIG. 60, the same processing steps as those in FIG. 57 will be denoted by the same reference signs as those used in FIG. 57, and description thereof will be omitted.

After the processing of step Sa501, step Sa1801, and step Sa1802 is executed, the real-time analysis unit 522c instructs the switching device 43b to perform optical path switching control and sleep control when the sleep cancellation condition is satisfied (step Sa2001). The switching device 43b receives the instruction transmitted from the management control device 50c.

The sleep control unit 532 of the switching device 43b transmits a sleep cancellation notification to the OLT 44-2 on the basis of the information included in the received instruction (step Sa2002). In response to the reception of the sleep cancellation notification, the OLT 44-2 transmits a sleep cancellation response notification to the switching device 43b (step Sa2003).

The optical path switching control unit 531 of the switching device 43b determines the optical path switching destination from the information included in the received instruction (step Sa2004). The optical path switching control unit 531 of the switching device 43b notifies the concentration device 45 of optical path switching destination information (step Sa2005). Thereafter, the processing from step Sa507 to step Sa520 is executed.

When the optical path switching is completed, the ONU 42 transmits an optical path switching completion notification to the switching device 43b (step Sa2006). When the optical path switching is completed, the OLT 44-1 transmits an optical path switching completion notification to the switching device 43b (step Sa2007). When the optical path switching is completed, the OLT 44-2 transmits an optical path switching completion notification to the switching device 43b (step Sa2008).

### Eighth Embodiment

The eighth embodiment is different from the fifth embodiment in that information of a transmission delay between the terminal 41 and each OLT 44 is further included in the cooperation information.

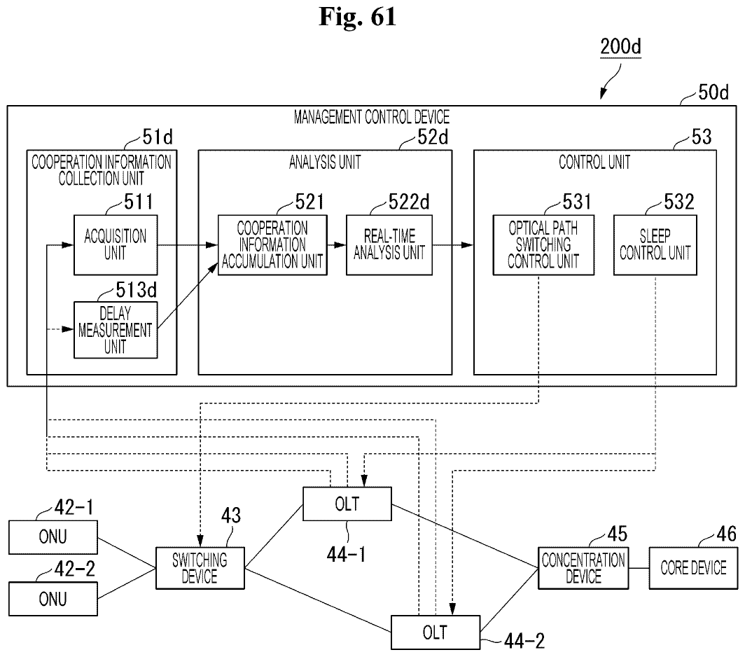

FIG. 61 is a diagram illustrating a configuration example of a wired NW system 200d according to the eighth embodiment. The wired NW system 200d in the eighth embodiment includes one or more ONUs 42, a switching device 43, a plurality of OLTs 44, a concentration device 45, a core device 46, and a management control device 50d. The management control device 50d includes a cooperation information collection unit 51d, an analysis unit 52d, and a control unit 53.

The cooperation information collection unit 51d includes an acquisition unit 511 and a delay measurement unit 513d. The delay measurement unit 513d measures a transmission delay between the terminal 41 and each OLT 44. For example, the delay measurement unit 513d measures a transmission delay between the terminal 41 and each OLT 44 on the basis of an RTT obtained as a result of ping transmission. The delay measurement unit 513d outputs information of propagation delay measured for each OLT 44 to the analysis unit 52d as the cooperation information.

The analysis unit 52d includes a cooperation information accumulation unit 521 and a real-time analysis unit 522d. The real-time analysis unit 522d analyzes a state of communication in the wired NW system 200d such as a change amount of the number of connections of the OLT 44 per unit time on the basis of the cooperation information. Specifically, the real-time analysis unit 522d roughly calculates the delay time per OLT by dividing the delay time by the current number of accommodated terminals. Further, the real-time analysis unit 522d multiplies the number of accommodated terminals of another OLT 44 by the delay time per target OLT 44, and determines optical path switching and sleep when the delay time does not exceed a threshold and the number of accommodated terminals of the OLT 44 is smaller than the number of terminals that can be additionally accommodated in the target OLT 44.

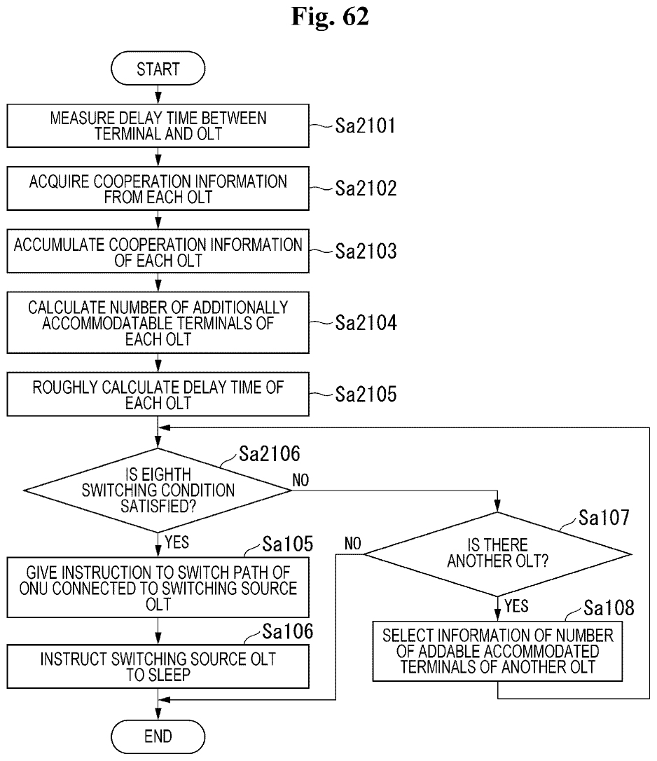

FIG. 62 is a flowchart illustrating an example of a flow of sleep processing executed by the management control device 50d according to the eighth embodiment. In FIG. 62, the same processing steps as those in FIG. 37 will be denoted by the same reference signs as those used in FIG. 37, and description thereof will be omitted.

The delay measurement unit 513d measures a transmission delay between the terminal 41 and each OLT 44 (step Sa2101). The cooperation information collection unit 51d acquires the cooperation information from each OLT 44 (step Sa2102). Specifically, the acquisition unit 511 acquires at least information of the number of accommodated terminals, information of the maximum number of accommodated terminals, and the like as the cooperation information from each OLT 44. The cooperation information collection unit 51d accumulates the acquired cooperation information of each OLT 44 in the cooperation information accumulation unit 521 (step Sa2103). Specifically, in addition to the cooperation information including at least the information of the number of accommodated terminals, the information of the maximum number of accommodated terminals, and the like from each OLT 44, the cooperation information collection unit 51d accumulates information of the transmission delay between the terminal 41 and each OLT 44 in the cooperation information accumulation unit 521 as the cooperation information.

The real-time analysis unit 522d calculates the number of additionally accommodatable terminals of each OLT 44 on the basis of the cooperation information for each OLT 44 accumulated in the cooperation information accumulation unit 521 (step Sa2104). Further, the real-time analysis unit 522d roughly calculates the delay time of each OLT 44 on the basis of the information of the transmission delay between the terminal 41 and each OLT 44 accumulated in the cooperation information accumulation unit 521 (step Sa2105).

The real-time analysis unit 522d determines whether or not an eighth switching condition is satisfied (step Sa2106). The eighth switching condition is a condition indicating that switching of the optical path between the ONU 42 and the OLT 44 is necessary, for example, that the number of additionally accommodatable terminals in a certain OLT 44 is larger than the number of accommodated terminals of the OLT 44 as a sleep determination target, and the transmission delay does not exceed the threshold.

When determining that the eighth switching condition is satisfied (step Sa2106—YES), the real-time analysis unit 522d executes the processing of step Sa105 and subsequent steps. On the other hand, when determining that the eighth switching condition is not satisfied (step Sa2106—NO), the real-time analysis unit 522d executes the processing of step Sa107 and subsequent steps.

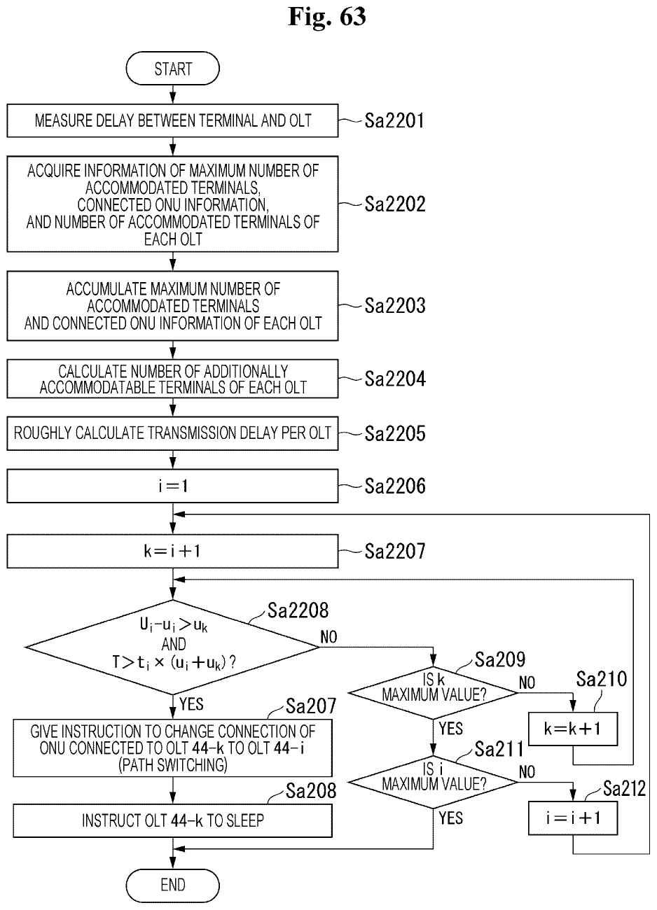

FIG. 63 is a flowchart illustrating an example of a flow of sleep processing executed by the management control device 50d according to the eighth embodiment. Note that, in the processing illustrated in FIG. 63, contents more specifically indicating the processing illustrated in FIG. 62 will be described. In FIG. 63, the same processing steps as those in FIG. 38 will be denoted by the same reference signs as those used in FIG. 38, and description thereof will be omitted.

The delay measurement unit 513d measures a transmission delay between the terminal 41 and each OLT 44 (step Sa2201). The acquisition unit 511 acquires, from each OLT 44, the information of the maximum number of accommodated terminals, the connected ONU information, and the number of accommodated terminals of each OLT 44 as the cooperation information (step Sa2202).

The acquisition unit 511 accumulates the acquired cooperation information of each OLT 44 in the cooperation information accumulation unit 521 (step Sa2203). The real-time analysis unit 522d calculates the number of additionally accommodatable terminals of each OLT 44 on the basis of the cooperation information for each OLT 44 accumulated in the cooperation information accumulation unit 521 (step Sa2204). Further, the real-time analysis unit 522d roughly calculates the transmission delay per OLT 44 on the basis of the information of the measured transmission delay between the terminal 41 and each OLT 44 (step Sa2205).

Specifically, the real-time analysis unit 522d roughly calculates a transmission delay tᵢ per OLT 44-i by dividing a value tᵢ of the transmission delay of the OLT 44-i obtained in the processing of step Sa2201 by the number of accommodated terminals Uᵢ of the OLT 44-i (tᵢ/uᵢ). Next, the real-time analysis unit 522d substitutes a value of 1 for constant i (step Sa2206). Next, the real-time analysis unit 522d substitutes a value of (i+1) for k (step Sa2207).

Thereafter, the real-time analysis unit 522d determines whether Uᵢ−uᵢ>uₖ and T>tᵢ×(Uᵢ+uₖ) is satisfied (step Sa2208). In the eighth embodiment, tᵢ indicates the transmission delay tᵢ per OLT 44-i. The condition indicated by Uᵢ−uᵢ>uₖ and T>tᵢ×(uᵢ+uₖ) is a specific example of the eighth switching condition. When determining that the eighth switching condition is satisfied (step Sa2208—YES), the real-time analysis unit 522d executes the processing of step Sa207 and subsequent steps. On the other hand, when determining that the eighth switching condition is not satisfied (step Sa2208—NO), the real-time analysis unit 522d executes the processing of step Sa209 and subsequent steps.

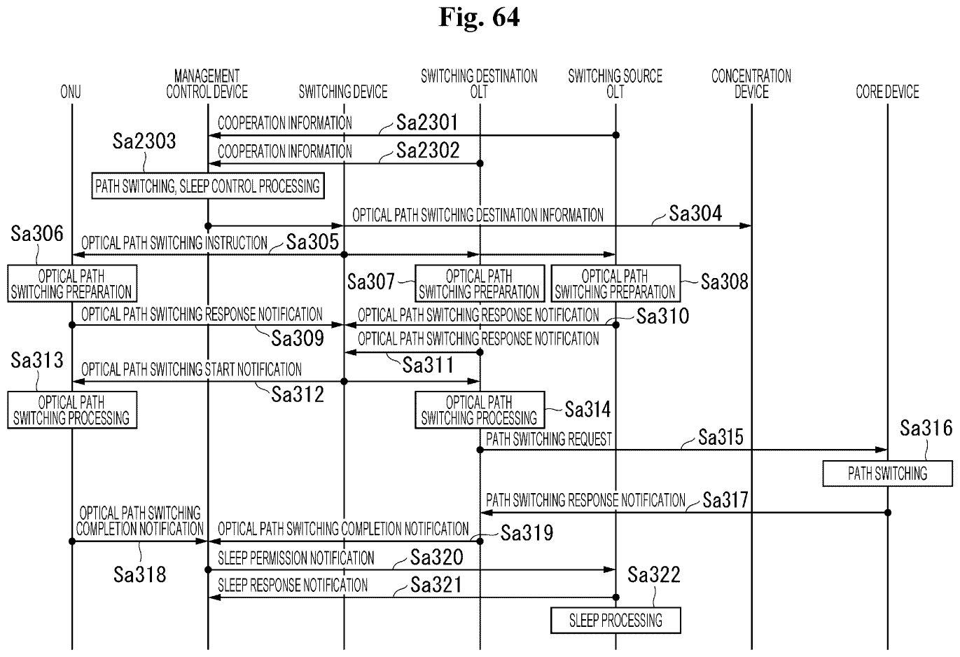

FIG. 64 is a sequence diagram illustrating an example of a detailed flow of sleep processing executed by the wired NW system 200d according to the eighth embodiment. In FIG. 64, the same processing steps as those in FIG. 39 will be denoted by the same reference signs as those used in FIG. 39, and description thereof will be omitted. Note that, in the description of FIG. 64, it is assumed that the OLT 44-1 is a switching destination OLT and the OLT 44-2 is a switching source OLT. Here, the switching destination OLT 44-1 and the switching source OLT 44-2 will be described.

The cooperation information collection unit 51d of the management control device 50d acquires the cooperation information from the switching destination OLT 44-1 and the switching source OLT 44-2 at a predetermined cycle or at an arbitrary timing (step Sa2301 and step Sa2302). Note that the cooperation information acquired in step Sa2301 and step Sa2302 includes information of the transmission delay between the terminal 41 and each OLT 44 in addition to at least the information of the number of accommodated terminals, information of the maximum number of accommodated terminals, and the like. The cooperation information collection unit 51d accumulates the acquired cooperation information in the cooperation information accumulation unit 521.

When the cooperation information is accumulated in the cooperation information accumulation unit 521, the real-time analysis unit 522d performs optical path switching and sleep control determination (step Sa2303). The optical path switching and the sleep control determination in step Sa2303 is a determination as to whether or not the eighth switching condition is satisfied in step Sa2106. Here, it is assumed that the eighth switching condition in step Sa2106 is satisfied. When the eighth switching condition is satisfied, the real-time analysis unit 522d executes the processing of step Sa304 and subsequent steps.

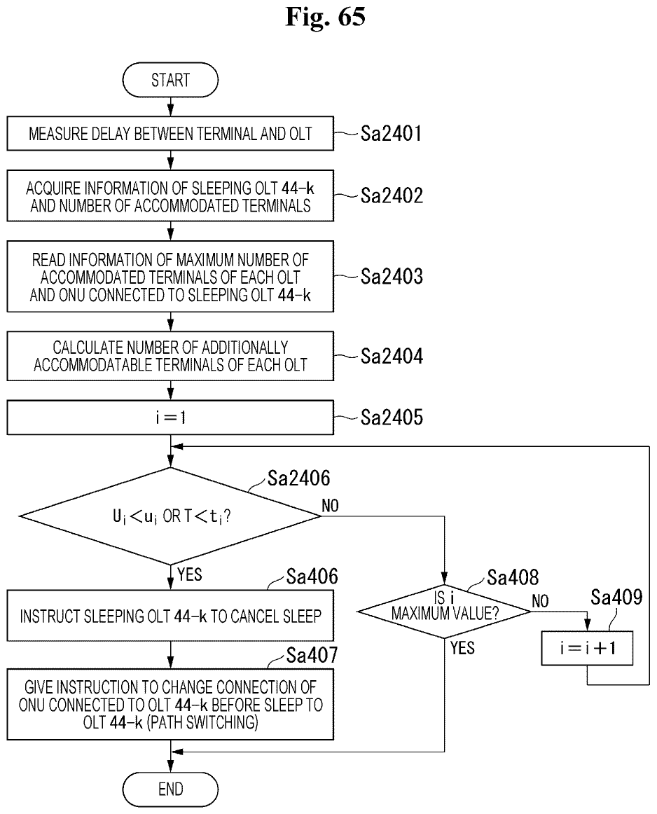

FIG. 65 is a flowchart illustrating an example of a flow of sleep cancellation processing executed by the management control device 50d according to the eighth embodiment. In FIG. 65, the same processing steps as those in FIG. 40 will be denoted by the same reference signs as those used in FIG. 40, and description thereof will be omitted.

The delay measurement unit 513d measures a transmission delay between the terminal 41 and each OLT 44 (step Sa2401). The acquisition unit 511 acquires information of the number of accommodated terminals and the sleeping OLT 44-k from each OLT 44 as the cooperation information (step Sa2402). The acquisition unit 511 notifies the analysis unit 52d of the acquired information of the number of accommodated terminals, the sleeping OLT 44-k, and the information of the transmission delay.

The real-time analysis unit 522d of the analysis unit 52d reads information of the maximum number of accommodated terminals of each OLT 44 and information of the ONU 42 connected to the sleeping OLT 44-k from the cooperation information accumulation unit 521 (step Sa2403). The real-time analysis unit 522d calculates the number of additionally accommodatable terminals of each OLT 44 on the basis of the acquired cooperation information for each OLT 44 (step Sa2404).

Next, the real-time analysis unit 522d substitutes a value of 1 for constant i (step Sa2405). The real-time analysis unit 522d determines whether either Uᵢ<uᵢ or T<tᵢ is satisfied (step Sa2406). The condition indicated by Uᵢ<uᵢ or T<tᵢ is a specific example of a fourth sleep cancellation condition. In the fourth sleep cancellation condition, T<tᵢ means that the transmission delay between the terminal 41 and the OLT 44-i exceeds the threshold. That is, it means that the transmission delay tᵢ per OLT 44-i exceeds the threshold.

When determining that the fourth sleep cancellation condition (for example, Uᵢ<uᵢ or T<tᵢ) is satisfied (step Sa2406—YES), the real-time analysis unit 522d determines that the optical path switching and the sleep cancellation of the sleeping OLT 44-k are necessary.

The real-time analysis unit 522d notifies the control unit 53 of the determination result. Thereafter, the processing in step Sa406 and subsequent steps is executed. On the other hand, when determining that the fourth sleep cancellation condition (for example, Uᵢ<uᵢ or T<tᵢ) is not satisfied (step Sa2406—NO), the real-time analysis unit 522d executes the processing of step Sa408.

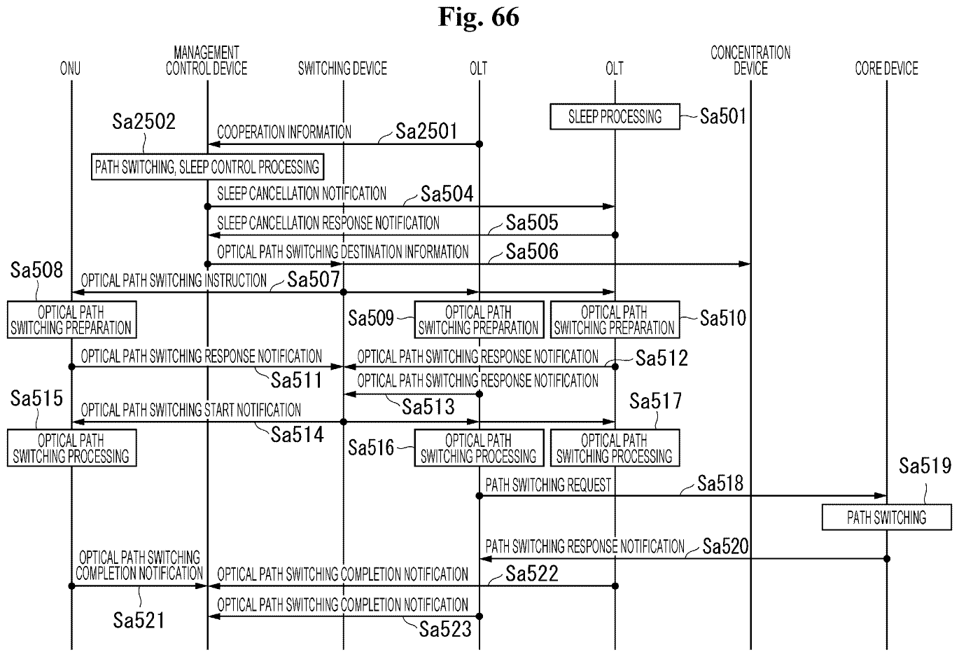

FIG. 66 is a sequence diagram illustrating an example of a detailed flow of sleep cancellation processing executed by the wired NW system 200d according to the eighth embodiment. In FIG. 66, the same processing steps as those in FIG. 41 will be denoted by the same reference signs as those used in FIG. 41, and description thereof will be omitted. Note that, in the description of FIG. 66, it is assumed that the OLT 44-2 is in a sleep state.

The OLT 44-2 is in a sleep state (step Sa501). The cooperation information collection unit 51d of the management control device 50d acquires the cooperation information from the OLT 44-1 at a predetermined cycle or at an arbitrary timing (step Sa2501). Note that the cooperation information acquired in step Sa2501 includes information of the transmission delay between the terminal 41 and each OLT 44 in addition to at least the information of the number of accommodated terminals, information of the maximum number of accommodated terminals, and the like. The cooperation information collection unit 51d accumulates the acquired cooperation information in the cooperation information accumulation unit 521.

When the cooperation information is accumulated in the cooperation information accumulation unit 521, the real-time analysis unit 522d performs optical path switching and sleep control determination (step Sa2502). The optical path switching and the sleep control determination in step Sa2502 are whether or not the sleep cancellation condition is satisfied. Here, it is assumed that the sleep cancellation condition is satisfied. When the sleep cancellation condition is satisfied, the real-time analysis unit 522d executes the processing of step Sa504 and subsequent steps.

With the wired NW system 200d configured as described above, effects similar to those of the fifth embodiment can be obtained. Specifically, in the wired NW system 200d, the management control device 50d further acquires the information of the transmission delay between the terminal 41 and each OLT 44 as the cooperation information, and determines the necessity of optical path switching on the basis of the cooperation information. When it is determined that it is necessary to switch the optical path, the management control device 50d controls switching of the optical path between one or more ONUs 42 and the plurality of OLTs 44. Further, the management control device 50d causes the OLT 44 capable of sleep to transition to the sleep state after the optical path switching is performed. As a result, the optical path switching and the sleep control are performed while analyzing the load of each OLT 44. Accordingly, power saving can be efficiently achieved as the entire system.

### First Modification of Eighth Embodiment

The above-described embodiment indicates the configuration in which the management control device 50d directly acquires the cooperation information from the OLT 44. The management control device 50d may acquire the cooperation information via another device (for example, a controller). In such a configuration, the wired NW system 200d newly includes a controller 60a, and the controller 60a is provided between the management control device 50d and the OLT 44.

The controller 60a acquires the cooperation information from each OLT 44 at a predetermined cycle or at an arbitrary timing. The controller 60a transmits the acquired cooperation information to the management control device 50d. Note that the controller 60a may receive a sleep control instruction from the management control device 50d and transmit the sleep control instruction to the switching source OLT.

With this configuration, the management control device 50d can collect the cooperation information by wireless communication.

### Second Modification of Eighth Embodiment

The above-described embodiment indicates the configuration in which the management control device 50d performs the optical path switching control processing and the sleep control processing. On the other hand, the switching device 43 may be configured to perform the optical path switching control processing and the sleep control processing. In such a configuration, the switching device 43 includes the control unit 53, and the management control device 50d does not include the control unit 53. The real-time analysis unit 522d of the management control device 50d notifies the switching device 43 of the analysis result. Note that the real-time analysis unit 522d may notify the switching device 43 of the analysis result only when optical path switching and sleep control are performed. The control unit 53 of the switching device 43 performs the optical path switching control processing and the sleep control processing on the basis of the analysis result notification of which has been given from the management control device 50d.

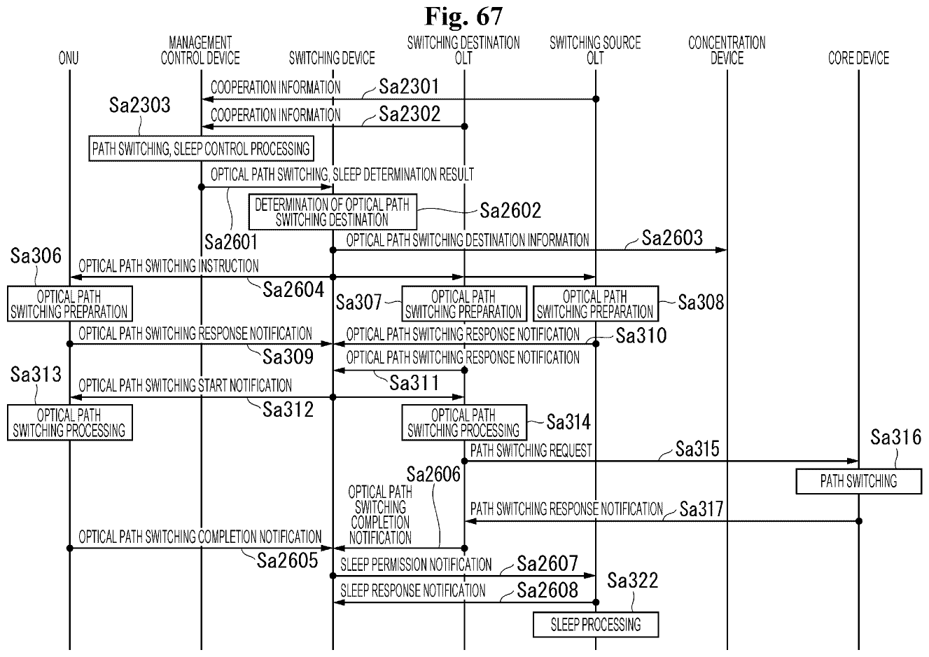

FIG. 67 is a sequence diagram illustrating an example of a detailed flow of sleep processing executed by the wired NW system 200d according to a second modification of the eighth embodiment. In FIG. 67, the same processing steps as those in FIG. 64 will be denoted by the same reference signs as those used in FIG. 64, and description thereof will be omitted.

After the processing from step Sa2301 to step Sa2303 is executed, the real-time analysis unit 522d instructs the switching device 43 to perform optical path switching control and sleep control when the eighth switching condition is satisfied (step Sa2601). The switching device 43 receives the instruction transmitted from the management control device 50d.

The optical path switching control unit 531 of the switching device 43 determines the optical path switching destination from the information included in the received instruction (step Sa2602). The optical path switching control unit 531 notifies the concentration device 45 of optical path switching destination information (step Sa2603). Thereafter, the optical path switching control unit 531 instructs the ONU 42 connected to the switching source OLT 44-2, the switching destination OLT 44-1, and the switching source OLT 44-2 to switch the optical path (step Sa2604). Thereafter, the processing from step Sa306 to step Sa317 is executed.

When the optical path switching is completed, the ONU 42 transmits an optical path switching completion notification to the switching device 43 (step Sa2605). Note that the ONU 42 may also transmit the optical path switching completion notification to the management control device 50d. When the optical path switching is completed, the switching destination OLT 44-1 transmits an optical path switching completion notification to the switching device 43 (step Sa2606). Note that the ONU 42 may also transmit the optical path switching completion notification to the management control device 50d.

When the optical path switching completion notification is received from the transmission destination of the optical path switching start notification, the sleep control unit 532 included in the switching device 43 transmits a sleep permission notification to the switching source OLT 44-2 (step Sa2607). When the sleep permission notification is obtained from the switching device 43, the switching source OLT 44-2 transmits a sleep response notification to the switching device 43 (step Sa2608). After transmitting the sleep response notification, the switching source OLT 44-2 transitions to the sleep state (step Sa322).

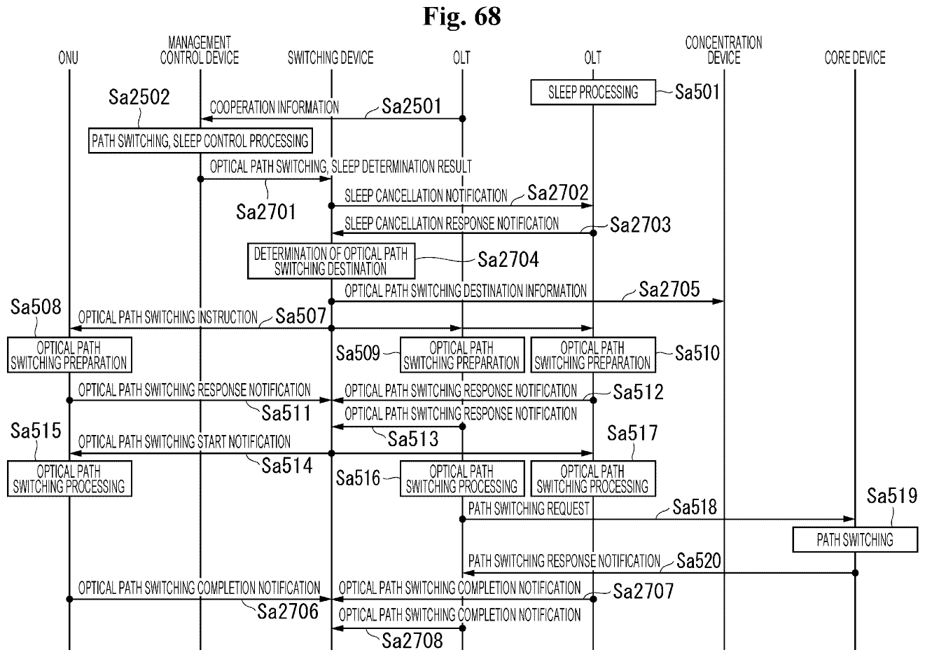

FIG. 68 is a sequence diagram illustrating an example of a detailed flow of sleep cancellation processing executed by the wired NW system 200d according to the second modification of the eighth embodiment. In FIG. 68, the same processing steps as those in FIG. 65 will be denoted by the same reference signs as those used in FIG. 65, and description thereof will be omitted. Note that, in the description of FIG. 65, it is assumed that the OLT 44-2 is in a sleep state.

After the processing of step Sa501, step Sa2501, and step Sa2502 is executed, the real-time analysis unit 522d instructs the switching device 43 to perform optical path switching control and sleep control when the sleep cancellation condition is satisfied (step Sa2701). The switching device 43 receives the instruction transmitted from the management control device 50d.

The sleep control unit 532 of the switching device 43 transmits a sleep cancellation notification to the OLT 44-2 on the basis of the information included in the received instruction (step Sa2702). In response to the reception of the sleep cancellation notification, the OLT 44-2 transmits a sleep cancellation response notification to the switching device 43 (step Sa2703).

The optical path switching control unit 531 of the switching device 43 determines the optical path switching destination from the information included in the received instruction (step Sa2704). The optical path switching control unit 531 of the switching device 43 notifies the concentration device 45 of optical path switching destination information (step Sa2705). Thereafter, the processing from step Sa507 to step Sa520 is executed.

When the optical path switching is completed, the ONU 42 transmits an optical path switching completion notification to the switching device 43 (step Sa2706). When the optical path switching is completed, the OLT 44-1 transmits an optical path switching completion notification to the switching device 43 (step Sa2707). When the optical path switching is completed, the OLT 44-2 transmits an optical path switching completion notification to the switching device 43 (step Sa2708).

### First Modification Common to Fifth to Eighth Embodiments

The wired NW systems 200, 200a, 200c, and 200d may not include the switching device 13. In such a configuration, each ONU 42 and each OLT 44 are connected in advance in a full-mesh network form. Further, when switching the optical path, the optical path switching control unit 531 instructs the ONU 42 and the OLT 44, which are optical path switching targets, to switch the optical path. For example, the optical path switching control unit 531 transmits an optical path switching instruction (for example, the processing of step Sa305 in FIG. 39) to the ONU 42, which is an optical path switching target, and the OLT 44, which is an optical path switching target. Then, the optical path switching control unit 531 transmits an optical path switching start notification (for example, the processing of step Sa312 in FIG. 39) to the ONU 42, which is an optical path switching target, and the OLT 44, which is an optical path switching target, after an optical path switching response notification is obtained from the ONU 42, which is an optical path switching target, and the OLT 44, which is an optical path switching target.

### Second Modification Common to Fifth to Eighth Embodiments

The fifth to eighth embodiments indicate the configuration in which the switching source OLT transitions to the sleep state as triggered by a sleep instruction given from the management control devices 50, 50c, and 50d to the switching source OLT. The switching source OLT may be configured to autonomously transition to the sleep state regardless of the sleep instruction from the management control devices 50, 50c, and 50d. With such a configuration, the switching source OLT autonomously transitions to the sleep state when an autonomous sleep condition is satisfied. The autonomous sleep condition according to the second modification common to the fifth to eighth embodiments is a condition for the switching source OLT to autonomously transition to the sleep state, and is, for example, that there is no ONU 42 connected to the switching source OLT (ONU 42 connected to the switching source OLT is zero) or that there is no traffic inflow for a certain time ΔT. In such a configuration, the switching source OLT includes the sleep control unit. The sleep control unit included in the switching source OLT causes the switching source OLT to transition to the sleep state when the autonomous sleep condition is satisfied. Note that this configuration is also applicable to a case where the switching device 43b includes the control unit 53.

### Third Modification Common to Fifth to Eighth Embodiments

In addition to the number of accommodated terminals, the number of terminals of each OLT 44, the number of terminals of each ONU 42, an actual traffic amount, and a value obtained by multiplying the number of accommodated terminals by an average throughput of one terminal can be used as the information collected by the management control devices 50, 50c, and 50d.

### Fourth Modification Common to Fifth to Eighth Embodiments

Each embodiment indicated in the fifth to eighth embodiments indicates the configuration in which the OLT 44 (for example, the switching source OLT) that is a sleep target is caused to sleep after the optical path switching is completed in FIGS. 37, 38, 39, 44, 47, 48, 49, 52, 54, 55, 56, 59, 62, 63, 64, and 67. Specifically, the configuration has been indicated in which the management control devices 50, 50b, 50c, and 50d cause the OLT 44 (for example, the switching source OLT) that is a sleep target to sleep after the optical path switching is completed (for example, after receiving the optical path switching completion notification).

On the other hand, they may be configured such that after the OLT 44 (for example, the switching source OLT) that is a sleep target is caused to sleep, the optical path switching is performed in FIGS. 37, 38, 39, 44, 47, 48, 49, 52, 54, 55, 56, 59, 62, 63, 64, and 67. In the case of such a configuration, the management control devices 50, 50b, 50c, and 50d cause the OLT 44 (for example, the switching source OLT) that is a sleep target to sleep and then executes the optical path switching. For example, the management control devices 50, 50b, 50c, and 50d cause the OLT 44 (for example, the switching source OLT) that is a sleep target to sleep and then executes the optical path switching by transmitting the optical path switching start notification to the target device. Here, the time after the OLT 44 (for example, the switching source OLT) that is a sleep target is caused to sleep may be after the management control devices 50, 50b, 50c, and 50d receive a sleep response notification from the OLT 44 (for example, the switching source OLT) that is a sleep target, or may be after transmission of a sleep permission notification to the OLT 44 (for example, the switching source OLT) that is a sleep target.

Some or all of the functional units of at least the management control devices 20, 20b, 20c, 20d, 50, 50b, 50c, and 50d or some or all of the functional units of the switching devices 13, 13b, 43, and 43b are implemented as software by a processor such as a central processing unit (CPU) executing a program stored in a storage device including a nonvolatile recording medium (non-transitory recording medium) and a storage unit. The program may be recorded in a computer-readable non-transitory recording medium. The computer-readable non-transitory recording medium is, for example, a portable medium such as a flexible disk, a magneto-optical disk, a read only memory (ROM), or a compact disc read only memory (CD-ROM), or a non-transitory recording medium such as a storage device such as a hard disk built in a computer system.

Some or all of the functional units of at least the management control devices 20, 20b, 20c, 20d, 50, 50b, 50c, and 50d or some or all of the functional units of the switching devices 13, 13b, 43, and 43b may be implemented by using hardware including an electronic circuit (electronic circuit or circuitry) using, for example, a large scale integrated circuit (LSI), an application specific integrated circuit (ASIC), a programmable logic device (PLD), a field programmable gate array (FPGA), or the like.

Although the embodiments of this invention have been described in detail with reference to the drawings, specific configurations are not limited to the embodiments and include design and the like within the scope without departing from the gist of this invention.

### INDUSTRIAL APPLICABILITY

The present invention can be applied to optical communication systems such as an optical access system.

### REFERENCE SIGNS LIST

11 Terminal
12, 12-1 to 12-4 Radio station
13, 13b, 43, 43b Switching device
14, 14-1 to 14-2 Distributed station
15 Aggregation station
16, 46 Core device
20, 20b, 20c, 20d, 50, 50b, 50c, 50d Management control device
21, 21c, 21d, 51, 51c, 51d Cooperation information collection unit
22, 52 Analysis unit
23, 53 Control unit
30a Wireless controller
42, 42-1 to 42-4 ONU
44, 44-1 to 44-2 OLT
45 Concentration device
60a Controller
100, 100a, 100b, 100c, 100d Mobile NW system
200, 200a, 200b, 200c, 200d Wired NW system
211, 511 Acquisition unit
212c Distributed station monitoring unit
512c Monitoring unit
213d, 513d Delay measurement unit
221, 521 Cooperation information accumulation unit
222, 522 Real-time analysis unit
231, 531 Optical path switching control unit
232, 532 Sleep control unit

1. A communication system comprising:
one or more terminal accommodation stations configured to perform communication with one or more terminals;
a plurality of communication stations that is connected to the one or more terminal accommodation stations directly or via another device;
a cooperation information collector configured to acquire cooperation information indicating a state of communication between the communication station and the one or more terminals, from the communication station;
an optical path switching controller configured to control switching of an optical path between the one or more terminal accommodation stations and the plurality of communication stations in a case where it is determined that switching of the optical path between the one or more terminal accommodation stations and the plurality of communication stations is necessary on a basis of the cooperation information; and
a sleep controller configured to cause a communication station capable of sleep to transition to a sleep state before the switching of the optical path is performed or after the switching is performed.

2. The communication system according to claim 1, wherein the one or more terminal accommodation stations are optical network units configured to terminate an optical signal,
the plurality of communication stations is optical line terminals that terminate an optical signal, and
the one or more terminals and the one or more terminal accommodation stations are connected by wire.

3. The communication system according to claim 1, wherein
the another device is a switching device configured to switch the optical path between the one or more terminal accommodation stations and the plurality of communication stations,
in a case where the switching device is provided, the optical path switching controller instructs the switching device to switch the optical path between the one or more terminal accommodation stations and the plurality of communication stations when it is determined that it is necessary to switch the optical path between the one or more terminal accommodation stations and the plurality of communication stations on a basis of the cooperation information, and
the switching device switches a communication station to which the one or more terminal accommodation stations are connected by switching the optical path in accordance with an instruction from the optical path switching controller.

4. The communication system according to claim 1, wherein
the another device is a switching device configured to switch the optical path between the one or more terminal accommodation stations and the plurality of communication stations,
in a case where the switching device is provided, the switching device includes the optical path switching controller and the sleep controller, and
the optical path switching controller receives, from outside, a notification indicating that switching of the optical path between the one or more terminal accommodation stations and the plurality of communication stations is necessary, and controls the switching of the optical path between the one or more terminal accommodation stations and the plurality of communication stations in accordance with the received notification.

5. The communication system according to claim 1, wherein
the cooperation information includes at least information of a number of accommodated terminals of each communication station and information of a maximum number of accommodated terminals of each communication station,
the communication system further comprises:
an analyzer configured to determine that switching of the optical path between the one or more terminal accommodation stations and the plurality of communication stations is necessary in a case where all terminals accommodated in a communication station that is a sleep determination target can be accommodated in another communication station on a basis of the information of the number of accommodated terminals of each communication station and the information of the maximum number of accommodated terminals of each communication station,
the optical path switching controller controls switching of an optical path so as to connect a terminal accommodation station connected to the communication station that is the sleep determination target to the another communication station, and
the sleep controller causes the communication station that is the sleep determination target to transition to a sleep state as a communication station capable of the sleep.

6. The communication system according to claim 5, wherein
the cooperation information further includes at least one of processing load information related to a processing load of each communication station or information of a transmission delay between the one or more terminals and the plurality of communication stations, and
the analyzer determines that switching of the optical path between the one or more terminal accommodation stations and the plurality of communication stations is necessary when all terminals accommodated in the communication station that is the sleep determination target can be accommodated in another communication station on a basis of the information of the number of accommodated terminals of each communication station, the information of the maximum number of accommodated terminals of each communication station, and the processing load information, or the information of the transmission delay.

7. A management control device comprising:
a cooperation information collector configured to acquire cooperation information indicating a state of communication between a communication station connected, directly or via another device, to one or more terminal accommodation stations that perform communication with one or more terminals and the one or more terminals, from the communication station;
an analyzer configured to determine necessity of switching of an optical path between the one or more terminal accommodation stations and a plurality of communication stations and sleep control on a basis of the cooperation information;
an optical path switching controller configured to control switching of the optical path between the one or more terminal accommodation stations and the plurality of communication stations in a case where it is determined that switching of the optical path between the one or more terminal accommodation stations and the plurality of communication stations is necessary; and
a sleep controller configured to cause a communication station capable of sleep to transition to a sleep state before the switching of the optical path is performed or after the switching is performed.

8. A communication station connected to a terminal accommodation station that communicates with a terminal, the communication station comprising:
a transmitter configured to transmit cooperation information indicating a state of communication with the terminal to a management control device;
a receiver configured to receive an optical path switching instruction indicating that the management control device determines that it is necessary to switch an optical path between the terminal accommodation station and the communication station on a basis of the cooperation information; and
a sleep processor configured to transition to a sleep state before the switching of the optical path is performed or after the switching is performed on a basis of the optical path switching instruction.

9. A control method comprising:
acquiring cooperation information indicating a state of communication between a communication station connected, directly or via another device, to one or more terminal accommodation stations that perform communication with one or more terminals and the one or more terminals, from the communication station;
controlling switching of an optical path between the one or more terminal accommodation stations and a plurality of communication stations in a case where it is determined that switching of the optical path between the one or more terminal accommodation stations and the plurality of communication stations is necessary on a basis of the cooperation information; and
causing a communication station capable of sleep to transition to a sleep state before the switching of the optical path is performed or after the switching is performed.

10. A communication system comprising:
one or more terminal accommodation stations configured to perform communication with one or more terminals;
a plurality of communication stations that is connected to the one or more terminal accommodation stations directly or via another device;
a cooperation information collector configured to acquire cooperation information indicating a state of communication between the communication station and the one or more terminals, from the communication station;
an optical path switching controller configured to control switching of an optical path between the one or more terminal accommodation stations and the plurality of communication stations in a case where it is determined that switching of the optical path between the one or more terminal accommodation stations and the plurality of communication stations is necessary on a basis of the cooperation information; and
a sleep controller configured to cause a communication station capable of sleep to transition to a sleep state before the switching of the optical path is performed.

11. A communication system comprising:
one or more terminal accommodation stations configured to perform communication with one or more terminals;
a plurality of communication stations that is connected to the one or more terminal accommodation stations directly or via another device;
a cooperation information collector configured to acquire cooperation information indicating a state of communication between the communication station and the one or more terminals, from the communication station, the cooperation information including any of information regarding a processing load of the communication station, information regarding a processing delay of the communication station, and information regarding a transmission delay between the communication station and the one or more terminals;
an optical path switching controller configured to control switching of an optical path between the one or more terminal accommodation stations and the plurality of communication stations in a case where it is determined that switching of the optical path between the one or more terminal accommodation stations and the plurality of communication stations is necessary on a basis of the cooperation information; and
a sleep controller configured to cause a communication station capable of sleep to transition to a sleep state before the switching of the optical path is performed or after the switching is performed.

12. A communication system comprising:
one or more terminal accommodation stations configured to perform communication with one or more terminals;
a plurality of communication stations that is connected to the one or more terminal accommodation stations directly or via another device;
a cooperation information collector configured to acquire cooperation information indicating a state of communication between the communication station and the one or more terminals, from the communication station;
an optical path switching controller configured to control switching of an optical path between the one or more terminal accommodation stations and the plurality of communication stations in a case where all terminals accommodated in a communication station that is a sleep target among the plurality of communication stations can be accommodated in another communication station on a basis of the cooperation information; and
a sleep controller configured to cause the communication station that is the sleep target to transition to a sleep state before the switching of the optical path is performed or after the switching is performed.

13. A management control device comprising:
a cooperation information collector configured to acquire cooperation information indicating a state of communication between a communication station connected, directly or via another device, to one or more terminal accommodation stations that perform communication with one or more terminals and the one or more terminals, from the communication station;
an analyzer configured to determine necessity of switching of an optical path between the one or more terminal accommodation stations and a plurality of communication stations and sleep control on a basis of the cooperation information;
an optical path switching controller configured to control switching of the optical path between the one or more terminal accommodation stations and the plurality of communication stations in a case where it is determined that switching of the optical path between the one or more terminal accommodation stations and the plurality of communication stations is necessary; and
a sleep controller configured to cause a communication station capable of sleep to transition to a sleep state before the switching of the optical path is performed.

14. A management control device comprising:
a cooperation information collector configured to acquire cooperation information indicating a state of communication between a communication station connected, directly or via another device, to one or more terminal accommodation stations that perform communication with one or more terminals and the one or more terminals, from the communication station, the cooperation information including any of information regarding a processing load of the communication station, information regarding a processing delay of the communication station, and information regarding a transmission delay between the communication station and the one or more terminals;
an analyzer configured to determine necessity of switching of an optical path between the one or more terminal accommodation stations and a plurality of communication stations and sleep control on a basis of the cooperation information;
an optical path switching controller configured to control switching of the optical path between the one or more terminal accommodation stations and the plurality of communication stations in a case where it is determined that switching of the optical path between the one or more terminal accommodation stations and the plurality of communication stations is necessary; and
a sleep controller configured to cause a communication station capable of sleep to transition to a sleep state before the switching of the optical path is performed or after the switching is performed.

15. A management control device comprising:
a cooperation information collector configured to acquire cooperation information indicating a state of communication between a communication station connected, directly or via another device, to one or more terminal accommodation stations that perform communication with one or more terminals and the one or more terminals, from the communication station;
an analyzer configured to determine that switching of an optical path between the one or more terminal accommodation stations and a plurality of communication stations and sleep control are necessary in a case where all terminals accommodated in a communication station that is a sleep target can be accommodated in another communication station on a basis of the cooperation information;
an optical path switching controller configured to control switching of the optical path between the one or more terminal accommodation stations and the plurality of communication stations in a case where it is determined that switching of the optical path between the one or more terminal accommodation stations and the plurality of communication stations is necessary; and
a sleep controller configured to cause the communication station that is the sleep target to transition to a sleep state before the switching of the optical path is performed or after the switching is performed.

16. A communication station connected to a terminal accommodation station that communicates with a terminal, the communication station comprising:
a transmitter configured to transmit cooperation information indicating a state of communication with the terminal to a management control device;
a receiver configured to receive an optical path switching instruction indicating that the management control device determines that it is necessary to switch an optical path between the terminal accommodation station and the communication station on a basis of the cooperation information; and
a sleep processor configured to transition to a sleep state before the switching of the optical path is performed on a basis of the optical path switching instruction.

17. A communication station connected to a terminal accommodation station that communicates with a terminal, the communication station comprising:
a transmitter configured to transmit cooperation information indicating a state of communication with the terminal to a management control device, the cooperation information including any of information regarding a processing load of the communication station, information regarding a processing delay of the communication station, and information regarding a transmission delay between the communication station and the terminal;
a receiver configured to receive an optical path switching instruction indicating that the management control device determines that it is necessary to switch an optical path between the terminal accommodation station and the communication station on a basis of the cooperation information; and
a sleep processor configured to transition to a sleep state before the switching of the optical path is performed or after the switching is performed on a basis of the optical path switching instruction.

18. A control method comprising:
acquiring cooperation information indicating a state of communication between a communication station connected, directly or via another device, to one or more terminal accommodation stations that perform communication with one or more terminals and the one or more terminals, from the communication station;
controlling switching of an optical path between the one or more terminal accommodation stations and a plurality of communication stations in a case where it is determined that switching of the optical path between the one or more terminal accommodation stations and the plurality of communication stations is necessary on a basis of the cooperation information; and
causing a communication station capable of sleep to transition to a sleep state before the switching of the optical path is performed.

19. A control method comprising:
acquiring cooperation information indicating a state of communication between a communication station connected, directly or via another device, to one or more terminal accommodation stations that perform communication with one or more terminals and the one or more terminals, from the communication station, the cooperation information including any of information regarding a processing load of the communication station, information regarding a processing delay of the communication station, and information regarding a transmission delay between the communication station and the one or more terminals;
controlling switching of an optical path between the one or more terminal accommodation stations and the plurality of communication stations in a case where it is determined that switching of the optical path between the one or more terminal accommodation stations and the plurality of communication stations is necessary on a basis of the cooperation information; and
causing a communication station capable of sleep to transition to a sleep state before the switching of the optical path is performed or after the switching is performed.

20. A control method comprising:
acquiring cooperation information indicating a state of communication between a communication station connected, directly or via another device, to one or more terminal accommodation stations that perform communication with one or more terminals and the one or more terminals, from the communication station;
controlling switching of an optical path between the one or more terminal accommodation stations and the plurality of communication stations in a case where all terminals accommodated in a communication station that is a sleep target among the plurality of communication stations can be accommodated in another communication station on a basis of the cooperation information; and
causing the communication station that is the sleep target to transition to a sleep state before the switching of the optical path is performed or after the switching is performed.
